(19) United States
(12) Patent Application Publication
(10) Pub. No.: US 2025/0376641 A1
(43) Pub. Date: Dec. 11, 2025

(54) FABRIC AND HOME CARE COMPOSITION

(71) Applicant: The Procter & Gamble Company, Cincinnati, OH (US)

(72) Inventors: Ouidad BENLAHMAR, Rheinland-Pfalz (DE); Adam BLANAZS, Rheinland-Pfalz (DE); Rosa CORBERAN ROC, Rheinland-Pfalz (DE); Sophia EBERT, Mannheim (DE); Renae Dianna FOSSUM, Middletown, OH (US); Katarzyna GORCZYNSKA-COSTELLO, Newcastle upon Tyne (GB); Frank HUELSKOETTER, Birkenheide (DE); Kian MOLAWI, Rheinland-Pfalz (DE); Jan Ole MUELLER, Neuhofen (DE); Pieter Jan Maria SAVEYN, Destelbergen (BE); Florian SCHOEN, Rheinland-Pfalz (DE); Gang SI, Newcastle upon Tyne (GB); Natalia STERGIOPOULOU, Brussels (BE)

(21) Appl. No.: 19/236,475

(22) Filed: Jun. 12, 2025

Related U.S. Application Data
(63) Continuation of application No. PCT/US2023/083020, filed on Dec. 8, 2023.

(51) Int. Cl. C11D 3/37; C11D 3/20; C11D 3/386

(52) U.S. Cl. CPC C11D 3/3788; C11D 3/2068; C11D 3/38636; C11D 2111/12; C11D 2111/14

(57) ABSTRACT

The present invention relates to fabric and home care compositions comprising specific graft polymers. The compositions are particularly suitable as laundry detergent compositions.

### FIELD OF THE INVENTION

The present invention relates to fabric and home care composition comprising specific graft polymers. The graft polymers may be applied in fabric and home care compositions, preferably in laundry detergent compositions.

### BACKGROUND OF THE INVENTION

Various states have already introduced initiatives to ban microplastics especially in cosmetic products. Beyond this ban of insoluble microplastic there is an intense dialog on future requirements for soluble polymers used in consumer products. It is therefore highly desirable to identify new better biodegradable ingredients for such applications. This problem is predominantly serious for polymers produced by radical polymerization based on carbon-only backbones (a backbone not containing heteroatoms such as oxygen), since a carbon-only backbone is particularly difficult to degrade for microorganisms. Even radically produced graft polymers of industrial importance with a polyethylene glycol backbone show only limited biodegradation in wastewater. However, the polymers described by the current Invention are preferably produced by radical graft polymerization and provide enhanced biodegradation properties compared to the state-of-the-art.

Polyalkylene oxides are important polymers with a wide range of applications. They have been extensively used as basis to produce graft polymers which are widely employed in consumer formulations, including cleaning compositions for household and other uses.

Similarly, graft polymers of a vinyl ester being grafted onto polyalkylene oxide-polymers such as vinyl acetate-graft-polyethylene glycol are known polymers. Their application in the detergent area as well as many other application areas are known as well. Those polymers however lack biodegradability or at least suffer from very limited biodegradability.

However, a certain amount—if not all—of such consumer products is rinsed finally away after their use and may, if not biodegraded or otherwise removed in the sewage treatment plant, end up in the rivers or sea.

Thus, biodegradability is one of the upcoming very important features not only in the area of detergents, as a biodegradable polymer can avoid the issue of building up in the environment.

Such issues will no longer be acceptable according to applicable laws in certain countries, which are expected to be made into law within the very near future if not already implemented and valid.

On the other hand, the functionalities imparted by such polymers is of utmost importance as well, as they allow for high cleaning efficiencies and thus among other advantages also for a low use of cleaning additives for a single cleaning run, and thus allow for saving material used and hence also avoid the pollution of the environment. As those specialty polymers also allow for cleaning at lower temperatures, in shorter times and with lower amounts of water, they are needed for an environment-friendly cleaning process.

Hence, providing biodegradable polymers for the area of detergents is of utmost importance to solve the problem of pollution of the environment without compromising cleaning efficiency, as such lower cleaning efficiency would also pollute the environment more than unavoidable.

One such widely known polymer is a graft polymer of vinyl acetate on PEG6000 with a wt. ratio 60% (VAc) to 40% (PEG) known and employed widely for its cleaning and whiteness benefits in liquid laundry formulations (liquid and gel-like detergents) and dry laundry formulations (such as laundry powders and tablets).

The poor biodegradability of polyalkylene oxides decreases in the range from a few hundred g/mol molecular weight up to a few thousand g/mol molecular weight. Even more so, graft polymers based on such polyalkylene oxides are usually even poorer in their biodegradation likely due to the grafting.

### Prior Art on Graft Polymers

US 2019/0390142 relates to fabric care compositions that include a graft copolymer, which may be composed of (a) a polyalkylene oxide, such as polyethylene oxide (PEG); (b) N-vinylpyrrolidone (VP); and (c) a vinyl ester, such as vinyl acetate. However, US 2019/0390142 does not disclose a graft polymer as presently required.

WO2020/005476 discloses a fabric care composition comprising a graft copolymer and a so-called treatment adjunct, the graft copolymer comprising a polyalkylene oxide as backbone based on ethylene oxide, propylene oxide, or butylene oxide, preferably polyethylene oxide, and N-vinylpyrrolidone and vinyl ester as grafted side chains on the backbone and with backbone and both monomers in a certain ratio.

WO2020/264077 discloses cleaning compositions containing a combination of enzymes with a polymer such composition being suitable for removal of stains from soiled material. This publication discloses a so-called “suspension graft copolymer” which is selected from the group consisting of poly (vinylacetate)-g-poly (ethylene glycol), poly(vinylpyrrolidone)-poly(vinyl acetate)-g-poly(ethylene glycol), and combinations thereof. The graft polymer as defined in this invention however is not disclosed.

U.S. Pat. No. 31,816,566 discloses graft polymers of so-called “lactone polyesters” and blends thereof with PVC. The lactone polyesters are either homo-polymers of epsilon-caprolactone or copolyesters thereof with epsilon-alkyl-epsilon-caprolactones. No polymers are disclosed being made from lactones and alkyleneoxides as in the present invention used as graft bases. The lactone polyesters of U.S. Pat. No. 31,816,566 were grafted with ethylenically unsaturated monomers, among a long list also “vinyl esters of aliphatic acids” are mentioned, with vinyl formate, vinyl acetate and vinyl propionate being exemplified in this list. The 22 examples show graft polymerization using acrylic acid, butylacrylate, dimethylaminomethacrylate, styrene, acrylonitrile, and methylmethacrylate as the only monomers actually being employed, all only as single monomer and no monomer mixtures being employed. Only one example (example 12) uses vinyl acetate as monomer and poly-epsilon-caprolactone as graft base (i.e. a graft base not comprising any alkylene oxide), employing 200 gram of backbone and 30 gram of vinyl acetate, i.e. and amount by weight of 15 wt. % vinyl acetate based on graft base equal to 13 wt. % of vinyl acetate based on total polymer weight. U.S. Pat. No. 31,816,566 does not disclose anything on the biodegradation of such polymer; the only use discloses is as plasticizer in PVC-polymer. Graft polymers of the types shown in this invention are not disclosed nor pointed at.

WO2022/136409 of BASF discloses amphiphilic alkoxylated polyalkylene imines or amines; no graft polymers are discloses comprising a polymer as graft backbone made from lactones and alkylene oxides being grafted in a radical polymerization with olefinically unsaturated monomers comprising at least a vinyl ester. Hence, his publication is completely unrelated to the present invention except to the fact that it also targets polymeric structures for use in areas similar to those of the present invention, and in that those products comprise lactone and alkylene oxides. The lactones and alkylene oxides are polymerized to produce lactone-alkylene oxide-copolymers which are attached to the amine groups of the starting compound polyethylene imine or polyamine. No graft polymerization is performed after the formation of those side chains. Thus, the structures and their preparation are completely different as well as the properties and thus the function in the application of such compounds. Graft polymers of the types shown in this invention are not disclosed nor pointed at.

US2022/0056380 discloses cleaning compositions focusing on specific enzymes, thus there is no focus on a specific polymer as such, it structure or preparation or properties. Among the many ingredients of such compositions also graft polymers are mentioned as an ingredient. The graft polymers however are the typically, known graft polymers (such as the preferred mentioned “Sokalan® HP22 of BASF”—all of which do not contain a lactone in the backbone of the polymer, thus such backbone being made only of alkylene oxides. Those alkylene oxides—and especially the preferred polymers of molecular weight of the backbones of around 6000 g/mol are not very much biodegradable at all, with the graft polymers being made with the use of such polyalkylene oxide-backbones having an even poorer biodegradation as shown in this present invention. Graft polymers of the types shown in this invention are not disclosed nor pointed at.

The task of improving the biodegradation of graft polymers based on backbones with polyalkylene oxide-units in the backbone was tackled already in un-published patent application PCT/EP2022/065983 (now published as WO2022/263354), which discloses graft polymers based on backbones comprising as functional units ester-functions and polyalkylene oxide-units. The backbones are prepared by oxidizing polyalkylene oxides in a first reaction, and then esterifying the oxidized PEG-mixtures either with itself or with additionally added polyalkylene oxides. The backbones are then grafted with vinyl acetate. The polymers in this disclosure suffer from the two-step-synthesis for the backbone: the oxidation as first reaction step is expensive and lengthy, and the composition obtained from the oxidation is difficult to control, as—depending on the time taken for the reaction—the content of the mixture changes. Typically, the mixture obtained contains non-oxidized starting material, polyalkylene oxides with one hydroxy-group being oxidized to carboxyl-function and polyalkylene oxides with both ends being oxidized. Hence, the flexibility of designing the backbone is highly limited. The patent application does also not disclose the use of nitrogen-containing monomers for preparing the graft polymers.

### Prior Art on Backbones

This present invention discloses the uses of three main types of polymeric backbones comprising (oligo-/poly-)alkylene oxide-moieties and (oligo-/poly-)lactone/hydroxy acid-derived moieties.

Such backbones are named (A1), (A2), (A3) and (A4) (see definitions below), and are in principle known so far:

### (A1)

WO2002046268 (Cognis, now BASF) discloses biodegradable polymers as surfactants, emulsifier etc., obtained by reacting an organic initiator with 1. alkylene oxides, 2. mixture of alkylene oxides and lactones. “Organic initiator” is defined on page 4 as mono- or polyfunctional alcohol or amine.

To obtain copolymers from alkylene oxides and caprolactone, suitable starters are reacted with a premixed combination of alkylene oxides and caprolactone.

To obtain (A1)-backbone-type copolymers from alkylene oxides and lactones such as caprolactone, suitable starters are reacted with a premixed combination of alkylene oxides and caprolactone.

Alcohols with 2 hydroxy groups (diols) are used as starters. Examples for such diols are: ethylene glycol, polyethylene glycol, propylene glycol, polypropylene glycol, ethylene oxide and propylene oxide block copolymers, 1,3-propylene diol, 1,4-butane diol, 1,6-hexane diol, neopentyl glycol, and the like.

Used alkylene oxides in combination with caprolactone are: ethylene oxide, 1,2-propylene oxide or 1,2-butylene oxide, 2,3-butylene oxide, 1,2-pentylene oxide, preferred ethylene oxide and propylene oxide.

The copolymerization of alkylene oxides and caprolactone is carried out under typical conditions for alkoxylation reactions. Basic catalysts are used like potassium hydroxide, sodium hydroxide, sodium methoxide, potassium methoxide.

### (A2)

(A2)—backbone-type polymers can be obtained in principle by alkoxylation of polylactones. Polylactones are for example accessible by polymerization of lactones such as caprolactone onto starters having 2 hydroxy-groups such as diols like ethylene glycol, polyethylene glycol, propylene glycol, polypropylene glycol, ethylene oxide and propylene oxide block copolymers, 1,3-propylene diol, 1,4-butane diol, 1,6-hexane diol, neopentyl glycol, and the like.

Polymerization of caprolactone is carried out with various catalysts like transesterification catalysts tin(II)alkanoates.

The alkoxylation of such polycaprolactones is done under typical alkoxylation conditions. Due to basic reaction conditions for the alkoxylation, transesterification reaction at ester bonds from polycaprolactone can occur.

U.S. Pat. No. 4,281,172 describes acrylic acid esters from polyester-polyether copolymers. To obtain these structures, a polylactone ester from mono-, di-, tri-, or tetraols, is reacted with alkylene oxides.

The polylactone esters are synthesized according to U.S. Pat. No. 3,169,945 from a hydroxy group-containing component with various catalysts, including Ti or Sn catalysts or alkali metal hydroxides.

The alkoxylation reaction is catalyzed with BF3-etherate or potassium hydroxide etc.

JP07149883 describes the process to obtain polyester-polyols from a compound with at least two active hydrogen, reacted with a lactone, followed by reaction with alkylene oxide. Both reactions are carried out with the same catalyst. Catalysts are alkali metal hydroxides or alkali metal alcoholates.

WO9636656 claims biodegradable alkylene oxide-lactone copolymers. The polymers are synthesized from a di- or polyfunctional starter, that are reacted with alkylene oxide and lactones in a copolymerization reaction, followed by an end-cap with an alkylene oxide block. Catalysts are alkali metal hydroxide or earth alkali metal hydroxide or Lewis acid. The patent application describes improved biodegradability of claimed polymers over polyalkylene oxides, and use as surfactants, emulsifiers etc. but not as backbones for graft polymers.

### (A3)

(A3)—backbone-type polymers can be obtained in principle by poly-esterification of polyalkylene glycols with lactones yielding—simplified—tri-block-polymers.

Triblock copolymers from caprolactone and alkylene oxides with a middle polyalkylene oxide block are synthesized by 1. formation of a polyalkoxylate from a diol or water by reaction with alkylene oxides, and 2. polymerization of caprolactone onto the polyalkoxylate.

Both reactions can be carried out under typical reaction conditions for alkoxylation reactions (polyalkoxylate) and for caprolactone polymerization (polycaprolactone block).

Such triblock copolymers with a middle polyethylene oxide block are known since about the 1990s. These polymers are used for drug release and solubilization purposes (Z. Zhu et al., Journal of Polymer Science, Part A: Polymer Chemistry 1997, 35 (4), 709-714; M. Boffito et al., Journal of Biomedical Materials Research, Part A 2015, 103A (3), 1276-1290).

### (A4)

(A4)—type backbones are known as well:

WO96/36656 discloses biodegradable oxide-lactone copolymers and copolyesters as already described for (A3) above.

WO2002046268 (Cognis, now BASF) discloses alkylene oxide-lactone copolymers as already described for (A1).

Not known however are the use of such polymers as backbones for graft polymers, introducing via the backbone an improved biodegradation into such graft polymers.

### OBJECT OF INVENTION

It was recognized that the graft polymers based on conventional polyalkylene oxides (without ester-groups in the backbone) show a surprisingly low biodegradation, which is often very much lower than the expected biodegradation percentage, which is calculated on the biodegradation of the pure polyalkylene oxides.

The graft polymers being based on such conventional polyalkylene oxides commonly show a decrease in biodegradation compared to the unmodified polyalkylene oxides and unmodified polyalkylene glycols, as the degree of modification of polyalkylene oxides (often polyalkylene oxides with two hydroxy-end groups are employed, thus such polyalkylene oxides with hydroxy-groups being named commonly “polyalkylene glycols”) with polymerizable monomers by radical grafting onto such backbones increases (i.e. the number of side chains on the backbone increases). This is sometimes attributed to the blocking of the biodegradation mechanism, as it seems that the polyalkylene oxides/glycols are degraded starting from their respective end group then following the polymer chain along. Thus, any additional branching on a carbon-atom of the backbone—which occurs when a polymeric side chain is grafted onto such backbone—impedes and possibly completely stops degradation. As a result, it is suggested that the higher the degree of grafting (i.e. the more side chains are attached to the backbone) the lower is the biodegradation percentage of such graft polymer. Unfortunately, it is also commonly observed that with higher degree of branching the performance increases in the desired applications, as only with a higher amount of side chains the chemical structure of the backbone is changed enough that the new graft polymer exerts its specific properties compared to the separated properties of the unmodified backbone in simple mixture with the (unattached/ungrafted) homopolymer which would make up the side chain of the graft polymer.

Hence, the difficulty of combining the conflicting properties of a suitable graft polymer with superior application performance with the biodegradation percentage of the unmodified backbone (i.e. an unmodified polyalkylene oxide/glycol) has not been met up to date when polyalkylene oxides are used as backbones.

Although the unpublished patent application PCT/EP2022/065983 has provided a first solution to the problem of lacking biodegradation of the polyalkylene oxide-backbones, the practical aspects of the solution found is still not satisfactory, as the two-step-reaction is lengthy and costly, as two completely different types of chemical reactions are employed (oxidation and polymerization) and the structural variations are not easily controlled as the oxidation leads to mixtures of compounds being diols (i.e. the starting material polyalkylene glycols), mono-ol-mono-carbonic acid (i.e. partially oxidized polyalkylene glycol) and di-carboxyl-polyalkylene oxide (i.e. fully oxidized polyalkylene glycol). Structures as the ones used here are not obtainable by the method disclosed in that document. Similarly, nitrogen-containing monomers are not disclosed.

Hence, there was a need to improve the biodegradation of conventional graft polymers based on polyalkylene oxides by improving the biodegradability of the graft base and keeping the general structure of the graft polymer and thus maintaining the application performance or even improve it, and to improve the cost and efficiency of the unpublished patent application PCT/EP2022/065983 by reducing the production process to just one reaction step employing only one reaction type and improving the variability of the chemical structure at the same time.

Even though polymers of the type (A1), (A2) and (A3) as defined herein are known, the use of such polymers as backbones to prepare graft polymers is not yet known.

Thus, the object of the present invention is to provide novel graft polymers based on polyalkylene-oxide-type graft backbones which impart ester-functions.

Furthermore, these novel graft polymers should have beneficial properties in respect of biodegradability and/or their washing behavior, when being employed within compositions such as cleaning compositions.

### SUMMARY OF THE INVENTION

The present invention provides a fabric and home care composition comprising:
(i) graft polymer; and
(ii) one or more fabric and home care ingredients,
wherein the graft polymer consists of:
(A) 20 to 95%, preferably 30 to 90%, more preferably 40 to 85%, most preferably 50 to 80% of a polymer backbone as a graft base,
which comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C₂ to C₁₀-alkylene oxides, preferably C₂ to C₅-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid, wherein preferably the at least one lactone and/or hydroxy acid is/are selected from the groups i) and/or ii), with
   i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
   and
   ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
   preferably lactic acid or caprolactone, more preferably caprolactone,
wherein the polymer backbone is obtained
   (A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
   (A2) by first oligo-/polymerizing sub-unit(s) (a2) and then polymerizing the product with sub-unit(s) (a1); or
   (A3) By first oligo-/polymerizing sub-unit(s) (a1) and then co-polymerizing the product with sub-unit(s) (a2);
   (A4) by first providing an oligo- or polymeric sub-unit (a1) which is bears an end-cap on one side, preferably is etherified with alcohols, more preferably short-chain alcohols C₁ to C₄, which—as starter-block—is thereafter reacted with at least one sub-unit (a2) and/or at least one sub-unit (a1)—wherein the sub-unit
(a1) may be different to that/those in the starter block or may be arranged in a different order compared to those in the starter block—to attach to the non-endcapped side of the starter block a new block comprising moieties from the sub-units employed for the (co-)polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
wherein in case more than one sub-unit (a1) and/or more than one sub-unit (a2) are present already in an employed oligomer or polymer, those sub-units can be arranged in any order within such employed oligomer or polymer, and
wherein in case more than one sub-unit (a1) and/or more than one sub-unit (a2) are present for the polymerization, those sub-units (and the optional oligomer/polymers if employed) can be arranged in any order within the obtained backbone; and
(B) 5 to 80%, preferably 10 to 70%, more preferably 15 to 60%, most preferably 20 to 50%, of polymeric sidechains (B) grafted onto the polymer backbone (A), wherein said polymeric sidechains (B) are obtainable by (co-)polymerization of at least one vinyl ester monomer (B1), optionally vinylpyrrolidone as monomer (B2), and optionally further monomer(s) (B3), and optionally further monomers, with all percentages as weight percent in relation to the total weight of the graft polymer.

The present invention also provides a fabric and home care composition comprising:
(i) graft polymer; and
(ii) one or more fabric and home care ingredients, wherein the graft polymer consists of:
(A) 20 to 95%, preferably 30 to 90%, more preferably 40 to 85%, most preferably 50 to 80% of a polymer backbone as a graft base, which comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C₂ to C₁₀-alkylene oxides, preferably C₂ to C₅-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
   wherein preferably the at least one lactone and/or hydroxy acid is/are selected from the groups i) and/or ii), with
   i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
   and
   ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
   preferably lactic acid or caprolactone, more preferably caprolactone,
wherein the polymer backbone is selected from
   (A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
   (A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on; and
   (A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”,
   (A4) a backbone consisting of
      a first block with
      on one end an end-cap—such end-cap being a C₁ to C₁₈, preferably C₁ to C₄-alkyl-group attached to said first block via an ether-function; and an oligo- or polymeric sub-unit (a1); and
      a second block which is attached to said first block at the opposite end of said first block (“opposite” in relation to the end-cap on said first block) via an ether or ester-function, said second block being composed of at least one sub-unit (a2) and optionally at least one sub-unit (a1), wherein the optional sub-unit(s) (a1) in said second block may be different to that/those in the first block or may be arranged in a different order compared to those in the first block, and the order of the sub-unit(s) (A1) and (a2) may be also in any order, including random structure,
      such di-block-structure having as an idealized structure in case of using only sub-unit(s) (a2): [end-cap]-[sub-unit(s) (a1)]-[sub-unit(s) (a2)]
      or in case of using sub-unit(s) (a1) and (a2): [end-cap]-[sub-unit(s) (a1)]-[random-{sub-unit(s) (a2)-sub unit(s) (a1)}]; and
(B) 5 to 80%, preferably 10 to 70%, more preferably 15 to 60%, most preferably 20 to 50%, of polymeric sidechains (B) grafted onto the polymer backbone (A), wherein said polymeric sidechains (B) are obtainable by (co-)polymerization of at least one vinyl ester monomer (B1), optionally vinylpyrrolidone as monomer (B2), and optionally further monomer(s) (B3), and optionally further monomers,
with all percentages as weight percent in relation to the total weight of the graft polymer.

### BRIEF DESCRIPTION OF THE DRAWINGS

FIG. 1 shows a comparison of ¹H NMR spectra (298 K, D₂O, 400 MHz) of the fresh sample comparative graft polymer 1 (bottom spectrum) and the comparative graft polymer 1 after storage of a 9 wt % aqueous solution for two weeks at 54° C. (up spectrum). a) full spectrum, b) enlargement of the region 4.0 to 4.35 ppm.

FIG. 2 shows a comparison of ¹H NMR spectra (298 K, D₂O, 400 MHz) of the fresh inventive graft polymer 5 (Inv. 5) (bottom spectrum) and the inventive graft polymer 5 after storage of a[[n]] 9 wt % aqueous solution for two weeks at 54° C. (up spectrum). a) full spectrum, b) enlargement of the region 3.75 to 4.35 ppm.

### DETAILED DESCRIPTION OF THE INVENTION

The fabric and home care composition comprises:
(i) graft polymer; and
(ii) one or more fabric and home care ingredients.

### Graft Polymers

The graft polymers of the invention comprise a polymer backbone as graft base as a first structural unit and polymeric side chains as a second structural unit.

### First Structural Unit (Backbone)

The first structural unit of the graft polymer is a polymer backbone used as a graft base for the inventive graft polymer, wherein said polymer backbone (A) is obtainable by polymerization of at least one sub-unit (a1) and at least one sub-unit (a2).

The sub-unit (a1) is made from least one alkylene oxide monomer and/or at least one polyalkylene oxide-polymer having two hydroxy-end-groups, the alkylene oxide monomer selected from the group of C₂ to C₁₀-alkylene oxides, preferably C₂ to C₅-alkylene oxides, such as ethylene oxide, 1,2 propylene oxide, 1,2 butylene oxide, 2,3 butylene oxide, 1,2-pentene oxide or 2,3 pentene oxide; from 1,4-diols or their cyclic or oligomeric analogs, or being based on polymeric ethers of such 1,4-diols; from 1,6-diols or their cyclic or oligomeric analogs, or being based on polymeric ethers of such 1,6-diols; or any of their mixtures in any ratio, either as blocks of certain polymeric units, or as statistical polymeric structures, or a polymers comprising one or more homo-block(s) of a certain monomer and one or more statistical block(s) comprising more than one such monomer, and any combination thereof such as polymers having several different blocks of two or more different monomers, or blocks of two or more different monomers, blocks of statistical mixtures of two or more monomers etc.

The term “block (co)polymer” as used herein means that the respective polymer comprises at least two (i.e. two, three, four, five or more) homo- or co-polymer subunits (“blocks”) linked by covalent bonds. “Two-block” copolymers have two distinct blocks (homo- and/or co-polymer subunits), whereas “triblock” copolymers have, by consequence, three distinct blocks (homo- and/or co-polymer subunits) and so on. The number of individual blocks within such block copolymers is not limited; by consequence, a “n-block copolymer” comprises n distinct blocks (homo- and/or co-polymer subunits). Within the individual blocks the size/length of such a block may vary independently from the other blocks. The smallest length/size of a block is based on two individual monomers (as a minimum), but may be as large as 50 or even 100 or 200, and any number in between 2 and 200. The respective monomers to be employed for preparing the individual blocks of a block copolymer backbone (a1) may be added in sequence. However, it is also possible that there is a transition of the feed from one monomer to the other to produce so called “dirty structures” wherein at the edge/border of the respective block a small number of monomers of the respective neighboring block may be contained within the individual block to be considered (so called “dirty structures” or “dirty passages”). However, it is preferred that the block copolymer sub-units (a1) according to the present invention do not contain any dirty structures at the respective border of the blocks, although for commercial reasons (i.e. mainly cost for efficient use of reactors etc.) small amounts of dirty structures may still be contained although not deliberately being made.

Preferably at least one monomer in the polymer stems from the use of ethylene oxide.

In another embodiment, more than one alkylene oxide monomer is comprised in the structure of the polymer-subunit (A1); in such case the polymer backbone is a random copolymer, a block copolymer or a copolymer comprising mixed structures of block units (with each block being a homo-block or a random block itself) and statistical/random parts comprised of two or more alkylene oxides, with one of the monomers being ethylene oxide. Preferably the further monomer beside ethylene oxide is propylene oxide (PO) and/or 1,2-butylene oxide (BO), preferably only 1,2-propylene oxide.

The sub-unit (a2) is made from at least one lactone and/or at least one hydroxy acid.

The at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid; preferably lactic acid or caprolactone, more preferably caprolactone.

The sub-units (a1) and (a2) may be combined in any order depending on how the starting material are employed and depending on the relative amounts. As a result, the polymer backbone (A) obtained from the reaction of (a1) and (a2) can be defined in a very broad range by selecting the desired sub-units (a1) and (a2), and—within sub-unit (a1) by selecting the number of different alkylene oxides, their relative amounts, their reaction order etc, and of course also for (a2) by selecting the compounds, their relative amounts etc., in such way
1) to obtain first defined (a1)-subunits which are then reacted with (a2)-sub units,
2) to directly react monomeric alkylene oxides from sub-unit (a1) with monomeric sub-units (a2); or
3) to combine approach 1) and 2) before.

Hence, three principal backbone-structures can be defined and obtained:

### (A1):

sub-units (a2) can be added during alkylene oxide polymerization (al-units) yielding random copolymers; in a variation thereof, polyalkylene oxides having two hydroxy-groups can be added to such polymerisation thus introducing specific (a1)-sub-unit-blocks; this variation is useful if the alkylene oxides employed are at least partially different to the alkylene oxides employed for preparing the polyalkylene oxide also employed or if the structure of the polyalkylene oxide (i.e. the order of the alkylene oxide-units therein) is different to what is obtained by reacting the at least one alkylene oxide employed for the co-polymerisation with (a2)-sub-unit and the polyalkylene oxide.

In a simplifying approach this (A1)-backbone can be described as a randomly arranged order of (a1)-sub-units and (a2)-sub-units. Depending on the relative amount of (a1) to (a2) and their reactivity the block length of the (a1) and the (a2) is varied.

Structures like the one shown below can be obtained by this approach:

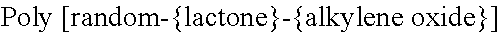

Hence, in one preferred embodiment, the polymer backbone is selected from (A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present.

### (A2):

sub-units (a2) can be oligomerized/polymerized first and the co-polymerized with at least one alkylene oxide yielding mixed random/block structures; depending on the degree of oligomerization of the lactone/hydroxy-acid and if still monomeric lactone/hydroxy acid is present when the alkylene oxide(s) is/are added, the structure can be further varied by tuning the amount and length of (a2)-sub-unit-chains within the (A2)-backbone.

As with (A1), in a further variation thereof, also polyalkylene oxides having two hydroxy-groups can be added to such polymerisation thus also introducing specific (a1)-sub-unit-blocks; this variation is useful if the alkylene oxides employed are at least partially different to the alkylene oxides employed for preparing the polyalkylene oxide also employed or if the structure of the polyalkylene oxide (i.e. the order of the alkylene oxide-units therein) is different to what is obtained by reacting the at least one alkylene oxide employed for the co-polymerisation with (a2)-sub-unit and the polyalkylene oxide.

In a simplifying approach, this (A2)-backbone can be described as a tri-block-polymer with an inner (a2)-block and two outer (a1)-blocks. (Switching the order to the opposite leads to structure (A3); see below.)

Structures like the one shown below (in its most simple version) can be obtained by this approach:

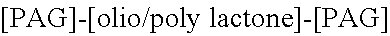

(“lactone” is used here to denote the (a2)-sub-units, thus made from lactone(s)/hydroxy acid(s) and can be single monomeric units or oligo- or polymeric units made from monomers in a first reaction step; “PAG”=polyalkylene glycol is used here to depict the (a1)-sub-unit) In case the (a2)-sub-unit-starting material has not completely reacted, the structure will not be anymore a true tri-block structure, but will in addition contain further, shorter (a2)-units in the chains and thus consist of a multi-block-structure or even shift towards a mixture of block and random-structural arrangement.

Hence, the in one preferred embodiment the polymer backbone is selected from (A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on.

### (A3):

sub-units (a2) can be added after alkylene oxide oligomerization or (almost complete) polymerization yielding block structures containing larger (a2)-chains and larger (a1)-chains; in case of complete polymerization of (a1) before addition of (a2) the structure resulting can be described as “(a2)-polyalkylene oxide-(a2)”; such structures can be also obtained by directly reacting polyalkylene oxides with (a2). By only oligomerizing the alkylene oxide(s) first and then reacting the mixtures containing alkylene-oxide(s)-oligomers and monomeric alkylene oxides with (a2) or by polymerizing (a2) with alkylene oxide(s) and with polyalkylene oxide(s) more complex structures can be obtained.

In a simplifying approach, this (A3)-backbone can be described as a tri-block-polymer with an inner (a1)-block and two outer (a2)-blocks:

### (Switching the Order to the Opposite Leads to Structure (A2); See Above)

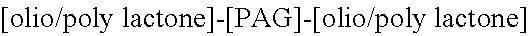

(“oligo/poly lactone” depicts the (a2)-sub-unit, thus made from lactone(s)/hydroxy acid(s); “PAG”=polyalkylene glycol is used here to depict the (a1)-sub-unit)

Hence, in one preferred embodiment, the polymer backbone is selected from (A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”.

Similarly as for case of (A2), in case the (a2)-sub-unit-starting material has not completely reacted, the structure will not be anymore a true tri-block structure, but will in addition contain further, shorter (a1)-units in the chains and thus consist of a multi-block-structure or even shift towards a mixture of block and random-structural arrangement.

### Similarities of (A1), (A2) and (A3)

The more unreacted species of (a2) (in case of (A2)-backbone) or the more unreacted species of (a1) (in case of (A3)-backbone) are present when the respective other sub-unit-species are added, the difference between (A2) and (A3) diminishes.

To the extreme, the result of that would be a true co-polymerization of sub-units (a1) and (a2) and thus would be similar or even identical also to (A1).

Hence, (A1), (A2) and (A3) are “just” extreme ends of the overall principle of co-polymerizing alkylene oxides, polyalkylene glycols and lactones/hydroxy acids in every thinkable order, ratio and variation of reaction times before adding the other starting materials.

Hence, in one preferred embodiment, the polymer backbone is selected from a backbone obtained by such overall principle of co-polymerizing alkylene oxides, polyalkylene glycols and lactones/hydroxy acids in every thinkable order, ratio and variation of reaction times before adding the other starting materials.

In a preferred embodiment, the polymer backbone as a graft base comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C₂ to C₁₀-alkylene oxides, preferably C₂ to C₅-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein preferably the at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone; and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone,
wherein the polymer backbone is obtained
(A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
(A2) by first oligo-/polymerizing sub-unit(s) (a2) and then polymerizing the product with sub-unit(s) (a1); or
(A3) By first oligo-/polymerizing sub-unit(s) (a1) and then co-polymerizing the product with sub-unit(s) (a2);
(A4) by first providing an oligo- or polymeric sub-unit (a1) which is end-capped on one side, preferably etherified with alcohols, more preferably short-chain alcohols C₁ to C₄, which—as starter-block—is thereafter reacted with at least one sub-unit (a2) and/or at least one sub-unit (a1)—wherein the sub-unit (a1) may be different to that/those in the starter block or may be arranged in a different order compared to those in the starter block—to attach to the non-endcapped side of the starter block a new block comprising moieties from the sub-units employed for the (co-)polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
wherein in case more than one sub-unit (a1) and/or more than one sub-unit (a2) are present already in an employed oligomer or polymer, those sub-units can be arranged in any order within such employed oligomer or polymer, and
wherein in case more than one sub-unit (a1) and/or more than one sub-unit (a2) are present for the polymerization, those sub-units (and the optional oligomer/polymers if employed) can be arranged in any order within the obtained backbone;
and wherein—optionally—at least one starter molecule is included in the backbone structure.

The polymer backbone (A) and specifically (A1), (A2) and (A3), may be optionally capped at the end groups, the capping is done by C₁ to C₂₅ alkyl groups using known techniques, preferably C₁ to C₄-groups. Such capping will be done after the production of the backbones and may be done preferably prior to the grafting.

In case of (A4), the capping on one end-group is either to be done prior to the condensation polymerization with sub-unit(s) (a1) and/or sub-unit(s) (a2), as only then a structure (A4) can be obtained. In another, more preferred approach, the production of the (A4) starts with a mono-alcohol, which is then reacted with alkylene oxide(s) to obtain the “mono-end-capped” oligo/polymer of sub-unit (a1) (bearing one hydroxy-group at the oligo/poly alkylene oxide-chain end), which is then reacted with sub-unit(s) (a2) to obtain (A4).

When preparing the oligo-/poly-alkylene oxide as a starting block, a diol may be used as a starter molecule for preparing this oligo/poly alkylene oxide, thus such oligo-/polymer of sub unit (a1) may contain in its structure a moiety derived from such diol. Diols for such use and methods to prepare such oligo/poly alkylene oxide comprising diols in their structure are known. Typical diols are ethylene glycol, propylene glycol etc. All of the commonly known diols can in principle be used for such purpose.

In another preferred embodiment, the polymer backbone as a graft base comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C₂ to C₁₀-alkylene oxides, preferably C₂ to C₅-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
   wherein preferably the at least one lactone and/or hydroxy acid is/are selected from the groups i) and/or ii), with
   i) lactone(s), i.e. cyclic esters, starting with α-lactone (three ring atoms) followed by 3-lactone (four ring atoms), γ-lactone (five ring atoms) and so on; such lactones preferably being (3-propiolactone, g-butyrolactone, δ-valerolactone, g-valerolactone, e-caprolactone, d-decalactone, g-decalactone, e-decalactone; preferably caprolactone; and
   ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone,
   wherein the polymer backbone as a graft base (A),
   which the polymer backbone is selected from
   (A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
   (A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on; and
   (A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”,
   (A4) a backbone consisting of
   a first block with
      (i) on one end an end-cap—such end-cap being a C₁ to C₁₈, preferably C₁ to C₄-alkyl-group attached to said first block via an ether-function; and
      (ii) an oligo- or polymeric sub-unit (a1); and
   a second block which is attached to said first block at the opposite end of said first block (“opposite” in relation to the end-cap on said first block) via an ether or ester-function, said second block being composed of at least one sub-unit (a2) and optionally at least one sub-unit (a1), wherein the optional sub-unit(s) (a1) in said second block may be different to that/those in the first block or may be arranged in a different order compared to those in the first block, and the order of the sub-unit(s) (A1) and (a2) may be also in any order, including random structure,
   such di-block-structure having as an idealized structure in case of using only sub-unit(s) (a2): [end-cap]-[sub-unit(s) (a1)]-[sub-unit(s) (a2)]
   or in case of using sub-unit(s) (a1) and (a2): [end-cap]-[sub-unit(s) (a1)]-[random-{sub-unit(s) (a2)-sub unit(s) (a1)}]; and wherein—optionally—at least one starter molecule is included in the backbone structure. In a preferred embodiment the polymer backbones (A), and specifically (A1), (A2) and (A3), are not capped but bear hydroxy-groups at the chain ends.

Preferably, the polyalkoxylate-ester backbone comprises moieties derived from
(i) alkylene oxides (AO) comprising at least one of ethylene oxide (EO), propylene oxide (PO), and butylene oxide (BO), preferably at least one of EO and PO,
with the AO in an amount of from 40 to 95, preferably up to 90, and preferably from 50, more preferably from 60, and even more preferably from 70 wt %, and any number and range in between, each based on the total weight of the backbone,
   the amount of EO being of from 0 to 100 wt. %, preferably from 10, more preferably from 20, even more preferably from 30, even more preferably from 40, such as from 50, 60, 70, 80 or even from 90 wt %, based on total AO,
   the PO and/or BO, in an total amount of each from 0 to 100 wt. %, preferably up to 90, more preferably up to 80, even more preferably up to 70, even more preferably up to 60, and most preferably up to 50, and any number in between such as up to 5, 10, 15, 25, 30, 35, 40, 45, 55, 65, 75, 85 or up to 95, and more preferably from 10, even more preferably from 20, even further more preferably from 30, such as from 40, 50, 60, 70, 80 or even from 90 wt %, each based on the total weight of AO, with the total amount of PO and BO adding up to 100 wt. % for the sum of PO and BO,
   with the total amount of AO adding up to 100 wt. %;
(ii) lactone/hydroxy acid monomer in an amount of from 1 and up to 60, preferably up to 50, more preferably up to 40, most preferably up to 30 wt. %, and preferably from 2, more preferably from 3, even more preferably from 4 and most preferably from 5 wt. %, each based on the total weight of the backbone, preferably only caprolactone;
With the total weight of the sum of sub-units (a1) and sub-units (a2) in the backbone (A) adding up to 100 wt %.

More preferably, the amount of EO is at least 80 wt %, preferably at least about 85, more preferably at least about 90, even more preferably at least about 95%, and most preferably about 100 wt. % based on total AO; the amount of PO and/or BO is each from about 0 to 50 wt. % based on the total weight of AO, more preferably at most about 30, even more preferably at most about 20%, even more preferably about 10, and most preferably about 0 wt. %, each based on total AO; in a more preferred embodiment, the amounts for PO and BO given in this paragraph before are the total amounts for the sum of PO and BO. In an even more preferred embodiment, the backbone-unit (a1) is made from ethylene oxide only.

In an alternative but preferred embodiment, at least two different alkylene oxides are employed for the preparation of the backbone/are present in the backbone.

Hence, in one more preferred embodiment, the polymer backbone consists of
(i) alkylene oxides (AO) being selected from ethylene oxide (EO), propylene oxide (PO), and butylene oxide (BO), preferably only EO and PO,
   the amount of EO being of from 10 to 90, preferably 20 to 80, more preferably 30 to 70, and most preferably 40 to 60 wt %, based on total AO,
   the total amount of PO and BO being from 10 to 90, preferably 20 to 80, more preferably 30 to 70, and most preferably 40 to 60 wt %, each based on the total weight of AO, with the total amount of PO and BO adding up to 100 wt. % for the sum of PO and BO, and with the total amount of AO adding up to 100 wt. %;
(ii) lactone/hydroxy acid monomer in an amount of from 1 and up to 60, preferably up to 40, more preferably up to 30, even more preferably up to 25, even further more preferably up to 20, and most preferably up to 15 wt. %, and preferably from 2, more preferably from 3, even more preferably from 4 and most preferably from 5 wt. %, each based on the total weight of the backbone, preferably only caprolactone;
   with the total weight of the sum of sub-units (a1) and sub-units (a2) in the backbone (A) adding up to 100 wt %.

Hence, in one more preferred, alternative embodiment, the polymer backbone consists of
(i) alkylene oxides (AO) is selected from ethylene oxide (EO), propylene oxide (PO), and butylene oxide (BO), preferably only EO and PO, more preferably only EO the amount of EO being of from 20 to 100 wt %, based on total AO,
   the total amount of PO and BO being from 0 to 80 wt. %, preferably up to 50, more preferably up to 30, even more preferably up to 20, and even further preferably up to 10, and most preferably zero, such as 45, 45, 45, 25, 15, 7 and 5, and any number in between, each based on the total weight of AO, with the total amount of PO and BO adding up to 100 wt. % for the sum of PO and BO,
   with the total amount of AO adding up to 100 wt. %;
(ii) lactone/hydroxy acid monomer in an amount of from 5 and up to 50, preferably up to 40, more preferably up to 35, and even more preferably up to 30, and as lower limit preferably from 7, more preferably from 10, even more preferably from 12 wt %, and most preferably from 15, such as 6, 8, 9, 11, 12, 13, 14 and 15 and any number in between as lower limit and such as 30, 33, 37, 45 and any number in between as upper limit, based on the total weight of the backbone, preferably only caprolactone;
   with the total weight of the sum of sub-units (a1) and sub-units (a2) in the backbone (A) adding up to 100 wt %.

In an even more preferred embodiment, the backbone for any of the embodiments of the inventive graft polymer as defined herein is a structure chosen from the structures (A1), (A2), (A3) and/or (A4).

### Second Structural Unit (Grafted Side Chains)

The second structural unit of the graft polymer are polymeric side chains (B), which are grafted onto the polymer backbone (A), wherein said polymeric sidechains (B) are obtainable by (co-)polymerization of at least one vinyl ester monomer (B1), optionally a nitrogen-containing monomer (B2), optionally further monomer(s) (B3), and optionally further monomers besides (B1), (B2) and (B3).

As vinyl ester monomer (B1), at least one of vinyl acetate, vinyl propionate and/or vinyl laurate is selected. Besides those, further vinyl ester monomers (B1) may be employed which are known to a person skilled in the art, such as vinyl valerate, vinyl pivalate, vinyl neodecanoate, vinyl decanoate and/or vinyl benzoate.

As optional monomer (B2) N-vinylpyrrolidone may be employed.

Further monomers (B3) may be employed as optional monomers, such monomers being different to (B1) and (B2) and being present only in an amount of preferably less than 10% of the total amount of monomers employed for obtaining the polymeric sidechains (B), and are more preferably present only as impurities but not deliberately added for polymerization. (B3) monomers may be any monomer chosen from 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid, and their derivatives.

Besides monomers (B1), (B2) and (B3) at least one further monomer, being different from those before, may be present for the co-polymerization to yield the side chains (B), wherein such further monomer is present only in an amount of less than 2% of the total amount of monomers employed for obtaining the polymeric sidechains (B), and is preferably present only as impurities but not deliberately added for polymerization.

In case monomer (B2) is present, the amounts of monomers are as follows, based on the total WEIGHT OF THE GRAFT POLYMER:
(B) is from 10 to 60%, preferably up to 50%, more preferably up to 40%, and preferably from 20%;
(B1) vinyl ester in weight percent being based on the total WEIGHT OF THE GRAFT POLYMER is from 9 to 55%, preferably up to 50, more preferably up to 40, even more preferably up to 35, and even more preferably up to 30%;
(B2) monomer-vinylpyrrolidone in weight percent being based on the total WEIGHT OF THE GRAFT POLYMER is from 1 to 25%, and more preferably 5 to 25, even more preferably up to 15 such as 1 to 15 and more preferably 5 to 15, and further such as up to 10 up to 20, 10, and every number in between 1 and 25, wherein preferably the amount of (B2) is not higher than the amount of (B1);
(B3) further monomer is from 0 to 10, preferably at most 2, more preferably at most 1, even more preferably about 0, but in all cases at most 10% of the amount of (B1), and not more than the amount of (B2). The amount of further monomer(s) besides (B1), (B2) and (B3) is as detailed before.

In case monomer (B2) is not present, the amounts of monomers are as follows, based on the total WEIGHT OF THE GRAFT POLYMER:
(B) is from 5 to 60%, preferably up to 50%, and preferably from 20%;
(B1) vinyl ester in weight percent being based on the total WEIGHT OF THE GRAFT POLYMER is the total amount of (B) minus the total amount of (B3);
(B2) vinylpyrrolidone is 0%;
(B3) further monomer is from 0 to 10, preferably at most 2, more preferably at most 1, even more preferably about 0. The amount of further monomer(s) besides (B1), (B2) and (B3) is as detailed before.

In a preferred embodiment, the amount of vinyl ester monomer (B1) is usually not smaller than 10% by weight (in relation to the sum of (B1) and (B2)).

Preferably, optional further monomers (B3) are present only as impurities but not deliberately added for polymerization. More preferably, the amount is less than 1, more preferably less than 0.5%, even more preferably less than 0.01% by weight based on total weight of monomers (B1), most preferably there is essentially no such monomers (B3), and most preferably even a total absence of any other monomer besides the monomers (B1) and optional monomers (B2). The same applies for the further monomers besides (B1), (B2) and (B3).

In a preferred embodiment, the graft polymer of the invention comprises polymeric sidechains (B) which are obtained or obtainable by radical polymerization of the at least one vinyl ester monomer (B1) and optionally at least one other monomer (B2) and optionally at least one further monomer (B3) in the presence of the polymer backbone (A), wherein at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 80, more preferably at least 90 weight percent, and most preferably essentially only vinyl acetate is employed as vinyl ester (weight percent being based on the total weight of vinyl ester monomers B1 being employed).

In an even more preferred embodiment of the previous embodiment, essentially no other monomer (B3) is employed.

In an even more preferred embodiment of the previous embodiment, essentially no other monomers (B2) nor (B3) are employed.

In a preferred embodiment, the inventive graft polymer consists of monomers, wherein
(B) the monomers are:
   (B1) at least one vinyl ester, selected from vinyl acetate, vinyl propionate and/or vinyl laurate, in amounts of from 70 to 100% by weight of the total weight of monomers that are grafted onto the backbone (A), preferably only vinyl acetate, and
   (B2) optionally monomer-vinylpyrrolidone in amounts of from 0 to 20% by weight of the total amount of monomers that are grafted onto the backbone (A),
with the vinyl ester monomer(s) (B1) optionally being partially or fully hydrolyzed after polymerization.

In a preferred embodiment thereof, the vinyl ester is not hydrolyzed.

In an alternative embodiment, vinylpyrrolidone as monomer (B2) is present besides at least one monomer (B1), with monomer (B1) being preferably comprising vinyl acetate, and even more preferably being only vinyl acetate. Even more preferably, vinyl acetate is the only monomer (B1) and vinylpyrrolidone is the only monomer (B2).

In an alternative embodiment of the embodiments in the paragraph immediately before, the monomer (B1) may be partially or fully hydrolyzed after the polymerization reaction. In a preferred embodiment thereof, monomer (B1) is partially hydrolyzed, and is even more preferably hydrolyzed to up to 80, 70 or 60, 50, 40, 30, 20 or 10 mole percent based on the total amount of monomer(s) (B1).

Preferably the monomer (B1) is partially hydrolyzed of from 20%, and is hydrolyzed up to 50%. In a most preferred embodiment of the embodiments before, vinyl acetate is employed as monomer (B1) and vinylpyrrolidone as monomer (B2), and the polymer moiety stemming from vinyl acetate is partially hydrolyzed after polymerisation, preferably in an amount of about 20 to 50, more preferably about 30 to 45, such as about 40 mole %, based on total amount of vinyl acetate. In an alternative, even more preferred embodiment of two paragraphs immediately before, the vinyl esters are not hydrolyzed at all.

It is to be understood that the amounts for (A), (B), (B1), (B2), (B3) and further monomers besides the ones before may be selected from the various detailed ranges given independently, i.e. lower and upper borders may be combined also from two different ranges given for one aspect to result in a numerical range not specified explicitly in numbers, such combined range for e.g. (A), (B), (B1), (B2) and (B3) however being explicitly intended to be encompassed by this present intention.

Also, broad ranges and very particularly preferred narrow ranges may be combined in one embodiment of this invention, with the selection of the ranges for one component being chosen independently of that for the other component, in as far as the overall numbers add up to a “100%-polymer”: e.g. the most preferred range for (A) and (B) may be chosen and combined with the broadest possible ranges given for (B1)/(B2)/(B3), and any other possible combination.

Preferably, for all selections possible to be made for (A)/(B) and (B1)/(B2)/(B3)), the same selections are to be made, e.g. all “preferred” ranges are chosen, or—more preferably—all “more preferred” ranges are chosen, or—most preferably—all “most preferable” ranges are chosen.

The inventive graft polymer as detailed before has a polydispersity (PDI) Mw/Mn of at most 10, preferably at most 5, more preferably at most 3, and most preferably in the range from 1.0 to 2.6, and any number a as upper or lower limit and any range in between such as 1,3 to 2,6, 1 to 3 etc. (with Mw=weight average molecular weight in g/mol, and Mn=number average molecular weight in g/mol; with the PDI being unitless), with lower numbers being preferred, but depending on the Mn of the polymer backbone employed (the higher the Mn of (A) also typically the higher the PDI) and also on the amount of (B) (the higher the amount of (B) relative to the amount of (A) typically the higher the PDI).

The respective values of MW and Mₙ can be determined using GPC standard methods, such as the one referenced in the experimental section. However, the molecular weights of the backbones used in this invention can also be calculated, as those reactions proceed basically to completeness. Hence, the calculation of the molecular weights based on the total molar amounts of ingredients employed for the preparation reaction is a viable way as well.” The graft polymers of the invention may contain a certain amount of ungrafted polymers (“ungrafted side chains”) made of monomers not being reacted with (i.e. grafted (on-)to) the polymer backbone.

The amount of such ungrafted polymers may be high or low, depending on the reaction conditions, but is preferably to be lowered and thus is more preferably low. By this lowering, the amount of grafted side chains is preferably increased. Such lowering can be achieved by suitable reaction conditions, such as dosing of monomers and radical initiator and their relative amounts and also in relation to the amount of backbone being present. Such adjustment is in principle known to a person of skill in the present field, and detailed hereinafter for this present invention within the description of a process to obtain the inventive graft polymers.

It has been found that the inventive graft polymers as detailed herein before exhibit an improved biodegradability which is at least 35, more preferably at least 40, even more preferably at least 50, such as 41, 42, 43, 44, 45 etc., 51, 52, 53 etc, 55, 60, 65, etc. and any number in between and up to 100%, within 28 days when tested under OECD 301F.

The ratios of (A) to (B) for the embodiments herein are:
(A) 20 to 95%, preferably 30 to 90%, more preferably 40 to 85%, most preferably 50 to 80% of a polymer backbone as a graft base, and
(B) 5 to 80%, preferably 10 to 70%, more preferably 15 to 60%, most preferably 20 to 50%, of polymeric sidechains (B) grafted onto the polymer backbone (A),

With each percentage being on the total weight of the graft polymer, and the total of (a) plus (B) being 100 wt. %.

Any and each of the sub-units (a1), (a2), the polymer backbones as graft bases (A), (A1), (A2), (A3) and (A4) as defined by their structure or their preparation, and the monomers (B), (B1), (B2), (B3), and further monomers besides (B1), (B2), (B3) are the ones as defined herein and specifically those defined before in all of their embodiments, preferred embodiment etc, and in the examples; any such embodiment for the sub-units (a1), (a2), the polymer backbones as graft bases (A), (A1), (A2), (A3) and (A4) as defined by their structure or their preparation, and the monomers (B), (B1), (B2), (B3), and further monomers besides (B1), (B2), (B3) may be chosen individually and combined, provided that such selection is possible and not ruled out herein, i.e. the totals need to add up as required and the embodiments are compatible (i.e. an embodiment requiring (B2) obviously not be combined with an embodiment requiring the absence of (B).

In a more preferred embodiment, the graft polymer of the invention and/or as detailed before consists of:
(A) at least on polymer backbone as graft base, such graft bases being any of the previously defined polymer backbones in any of the embodiments, preferably any of (A1), (A2), (A3) and (A4) as previously defined,
   in the amounts defined in any of the embodiments herein,
   including the description, the examples, and the claims,
and
(B) polymeric sidechains (B) grafted onto the polymer backbone (A), wherein said polymeric sidechains (B) are obtainable by (co-)polymerization of at least one vinyl ester monomer (B1), optionally vinylpyrrolidone (B2), and optionally further monomer(s) (B3), and optionally further monomers,
   all such monomers being any of the monomers as defined in any of the embodiments herein,
   in the amounts defined in any of the embodiments herein,
   including the description, the examples, and the claims.

In one embodiment of the previous embodiment, the vinyl ester monomer is vinyl acetate as the only monomer (B1), and vinylpyrrolidone is the only monomer (B2), and most preferably no other monomers (B3) and further monomers besides the previous ones are present.

In a preferred embodiment of the previous embodiment, the vinyl ester is hydrolyzed to about 20 to 50 mole percent, preferably about 30 to 45 mole %, most preferably about 40 mole %.

In a specific embodiment, the graft polymer of the invention consists of:
(A) 20 to 95%, preferably 30 to 90%, more preferably 40 to 85%, most preferably 50 to 80% of a polymer backbone as a graft base, with the percentages as weight percent in relation to the total weight of the graft polymer;
which comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C₂ to C₁₀-alkylene oxides, preferably C₂ to C₅-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein preferably the at least one lactone and/or hydroxy acid is/are selected from the groups
   i) and/or ii), with
   i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
   and
   ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone,
   wherein the polymer backbone is
   either obtained
(A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
(A2) by first oligo-/polymerizing sub-unit(s) (a2) and then polymerizing the product with sub-unit(s) (a1); or
(A3) By first oligo-/polymerizing sub-unit(s) (a1) and then co-polymerizing the product with sub-unit(s) (a2);
(A4) by first providing an oligo- or polymeric sub-unit (a1) which is bears an end-cap on one side, preferably is etherified with alcohols, more preferably short-chain alcohols C₁ to C₄, which—as starter-block—is thereafter reacted with at least one sub-unit (a2) and/or at least one sub-unit (a1)—wherein the sub-unit (a1) may be different to that/those in the starter block or may be arranged in a different order compared to those in the starter block—to attach to the non-endcapped side of the starter block a new block comprising moieties from the sub-units employed for the (co-)polymerizaiton, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
   wherein in case more than one sub-unit (a1) and/or more than one sub-unit (a2) are present already in an employed oligomer or polymer, those sub-units can be arranged in any order within such employed oligomer or polymer, and
   wherein in case more than one sub-unit (a1) and/or more than one sub-unit (a2) are present for the polymerization, those sub-units (and the optional oligomer/polymers if employed) can be arranged in any order within the obtained backbone;
      or selected from
(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
(A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on; and
(A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”,
(A4) a backbone consisting of
   a first block with on one end an end-cap—such end-cap being a C₁ to C₁₈, preferably C₁ to C₄-alkyl-group attached to said first block via an ether-function; and
   an oligo- or polymeric sub-unit (a1); and
   a second block which is attached to said first block at the opposite end of said first block (“opposite” in relation to the end-cap on said first block) via an ether or ester-function, said second block being composed of at least one sub-unit (a2) and optionally at least one sub-unit (a1), wherein the optional sub-unit(s) (a1) in said second block may be different to that/those in the first block or may be arranged in a different order compared to those in the first block, and the order of the sub-unit(s) (A1) and (a2) may be also in any order, including random structure,
   such di-block-structure having as an idealized structure in case of using only sub-unit(s) (a2): [end-cap]-[sub-unit(s) (a1)]-[sub-unit(s) (a2)]
   or in case of using sub-unit(s) (a1) and (a2): [end-cap]-[sub-unit(s) (a1)]-[random-{sub-unit(s) (a2)-sub unit(s) (a1)}];

With the amounts for sub-units (a1) and (a2) being those as herein defined before; and wherein—optionally—at least one starter molecule is included in the backbone structure; and
(B) 5 to 80%, preferably 10 to 70%, more preferably 15 to 60%, most preferably 20 to 50%, of polymeric sidechains (B) grafted onto the polymer backbone (A), wherein said polymeric sidechains (B) are obtainable by (co-)polymerization of at least one vinyl ester monomer (B1), optionally vinylpyrrolidone (B2), and optionally further monomer(s) (B3), and optionally further monomers,
   with the percentages as weight percent in relation to the total weight of the graft polymer; wherein the monomers are:
   (B1) at least one vinyl ester, selected from vinyl acetate, vinyl propionate and/or vinyl laurate and any further vinylester known to a person skilled in the art, such as vinyl valerate, vinyl pivalate, vinyl neodecanoate, vinyl decanoate and/or vinyl benzoate;
   Optionally
   (B2) N-vinylpyrrolidone;
   optionally
   (B3) at least one further monomer, such as any one or more of 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid; and
   Optionally
   at least one further monomer, being different from those before, such other monomer being present only in an amount of less than 2% of the total amount of monomers employed for obtaining the polymeric sidechains (B), and are preferably present only as impurities but not deliberately added for polymerization;
   with the amount(s) preferably as follows:
      if (B2) is present—
         (B) is from 10 to 60%, preferably up to 50%, more preferably up to 40%, and preferably from 20%;
         (B1) vinyl ester in weight percent being based on the total WEIGHT OF THE GRAFT POLYMER is
         from 9 to 55%, preferably up to 50, more preferably up to 40, even more preferably up to 35, and even more preferably up to 30%;
         (B2) vinylpyrrolidone in weight percent being based on the total WEIGHT OF THE GRAFT POLYMER is from 1 to 41%, preferably up to 30, more preferably up to 25 such as 1 to 25 and more preferably 5 to 25, even more preferably up to 15 such as 1 to 15 and more preferably 5 to 15, and further such as up to 10 up to 40, 35, 20, 10, and every number in between 1 and 41, wherein preferably the amount of (B2) is not higher than the amount of (B1)
         and
      if (B2) is not present—
         (B) is from 5 to 60%, preferably up to 50%, and preferably from 20%;
         (B1) (vinylester) in weight percent being based on the total WEIGHT OF THE GRAFT POLYMER is the total amount of (B) minus the total amount of (B3),
         (B2) vinylpyrrolidone is 0%,
         And further provided that in all cases before
         (B3) (further monomer) is from 0 to 10, preferably at most 2, more preferably at most 1, even more preferably about 0, but in all cases at most 10% of the amount of (B1), and not more than the amount of (B2);
         Wherein preferably at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 80, more preferably at least 90 weight percent, and most preferably essentially only vinyl acetate is employed as vinyl ester (weight percent being based on the total weight of vinyl ester monomers B1 being employed),
         And optionally the vinyl ester is hydrolyzed after polymerization.

In one embodiment of the previous embodiment, the vinyl ester monomer is vinyl acetate as the only monomer (B1), and more preferably vinylpyrrolidone is the only monomer (B2), and most preferably no other monomers (B3) and further monomers besides the previous ones are present.

In a preferred embodiment of the previous embodiment, the vinyl ester is hydrolyzed to about 20 to 50 mole percent, preferably about 30 to 45 mole %, most preferably about 40 mole %.

Inventive polymers have preferably at least one of the following additional properties, preferably two or more, to be more successfully employed in the various fields of applications targeted with this present invention:
i) the polymer backbone (A) may bear as the end-groups two hydroxy-groups or may be capped on both ends with C₁ to C₂₂-alkyl groups, preferably C₁ to C₄ alkyl groups;
ii) the graft polymer has a polydispersity (PDI) Mw/Mn of at most 10, preferably at most 5, more preferably at most 3, and most preferably in the range from 1.0 to 2.6, and any number a as upper or lower limit and any range in between such as 1,3 to 2,6, 1 to 3 etc. (with Mw=weight average molecular weight and Mn=number average molecular weight [g/mol/g/mol]);
iii) the biodegradability of the graft polymer is at least 35, more preferably at least 40, even more preferably at least 45, even further more preferably at least 50, such as 46, 47, 48, 49, 50, 55, 60, 65, 70, 75 etc. and any number in between and up to 100%, within 28 days, when tested under OECD 301F.

Further, the graft polymer is preferably water-soluble to a certain extent, to be able to employ the polymers within the aqueous environment typically present in the fields of applications as generally targeted with this present invention. Preferably inventive polymers should exhibit a medium to good, more preferably a good solubility in the environment of an aqueous formulation as typically employed in such fields for the various kinds of formulations, e.g. dish washing, automatic dish-washing, hard surface cleaning, fabric cleaning, fabric care, cosmetic formulations etc.

Further, the graft polymer solution preferably has a viscosity that at reasonably high solid concentrations of the polymer as to be handled in and after production and to be provided to the user, which could be e.g. as a “pure” (then typically liquid) product, dissolved in a solvent, typically an aqueous solution containing water and organic solvents, only water or only organic solvents, the viscosity of such polymer or polymer solution being in a range that allows typical technical process steps such as pouring, pumping, dosing etc. Hence, the viscosities should be preferably in a range of about up to less than 4000 mPas, more preferably up to 3500 mPas, even more preferably up to 3000 mPas, such as up to 4500, 3750, 3250, 2750 or even 2600 or below such as 2500, 2000, 1750, 1500, 1250, 1000, 750, 500, 250, 200, 150, or 100 mPas, at concentrations of the polymer (based on the total solid content of the polymer in solution, as defined by weight percent of the dry polymer within the total weight of the polymer solution) of preferably at least 10 wt. %, more preferably at least 20, and even more preferably at least 40 wt. %, and most preferably at least 50 wt. %, such as at least 60, 70, 80 or even 90 wt. %. The viscosity may be measured at either 25° C. or at elevated temperature, e.g. temperatures of 50 or even 60° C. By this a suitable handling of the polymer solutions in commercial scales is possible. It is of course evident that depending on the amount of solvent being added the viscosity is lower when the amount of solvent increases and vice versa, thus allowing for adjustment in case desired. It is also evident that the viscosity being measured depends on the temperature at which it is being measured, e.g. the viscosity of a given polymer with a given solid content of e.g. 80 wt. % will be higher when measured at lower temperature and lower when measured at a higher temperature. In a preferred embodiment the solid content is in between 70 and 99 wt. %, more preferably in between 75 and 85 wt. %, with no additional solvent being added but the polymer as prepared. In a more preferred embodiment, the solid content is in between 70 and 99 wt. %, more preferably in between 75 and 95 wt. %, with no additional solvent being added but the polymer as prepared, and the viscosity is lower than 3000 mPas, more preferably 3250, or even below 2750, 2600, 2500, 2000, 1750, 1500, 1250, 1000, 750, 500 or even 250 mPas, when measured at 60° C. The viscosity may be determined as generally known for such polymers, preferably as described below in the experimental part.

As further criteria, of course, the individual performance of a specific polymer needs to be evaluated and thus ranked for each individual formulation in a specific field of application. Due to the broad usefulness of the inventive polymers an exhaustive overview or detailed guidance for each area is not possible, but the present specification and examples give a guidance on how to prepare and select useful polymers of desired properties and how to tune the properties to the desired needs. One such criteria for the area of home care and especially fabric care of course it he performance upon washing, e.g. subjecting a certain material exhibiting stains of certain materials to a defined washing procedure.

The examples give some guidance for the application for washing of fabrics, i.e. the general area of fabric care.

Depending on the individual needs for a polymer exhibiting a defined degree of biodegradation, water solubility and viscosity (i.e. handling properties) the general and specific teachings herein—without being intended to be limited to the specific examples being given—will guide on how to obtain such polymer.

### Process

The invention also encompasses a process for obtaining a graft polymer according to any of the previous embodiments as defined herein and specifically any embodiment in the previous section, but also in any of the examples disclosed herein, wherein at least one vinyl ester monomer (B1), optionally avinylpyrrolidone as monomer (B2), optionally further monomer(s) (B3) and optional further monomers (besides (B1), (B2) and (B3)) is/are polymerized in the presence of at least one polymer backbone (A) as defined herein, preferably selected from backbones (A1), (A2), (A3) and (A4) as defined herein, wherein the polymeric sidechains (B) are obtained by radical polymerization, preferably using radical forming compounds to initiate the radical polymerization, wherein each B1, B2 and B3 (and further monomers besides (B1), (B2) and (B3)) and (A), (A1), (A2), (A3) and (A4) are as defined herein before, in any of the embodiments including the claims and including as exemplified in the examples below, with each of it preferably being selected from any of its grades of preferences, in as far as each can be selected individually form its preferences, but always confirming to the general requirements of compatibility of preferences, such as total sums not exceeding 100% etc.

It has to be noted that the “grafting process” as such, wherein a polymeric backbone, such as the polymer backbone (A) described herein above, is grafted with polymeric sidechains, is known to a person skilled in the art. Any process known to the skilled person in this respect can in principle be employed within the present invention.

The radical polymerization as such is also known to a skilled person. That person also knows that the inventive process can be carried out in the presence of a radical-forming initiator (C) and/or at least one solvent (D).

The skilled person knows the respective components suitable as such.

The term “radical polymerization” as used within the context of the present invention comprises besides the free radical polymerization also variants thereof, such as controlled radical polymerization. Suitable control mechanisms are RAFT, NMP or ATRP, which are each known to the skilled person, including suitable control agents.

In a preferred embodiment, the process to produce a graft polymer of the invention and/or as detailed before comprises the polymerization of at least one vinyl ester monomer (B1) and optionally vinylpyrrolidone as monomer (B2), optionally at least one further monomer (B3) and optionally further monomer(s)—the latter being preferably present only as impurities, and more preferably are essentially not present—in the presence of at least one polymer backbone (A), preferably selected from the backbones (A1), (A2), (A3) and (A4) as defined herein before, a free radical-forming initiator (C) and, if desired, up to 50% by weight, based on the sum of components (A), (B), and (C), of at least one solvent (D), at a mean polymerization temperature at which the initiator (C) has a decomposition half-life of from 40 to 500 min, in such a way that the fraction of unconverted graft monomers (B1), optional (B2) and optional (B3) (the further monomers typically not being monitored as present only as impurity in low, thus neglectable amounts) and initiator (C) in the reaction mixture is constantly kept in a quantitative deficiency relative to the copolymer backbone (A). In a preferred embodiment no monomer (B2) is employed. In a more preferred embodiment, no monomer (B2) nor monomer (B3) are employed. In an even more preferred embodiment only monomer(s) (B1) are employed. Generally, the amount of further monomer(s) besides (B1), (B2) and (B3) is minimized, preferably they are not present at all.

In a preferred embodiment of any of the embodiments of the process as detailed in the previous paragraph, at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 60, more preferably at least 70, even more preferably at least 80, even more preferably at least 90 weight percent, and most preferably essentially only (i.e. about 100 wt. % or even 100 wt. %) vinyl acetate is employed as vinyl ester (weight percent being based on the total weight of vinyl ester monomers B1 being employed).

Generally, besides monomers (B1), (B2) and (B3), at least one further monomer, being different from those before, may be employed for the co-polymerization to yield the side chains (B), wherein such further monomer is present only in an amount of less than 2% of the total amount of monomers employed for obtaining the polymeric sidechains (B), and is preferably employed only as—in practical aspects non-avoidable—impurities but not deliberately added for polymerization, and most preferably is not present at all.

In a more preferred embodiment of the previous two paragraphs, the following additional provisions 1) (presence of (B2)) and 2) (absence of (B2)) apply for the amounts and ratios of monomers:

In case monomer (B2) is employed, the amounts of monomers are as follows, based on the total WEIGHT OF THE GRAFT POLYMER:
(B) is from 10 to 60%, preferably up to 50%, more preferably up to 40%, and preferably from 20%;
(B1) vinyl ester in weight percent being based on the total WEIGHT OF THE GRAFT POLYMER is
from 9 to 55%, preferably up to 50, more preferably up to 40, even more preferably up to 35, and even more preferably up to 30%;
(B2) vinylpyrrolidone in weight percent being based on the total WEIGHT OF THE GRAFT POLYMER is from 1 to 25 and more preferably 5 to 20, even more preferably up to 15 such as 1 to 15 and more preferably 5 to 15, and further such as up to 10 and up to 19, 18, 17, 16, 14, 13, 12, 11, 10, and every number in between 1 and 25, wherein preferably the amount of (B2) is not higher than the amount of (B1);
(B3) (further monomer) is from 0 to 10, preferably at most 2, more preferably at most 1, even more preferably about 0, but in all cases at most 10% of the amount of (B1), and not more than the amount of (B2).

The amount of further monomer(s) besides (B1), (B2) and (B3) is as detailed before, and the monomers (B1), (B2) and (B3) are those as detailed herein before in any of the embodiments disclosed.

In case monomer (B2) is not employed, the amounts of monomers are as follows, based on the total WEIGHT OF THE GRAFT POLYMER:
B) is from 5 to 60%, preferably up to 50%, and preferably from 20%;
(B1) vinyl ester in weight percent being based on the total WEIGHT OF THE GRAFT POLYMER is the total amount of (B) minus the total amount of (B3),
(B2) vinylpyrrolidone is 0%;
(B3) (further monomer) is from 0 to 10, preferably at most 2, more preferably at most 1, even more preferably about 0.

The amount of further monomer(s) besides (B1), (B2) and (B3) is as detailed before, and the monomers (B1), (B2) and (B3) are those as detailed herein before in any of the embodiments disclosed.

In a preferred embodiment, the amount of vinyl ester monomer (B1) employed is usually not smaller than 10% by weight (in relation to the sum of (B1) and (B2)).

Preferably, optional further monomers (B3) are present also only as impurities but not deliberately added for polymerization. More preferably, the amount is less than 1, more preferably less than 0.5%, even more preferably less than 0.01% by weight based on total weight of monomers (B1), most preferably there is essentially no such monomers (B3), and most preferably even a total absence of any other monomer besides the monomers (B1) and optional monomers (B2). The same applies for the further monomers besides (B1), (B2) and (B3).

In specifically preferred embodiments, the amounts of monomers employed are as follows, based on the total WEIGHT OF THE GRAFT POLYMER:
(A) is from 40 to 90%, preferably from 50%, more preferably from 60%, and preferably at most 80%, of a polymer backbone as defined herein before, preferably at least one of (A1), (A2) and (A3), as a graft base,
(B) is from 10 to 60%, preferably up to 50%, more preferably up to 40%, and preferably from 20%;
(B1) vinylester is from 9 to 55%, preferably up to 50, more preferably up to 40, even more preferably up to 35, and even more preferably up to 30%;
(B2) vinylpyrrolidone is from 1 to 25%, preferably up to 20, more preferably up to 15, even more preferably up to 10, such as even only up to 5, wherein at most the amount of (B2) is not higher than the amount of (B1);
(B3) (further monomer(s)) is from 0 to 2, preferably at most 1, more preferably 0, but in all cases at most 10% of the amount of (B1), and not more than the amount of (B2);
More preferably the optional further monomers (B3) and the further monomers besides (B1), (B2) and (B3) are preferably present only as impurities but not deliberately added for polymerization; more preferably, the amount is less than 1, more preferably less than 0.5%, even more preferably less than 0.01% by weight based on total weight of monomers (B1), most preferably there is essentially no such monomers (B3) nor further monomers, and most preferably even a total absence of any other monomer besides the monomers (B1) and (B2).

The amount of vinyl ester monomer (B1) is usually not smaller than 10% by weight (in relation to the sum of (B1) and (B2)).

In alternatively specifically preferred embodiments, the amounts of monomers employed are as follows, based on the total WEIGHT OF THE GRAFT POLYMER:
(A) is from 40 to 90%, preferably from 50%, more preferably from 80%, of a polymer backbone as defined herein before, preferably at least one of (A1), (A2) and (A3), as a graft base;
(B) is from 10 to 60%, preferably up to 50%, and preferably from 20%;
(B1) vinyl ester is the total amount of (B) minus the total amount of (B3);
(B2) is 0%;
(B3) (further monomer(s)) is from 0 to 2, preferably at most 1, more preferably 0, but in all cases at most 10% of the amount of (B1), and not more than the amount of (B2);
the amount of vinyl ester monomer (B1) is usually not smaller than 10% by weight (in relation to the sum of (B1) and (B2));
the optional further monomers (B3) and the further monomers beside (B1), (B2) and (B3) are preferably present only as impurities but not deliberately added for polymerization. More preferably, the amount is less than 1, more preferably less than 0.5%, even more preferably less than 0.01% by weight based on total weight of monomers (B1), most preferably there is essentially no such monomers (B3) nor further monomers, and most preferably even a total absence of any other monomer besides the monomers (B1).

The amount of ((free) radical-forming) initiator (C) is preferably from 0.1 to 5% by weight, in particular from 0.3 to 3.5% by weight, based in each case on the polymeric sidechains (B).

For the process according to the invention, it is preferred that the steady-state concentration of radicals present at the mean polymerization temperature is substantially constant and the graft monomers (B), and especially (B1), more preferably (B1) and (B2), even more preferably (B1), (B2) and (B3), are present in the reaction mixture constantly only in low concentration (for example of not more than 5% by weight in total). This allows the reaction to be controlled, and graft polymers can be prepared in a controlled manner with the desired low polydispersity.

To assure a safe temperature control although—especially when a polymerization is started at high solid concentrations or in bulk and/or with a large amount of monomers being present from the start on it is advisable, and thus preferred, to use an additional and efficient measure to control the temperature. This can be done by external and/or internal cooling; such cooling can be done by internal and/or external coolers such as heat exchangers, or using reflux condensers when working at the boiling temperature of the solvent or the solvent mixture at a given temperature/pressure-combination.

The same measure could of course be used for the preferred embodiment mentioned before wherein the monomers are added over a prolonged period of time, and thus the monomer concentration in the reaction volume being constantly low over time.

However, under such conditions, temperature control is usually not a crucial point, as the temperature is at least partially controlled also by the propagation of the polymerization reaction by controlling the radical concentration and the available amount of polymerizable monomers. Of course, depending on the scale of the polymerisation reaction, such additional cooling as described before may become necessary for both variants—batch reaction or bulk reactions with large amounts of monomer present from the start or semi-continuous or continuous polymerization reactions with typically constantly low monomer concentrations—when the scale gets large enough that the ratio from volume to surface of the polymerization mixture becomes very large.

This however is generally known to a person of skill in the art of commercial scale polymerisations, and thus can be adapted to the needs.

According to the invention, the initiator (C) and the graft monomers (B), and especially (B1) and/or (B2) and/or (B3), preferably twice “and”, are advantageously added in such a way that a low and substantially constant concentration of undecomposed initiator and graft monomers (B), and especially a constant but low amount of (B1) and especially even more (B2), are present in the reaction mixture. The proportion of undecomposed initiator in the overall reaction mixture is preferably 15% by weight, in particular 10% by weight, based on the total amount of initiator metered in during the monomer addition.

In a more preferred embodiment, the process comprises the polymerization of at least one vinyl ester monomer (B1) and optionally at least one nitrogen-containing monomer (B2), optionally at least one other monomer (B3) and optionally at least one further monomer(s), more preferably only monomers (B1) and (B2), in the presence of at least one polymer backbone (A) as defined herein, preferably selected from (A1), (A2) and (A3), a free radical-forming initiator (C) and, if desired, up to 50% by weight, based on the sum of components (A), (B) and (C), of at least one solvent (D), at a mean polymerization temperature at which the initiator (C) has a decomposition half-life of from 40 to 500 min, in such a way that the fraction of unconverted graft monomers (B) and initiator (C) in the reaction mixture is constantly kept in a quantitative deficiency relative to the polymer backbone (A), wherein preferably at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 60, more preferably at least 70, even more preferably at least 80, even more preferably at least 90 weight percent, and most preferably essentially only (i.e. about 100 wt. % or even 100 wt. %) vinyl acetate is employed as vinyl ester (weight percent being based on the total weight of vinyl ester monomers B1 being employed).

In an even more preferred embodiment of the preceding embodiment before, besides the monomer(s) (B1) essentially no monomer (B2) is employed, preferably (B1) comprises vinyl acetate, more preferably comprises essentially only vinyl acetate, all in the ranges and preferred ranges given in the section on the “graft polymers of this invention”.

In an alternative embodiment to the one before, besides the monomer(s) (B1) essentially only monomer (B2) is employed, preferably (B1) comprises vinyl acetate, more preferably comprises essentially only vinyl acetate, and preferably (B2) vinylpyrrolidone is present, all in the ranges and preferred ranges given in the section on the “graft polymers of this invention”.

The mean polymerization temperature for the main polymerization and the post-polymerization is appropriately in the range from 50 to 140° C., preferably from 60 to 120° C. and more preferably from 65 to 110° C. Typically, the temperature for the post-polymerization is higher by 5 to 40° C. compared to the polymerization.

The term “mean polymerization temperature” is intended to mean here that, although the process is substantially isothermal, there may, owing to the exothermicity of the reaction, be temperature variations which are preferably kept within the range of +/−10° C., more preferably in the range of +/−5° C.

According to the invention, the (radical-forming) initiator (C) at the mean polymerization temperature should have a decomposition half-life of from 40 to 500 min, preferably from 50 to 400 min and more preferably from 60 to 300 min.

Examples of suitable initiators (C) whose decomposition half-life in the temperature range from 50 to 140° C. is from 20 to 500 min are:
O—C₂-C₁₂-acylated derivatives of tert-C₄-C₁₂-alkyl hydroperoxides and tert-(C₉-C₁₂-aralkyl) hydroperoxides, such as tert-butyl peroxyacetate, tert-butyl monoperoxymaleate, tert-butyl peroxyisobutyrate, tert-butyl peroxypivalate, tert-butyl peroxyneoheptanoate, tert-butyl peroxy-2-ethylhexanoate, tert-butyl peroxy-3,5,5-trimethylhexanoate, tert-butyl peroxyneodecanoate, tert-amyl peroxypivalate, tert-amyl peroxy-2-ethylhexanoate, tert-amyl peroxyneodecanoate, 1,1,3,3-tetramethylbutyl peroxyneodecanoate, cumyl peroxyneodecanoate, tert-butyl peroxybenzoate, tert-amyl peroxybenzoate and di-tert-butyl diperoxyphthalate;
di-O—C₄-C₁₂-acylated derivatives of tert-C₈-C₁₄-alkylene bisperoxides, such as 2,5-dimethyl-2,5-di(2-ethylhexanoylperoxy)hexane, 2,5-dimethyl-2,5-di(benzoylperoxy)hexane and 1,3-di(2-neodecanoylperoxyisopropyl)benzene;
di(C₂-C₁₂-alkanoyl) and dibenzoyl peroxides, such as diacetyl peroxide, dipropionyl peroxide, disuccinyl peroxide, dicapryloyl peroxide, di(3,5,5-trimethylhexanoyl) peroxide, didecanoyl peroxide, dilauroyl peroxide, dibenzoyl peroxide, di(4-methylbenzoyl) peroxide, di(4-chlorobenzoyl) peroxide and di(2,4-dichlorobenzoyl) peroxide;
tert-C₄-C₅-alkyl peroxy(C₄-C₁₂-alkyl)carbonates, such as tert-amyl peroxy(2-ethyl-hexyl)carbonate;
di(C₂-C₁₂-alkyl) peroxydicarbonates, such as di(n-butyl) peroxydicarbonate and di(2-ethylhexyl) peroxydicarbonate.

Depending on the mean polymerization temperature, examples of particularly suitable initiators (C) are:
at a mean polymerization temperature of from 50 to 60° C.: tert-butyl peroxyneoheptanoate, tert-butyl peroxyneodecanoate, tert-amyl peroxypivalate, tert-amyl peroxyneodecanoate, 1,1,3,3-tetramethylbutyl peroxyneodecanoate, cumyl peroxyneodecanoate, 1,3-di(2-neodecanoyl peroxyisopropyl)benzene, di(n-butyl) peroxydicarbonate and di(2-ethylhexyl) peroxydicarbonate;
at a mean polymerization temperature of from 60 to 70° C.: tert-butyl peroxypivalate, tert-butyl peroxyneoheptanoate, tert-butyl peroxyneodecanoate, tert-amyl peroxypivalate and di(2,4-dichlorobenzoyl) peroxide;
at a mean polymerization temperature of from 70 to 80° C.: tert-butyl peroxypivalate, tert-butyl peroxyneoheptanoate, tert-amyl peroxypivalate, dipropionyl peroxide, dicapryloyl peroxide, didecanoyl peroxide, dilauroyl peroxide, di(2,4-dichlorobenzoyl) peroxide and 2,5-dimethyl-2,5-di(2-ethylhexanoylperoxy)hexane;
at a mean polymerization temperature of from 80 to 90° C.: tert-butyl peroxyisobutyrate, tert-butyl peroxy-2-ethylhexanoate, tert-amyl peroxy-2-ethylhexanoate, dipropionyl peroxide, dicapryloyl peroxide, didecanoyl peroxide, dilauroyl peroxide, di(3,5,5-trimethylhexanoyl) peroxide, dibenzoyl peroxide and di(4-methylbenzoyl) peroxide;
at a mean polymerization temperature of from 90 to 100° C.: tert-butyl peroxyisobutyrate, tert-butyl peroxy-2-ethylhexanoate, tert-butyl monoperoxymaleate, tert-amyl peroxy-2-ethylhexanoate, dibenzoyl peroxide and di(4-methylbenzoyl) peroxide;
at a mean polymerization temperature of from 100 to 110° C.: tert-butyl monoperoxymaleate, tert-butyl peroxyisobutyrate and tert-amyl peroxy(2-ethylhexyl)carbonate;
at a mean polymerization temperature of from 110 to 120° C.: tert-butyl monoperoxymaleate, tert-butyl peroxy-3,5,5-trimethylhexanoate and tert-amyl peroxy(2-ethylhexyl)carbonate.

Preferred initiators (C) are O—C₄-C₁₂-acylated derivatives of tert-C₄-C₅-alkyl hydroperoxides, particular preference being given to tert-butyl peroxypivalate and tert-butyl peroxy-2-ethylhexanoate.

Particularly advantageous polymerization conditions can be established effortlessly by precise adjustment of initiator (C) and polymerization temperature. For instance, the preferred mean polymerization temperature in the case of use of tert-butyl peroxypivalate is from 60 to 80° C., and, in the case of tert-butyl peroxy-2-ethylhexanoate, from 80 to 100° C.

The inventive polymerization reaction can be carried out in the presence of, preferably small amounts of, a solvent (D). It is of course also possible to use mixtures of different solvents (D). Preference is given to using water-soluble or water-miscible organic solvents. However, water as only solvent is in principle also possible but not preferred.

When a solvent (D) is used as a diluent, generally from 1 to 40% by weight, preferably from 1 to 35% by weight, more preferably from 1.5 to 30% by weight, most preferably from 2 to 25% by weight, based in each case on the sum of the components (A), (B1), optionally (B2), optionally (B3) and optional further monomers, and (C), are used.

Examples of suitable solvents (D) include:
monohydric alcohols, preferably aliphatic C₁-C₁₆-alcohols, more preferably aliphatic C₂-C₁₂-alcohols, most preferably C₂-C₄-alcohols, such as ethanol, propanol, isopropanol, butanol, sec-butanol and tert-butanol;
polyhydric alcohols, preferably C₂-C₁₀-diols, more preferably C₂-C₆-diols, most preferably C₂-C₄-alkylene glycols, such as ethylene glycol, 1,2-propylene glycol and 1,3-propylene glycol;
alkylene glycol ethers, preferably alkylene glycol mono(C₁-C₁₂-alkyl) ethers and alkylene glycol di(C₁-C₆-alkyl) ethers, more preferably alkylene glycol mono- and di(C₁-C₂-alkyl) ethers, most preferably alkylene glycol mono(C₁-C₂-alkyl) ethers, such as ethylene glycol monomethyl and -ethyl ether and propylene glycol monomethyl and -ethyl ether;
polyalkylene glycols, preferably poly(C₂-C₄-alkylene) glycols having 2-20 C₂-C₄-alkylene glycol units, more preferably polyethylene glycols having 2-20 ethylene glycol units and polypropylene glycols having 2-10 propylene glycol units, most preferably polyethylene glycols having 2-15 ethylene glycol units and polypropylene glycols having 2-4 propylene glycol units, such as diethylene glycol, triethylene glycol, dipropylene glycol and tripropylene glycol;
polyalkylene glycol monoethers, preferably poly(C₂-C₄-alkylene) glycol mono(C₁-C₂₅-alkyl) ethers having 2-20 alkylene glycol units, more preferably poly(C₂-C₄-alkylene) glycol mono(C₁-C₂₀-alkyl) ethers having 2-20 alkylene glycol units, most preferably poly(C₂-C₃-alkylene) glycol mono(C₁-C₁₆-alkyl) ethers having 3-20 alkylene glycol units;
carboxylic esters, preferably C₁-C₆-alkyl esters of C₁-C₆-carboxylic acids, more preferably C₁-C₄-alkyl esters of C₁-C₃-carboxylic acids, most preferably C₂-C₄-alkyl esters of C₂-C₃-carboxylic acids, such as ethyl acetate and ethyl propionate;
aliphatic ketones which preferably have from 3 to 10 carbon atoms, such as acetone, methyl ethyl ketone, diethyl ketone and cyclohexanone;
cyclic ethers, in particular tetrahydrofuran.

The solvents (D) are advantageously those solvents, which are also used to formulate the inventive graft polymers for use (for example in washing and cleaning compositions) and can therefore remain in the polymerization product.

Preferred examples of these solvents are polyethylene glycols having 2-15 ethylene glycol units, polypropylene glycols having 2-6 propylene glycol units and in particular alkoxylation products of C₆-C₈-alcohols (alkylene glycol monoalkyl ethers and polyalkylene glycol monoalkyl ethers). Particular preference is given here to alkoxylation products of C₈-C₁₆-alcohols with a high degree of branching, which allow the formulation of polymer mixtures which are free-flowing at 40-70° C. and have a very low polymer content at comparatively low viscosity. The branching may be present in the alkyl chain of the alcohol and/or in the polyalkoxylate moiety (copolymerization of at least one propylene oxide, butylene oxide or isobutylene oxide unit). Particularly suitable examples of these alkoxylation products are 2-ethylhexanol or 2-propylheptanol alkoxylated with 1-15 mol of ethylene oxide, C₁₃/C₁₅ oxo alcohol or C₁₂/C₁₄ or C₁₆/C₁₈ fatty alcohol alkoxylated with 1-15 mol of ethylene oxide and 1-3 mol of propylene oxide, preference being given to 2-propylheptanol alkoxylated with 1-15 mol of ethylene oxide and 1-3 mol of propylene oxide.

In an alternative embodiment the polymerization is performed using a mixture of at least one organic solvent and water.

In a preferred embodiment, the amount of water during the polymerization is low, preferably at most 10 wt. %, more preferably at most 5 wt % based on total solvent, more preferably at most 1%.

In a further alternative embodiment the polymerization is performed using water as solvent (D). However, water as only solvent is not preferred.

The radical initiator (C) is preferably employed in the form of a concentrated solution in one of the solvents mentioned before. The concentration of course depends on the solubility of the radical initiator. It is preferred, that the concentration is as high as possible to allow to introduce as little as possible of the organic solvent into the polymerization reaction. In case the initiator is soluble in water, and thus water is used as solvent for introducing the initiator, the concentration is not critical from the viewpoint of residual levels of water.

Preferably, the amount of water during the polymerisation is at most 10 wt. %, preferably at most 5 wt. %, more preferably at most 1 wt. %, based on total weight of graft polymer (at the end of the polymerization) or based on total weight of (A) and (B) (at the start of the polymerization).

In the process according to the invention, polymer backbone (A), graft monomer(s) (B), initiator (C) and, if appropriate, solvent (D) are usually heated to the selected mean polymerization temperature in a reactor.

According to the invention, the polymerization is carried out in such a way that an excess of polymer (polymer backbone (A) and formed graft polymer) is constantly present in the reactor. The quantitative ratio of polymer to ungrafted monomer and initiator is generally ≥10:1, preferably ≥15:1 and more preferably ≥20:1.

The polymerization process according to the invention can in principle be carried out in various reactor types. Such reactor types are generally known, and includes any stirred-type reactor such as vessels, but also includes tube reactors, reactor cascades from vessels or various tubes etc.

The reactor used is preferably a stirred tank in which the polymer backbone (A), if appropriate together with portions, of generally up to 15% by weight of the particular total amount, of graft monomers (B), initiator (C) and solvent (D), are initially charged fully or partly and heated to the polymerization temperature, and the remaining amounts of (B), (C) and, if appropriate, (D) are metered in, preferably separately. The remaining amounts of (B), (C) and, if appropriate, (D) are metered in preferably over a period of ≥2 h, more preferably of ≥4 h and most preferably of ≥5 h.

In the case of a particularly preferred, substantially solvent-free process variant, the entire amount of polymer backbone (A) is initially charged as a melt and the graft monomers (B1) and, if appropriate, (B2) and/or (B3), and also the initiator (C) present preferably in the form of a from 10 to 50% by weight solution in one of the solvents (D), are metered in, the temperature being controlled such that the selected polymerization temperature, on average during the polymerization, is maintained with a range of especially +/−10° C., in particular +/−5° C.

In a further particularly preferred, low-solvent process variant, the procedure is as described above, except that solvent (D) is metered in during the polymerization in order to limit the viscosity of the reaction mixture. It is also possible to commence with the metered addition of the solvent only at a later time with advanced polymerization, or to add it in portions.

The polymerization can be affected under standard pressure or at reduced or elevated pressure. When the boiling point of the monomers (B1) and/or (B2) (and if employed also monomer (B3)) and/or of any solvent (D) used is exceeded at the selected pressure, the polymerization is carried out with reflux cooling.

A post-polymerization process step may be added after the main polymerization reaction. For that a further amount of initiator (dissolved in the solvent(s)) can be added over a period of 0.5 hour and typically up to 3 hours, preferably about 1 to 2 hours, more preferably about 1 hour, (such duration however also depending on the scale of the reactor) with the radical initiator and the solvent(s) for the initiator typically—and preferred—being the same as the ones for the main polymerization reaction. Of course, a different radical initiator and/or different solvent(s) may be employed as well.

The temperature of the post-polymerisation process step may be the same as in the main polymerization reaction (which is preferred in this invention) or may be increased. In case increased, it may be typically higher by about 5 to 40° C., preferably 10 to 20° C.

In between the post-polymerisation and the main polymerization a certain period of time may be waited, where the main polymerization reaction is left to proceed, before the post-polymerisation reaction is started by starting the addition of further radical initiator.

For solvents having a boiling point of approximately less than 110-120° C. at atmospheric pressure, such solvents may—as a purification step—be removed partially or essentially complete by thermal or vacuum distillation or stripping with a gas such as steam or nitrogen, such as stripping with steam made from water, all at ambient or reduced pressure, preferably vacuum distillation, whereas higher boiling solvents will usually stay in the polymer products obtained. When mercaptoethanol is employed as chain transfer regulator, steam distillation is the preferred step of purification. Hence, higher boiling solvents like 1-methoxy-2-propanol, 1,2-propandiol and tripropylene glycol will stay in the polymer product, and thus their amounts should be minimized as far as possible by using as high as possible concentrations of the radical initiator when such solvents are used only for introducing the initiator, unless such solvents form also part of the formulation the graft polymer will be used within.

The graft polymers of the invention prepared using the process as defined herein may contain a certain amount of ungrafted polymers (“ungrafted side chains”) made of vinyl ester(s), e.g. poly vinyl acetate in case only vinyl acetate is employed, and/or—when further monomers are employed—homo- and copolymers of vinyl ester(s) with the other monomers. The amount of such ungrafted vinyl ester-homo- and copolymers may be high or low, depending on the reaction conditions, but is preferably to be lowered and thus low. By this lowering, the amount of grafted side chains is preferably increased. Such lowering can be achieved by suitable reaction conditions, such as dosing of vinyl ester and radical initiator and their relative amounts and also in relation to the amount of backbone being present. Such reaction controlling and the necessary process steps is generally known to a person of skill in the present field, specific guidance being given herein.

This adjustment of the degree of grafting and this amount of ungrafted polymers can be used to optimize the performance in areas of specific interest, e.g. certain (e.g. detergent-) formulations, application areas or desired cleaning etc. performance.

It is believed that the conditions considered favorable herein promote a—suspected—higher degree of grafting; such higher degree of grafting is associated with a better performance. This suspected higher degree of grafting however does not compromise the biodegradation—which is attributed to the ester linkage in the backbone, which can “compensate” the lower biodegradation of a graft polymer having a higher degree of grafting—which is seen in the “conventional graft polymers” based on polyalkylene oxides as backbone.

A drawback is that it is extremely difficult if not even impossible to actually verify such degree of grafting on a polymer, especially with increasing molecular weights of the polymers, as the total amount of grafting sites in a polymer is generally very low compared to the molecular weight; thus, the signal-noise-ratio is unfavorable for polymers in view of current analytical tools.

In another—alternative—embodiment of the present invention, the polymeric sidechains (B) of the graft polymer according to the present invention are fully or partially hydrolyzed, preferably partially hydrolyzed, more preferably up to 50 mole %, and preferably from 20 mole %, more preferably 20 to 50, even more preferably 30 to 45, such as about 40 mole %, based on the total moles of (B1) employed, after the polymerization reaction and thus after the graft polymer as such is obtained. This means that the full or at least partial hydrolyzation of the polymeric sidechains (B) of the graft polymer is carried out in a further process step after the polymerization process (including after the optional post-polymerisation step if employed) of the polymeric sidechains (B) is finished.

In another alternative embodiment, no hydrolysis is performed on the graft polymer after the polymerization process of the polymeric sidechains (B) is finished.

Due to this full or at least partial hydrolyzation of the polymeric sidechains (B) of the graft polymers according to the present invention, the respective sidechain units originating from the at least one vinyl ester monomer (B1) are changed from the respective ester function into the alcohol function within the polymeric sidechain (B). It has to be noted that the corresponding vinyl alcohol is not suitable to be employed as monomer within the polymerization process of the polymeric sidechains (B) due to stability aspects of the “vinylalcohol”-monomer. In order to obtain an alcohol function (hydroxy substituent) within the polymeric sidechains (B) of the graft polymers according to the present invention, the alcohol function is typically introduced by hydrolyzing the ester function of the sidechains.

From a theoretical point of view, each ester function of the polymeric sidechain (B) may be partially or completely replaced by an alcohol function (hydroxy group). In such a case, the polymeric sidechain is fully hydrolyzed (“saponified”).

The hydrolysis can be carried out by any method known to a person skilled in the art. For example, the hydrolysis can be induced by addition of a suitable base, such as sodium hydroxide or potassium hydroxide. Such hydrolysis processes are known from prior art.

In a preferred embodiment of the embodiments before, vinyl acetate is employed as monomer (B1) and vinylpyrrolidone as monomer (B2) and no other monomers are employed besides (B1) and (B2), and the polymer moiety stemming from vinyl acetate is partially hydrolyzed after polymerisation, preferably in an amount of from 20 to 50 mole, more preferably 30 to 45, such as—most preferably—about 40 mole % based on the total moles of (B1) employed.

The graft polymer of this invention, i.e. the polymer solution obtained from the process, may be also subjected to a means of concentration and/or drying.

The graft polymer solution obtained may be concentrated by subjecting the polymer solutions to means for removing part of the volatiles and especially solvent(s) to increase the solid polymer concentration. This may be achieved by distillation processes such as thermal or vacuum distillation, or by stripping using gases such as steam or inert gases such as nitrogen or argon, which is performed until the desired solid content is achieved. Such process can be combined with the purification step as disclosed before wherein the graft polymer solution obtained is purified by removing part or all of the volatile components such as volatile solvents and/or unreacted, volatile monomers, by removing the desired amount of solvent.

The graft polymer solution may be also after the main and/or the optional post-polymerization step and the optional purification step further concentrated or dried by subjecting the graft polymer solution to means of removing the volatiles partially or fully, such as—for concentration—distillation processes such as thermal or vacuum distillation, or by stripping using gases such as steam or inert gases such as nitrogen or argon, which is performed until the desired solid content is achieved, and/or drying such as roller-drum drying, spray-drying, vacuum drying or freeze-drying, preferably—mainly for cost-reasons—spray-drying. Such drying process may be also combined with an agglomeration or granulation process such as spray-agglomeration, granulation or drying in a fluidized-bed dryer.

Hence, the process of the invention encompasses preferably at least one further process step selected from i) to iv), with i) post-polymerisation; ii) purification; iii) concentration; and iv) drying.

More preferably, the process as detailed herein in any of the embodiments defined, comprises at least one further process step selected from:
i) a post-polymerization process step that is performed after the main polymerization reaction, wherein preferably a further amount of initiator (optionally dissolved in the solvent(s)) is added over a period of 0.5 hour and up to 3 hours, preferably about 1 to 2 hours, more preferably about 1 hour, with the radical initiator and the solvent(s) for the initiator typically—and preferred—being the same as the ones for the main polymerization reaction; and wherein after the polymerization reaction and before the post-polymerisation reaction preferably a period is waited when the main polymerization reaction is left to proceed, before the post-polymerisation reaction is started by starting the addition of further radical initiator, such period being preferably from 10 minutes and up to 4 hours, preferably up to 2 hours, even more preferably up to 1 hour, and most preferably up to 30 minutes; and wherein the temperature of the post-polymerisation process step is—preferably—the same as in the main polymerization reaction, or is increased, such increase being preferably higher by about 5 to 40° C., preferably 10 to 20° C. compared to the temperature of the main polymerisation reaction;
ii) a step of subjecting the graft polymer as obtained from the main polymerization or—if performed, the post-polymerisation process—to a means of purification, concentration and/or drying to remove part of or almost all of the remaining solvent(s) (as far as they are removable due to their boiling points) and/or volatiles such as residual monomers, wherein
   a. the concentration is performed by removing part of the solvent(s) and optionally also volatiles—by this this step additionally serves as means for purification—to increase the solid polymer concentration—and optionally as well for purification—, by preferably applying a distillation process such as thermal or vacuum distillation, preferably vacuum distillation, and/or applying stripping with gas such as steam or an inert gas such as nitrogen, preferably using steam from water, which is performed until the desired solid content and optionally also purity is achieved, preferably is performed until the desired part or all of the volatile components such as volatile solvents and/or unreacted, volatile monomers, are removed;
   b. the drying is performed by subjecting the graft polymer containing at least residual amounts of volatiles such as remaining solvent and/or unreacted monomers etc. to a means of removing the volatiles, such as drying using a roller-drum, a spray-dryer, vacuum drying or freeze-drying, preferably—mainly for cost-reasons—spray-drying; and optionally combining such drying process step with a means of agglomeration or granulation to obtain agglomerated or granulated graft polymer particles, such process being preferably selected from spray-agglomeration, granulation or drying in a fluidized-bed dryer, spray-granulation device and the like.

### Uses of Graft Polymer.

In principle the graft polymers of this invention can be employed in any application to replace conventional graft polymers of the same or very similar composition (in terms of relative amounts of polymer backbone and grafted monomers especially when the type and amounts of grafted monomers is similar or comparable. Such applications are for example: Redeposition of soils and removing of stains, avoiding or reducing re-soiling or greying or deposition of solids or redeposition of dyes, dispersion of actives in formulations improve dispersion stability, hydrophobisation of surfaces, reduction of growth of microbes on surfaces, and/or odor control etc., all compared to corresponding polymers or graft polymers according to the prior art.

The inventive graft polymers as defined herein, obtainable by a process as defined herein or obtained by the process as defined herein, can improve the overall biodegradation ratio of such formulation, compositions and products by replacing non-biodegradable polymers of similar structures or properties. They may thus be advantageously used—partly also depending on the monomer(s) B employed for grafting and thus adjusted in their performance to the specific needs of the specific applications; such monomer substitution pattern as possibly also derivable from the prior art of analogous graft polymers based on simple PEGs and polyalkylene glycols.

Specifically, and beyond the performance in a certain type of application, the graft polymers according to the present invention lead to an improved biodegradability when being employed within such compositions or products, compared to the previously known graft polymers.

Hence, another subject matter of the present invention is the use of the graft polymers of the invention and/or obtained by or obtainable by a process of the invention and/or as detailed before, in cleaning compositions, fabric and home care products, in particular cleaning compositions for improved oily and fatty stain removal, removal of solid dirt such as clay, prevention of greying or discoloration of fabric surfaces, and/or anti-scale agents, wherein the cleaning composition is preferably a laundry detergent formulation and/or a dish wash detergent formulation, more preferably a liquid laundry detergent formulation and/or a liquid manual dish wash detergent formulation.

Preferably, the graft polymers are used in cleaning compositions and in laundry treatment, laundry care products and laundry washing products, more preferably a laundry detergent formulation, even more preferably a liquid laundry detergent formulation. In particular, the inventive graft polymer is employed in such composition/product/formulation for improved dye transfer inhibition.

Laundry detergents, cleaning compositions and/or fabric and home care products as such are known to a person skilled in the art. Any composition etc. known to a person skilled in the art, in connection with the respective use, can be employed within the context of the present invention.

In a preferred embodiment, it is a cleaning composition and/or fabric and home care product, comprising at least one graft polymer as defined above. In particular, it is a cleaning composition for improved cleaning performance and/or—(preferably “and”)—improved anti redeposition for example in respect of redeposition of soils and dyes, and removing of stains, preferably a laundry detergent formulation and/or a manual dish wash detergent formulation, more preferably a liquid laundry detergent formulation and/or a liquid manual dish wash detergent formulation.

The graft polymers support the removal of various hydrophobic and hydrophilic soils, such as body soils, food and grease soil, particulate soil such clay or carbon black, grass soil, make-up, motor oil etc. from textile or hard surfaces by the surfactants and thus improve the washing and cleaning performances of the formulations.

Moreover, the graft polymers also bring about better dispersion of the removed soil in the washing or cleaning liquor and prevent its redeposition onto the surfaces of the washed or cleaned materials. Herein, the removed soil includes all typical soil that exist in the laundry process, for example, body soil, food and grease soil, particulate soil such clay or carbon black, grass soil, make-up, motor oil etc. Such anti-redeposion effect can be observed on various fabric types, including cotton, polycotton, polyester, copolymer of poly ether/poly urea (Spandex™), etc. In addition, such anti-redeposition effect is also effective on fabrics that have a fabric enhancer history, or when the fabric wash is carried out in the presence of fabric enhancer or other laundry additives such as freshness beads or bleach.

In one embodiment it is also preferred in the present invention that the cleaning composition comprises (besides at least one graft polymer as described above) additionally at least one enzyme, preferably selected from one or more optionally further comprising at least one enzyme, preferably selected from one or more lipases, hydrolases, amylases, proteases, cellulases, hemicellulases, phospholipases, esterases, pectinases, lactases, pectate lyases, cutinases, β-glucanases, DNases, xylanases, oxicoreductases, dispersins, mannanases and peroxidases, and combinations of at least two of the foregoing types, preferably at least one enzyme being selected from lipases.

At least one graft polymer as described herein is present in said inventive cleaning compositions in an amount ranging from about 0.01% to about 20%, preferably from about 0.05% to 15%, more preferably from about 0.1% to about 10%, and most preferably from about 0.5% to about 5%, in relation to the total weight of such composition or product in relation to the total weight of such composition or product; such cleaning composition may—and preferably does—further comprise a from about 1% to about 70% by weight of a surfactant system.

Preferably, such inventive cleaning composition is a fabric and home care product, preferably a laundry detergent or manual dish washing detergent, comprising at least one inventive graft polymer, and optionally further comprising at least one surfactant or a surfactant system, providing improved removal, dispersion and/or emulsification of soils and/or modification of treated surfaces and/or whiteness maintenance of treated surfaces.

Even more preferably, the cleaning compositions of the present invention comprising at least one inventive graft polymer, and optionally further comprising at least one surfactant or a surfactant system—as detailed before—are those for cleaning and anti-redeposition performance within laundry and manual dish wash applications, even more specifically, for improved cleaning and anti-redeposition performance (such actions as detailed before) such as those on fabrics and dishware, and may additionally comprise at least one enzyme selected from the list consisting of optionally further comprising at least one enzyme, preferably selected from one or more optionally further comprising at least one enzyme, preferably selected from one or more lipases, hydrolases, amylases, proteases, cellulases, hemicellulases, phospholipases, esterases, pectinases, lactases, pectate lyases, cutinases, β-glucanases, DNases, xylanases, oxicoreductases, dispersins, mannanases and peroxidases, and combinations of at least two of the foregoing types, preferably selected from one or more lipases, hydrolases, amylases, proteases, cellulases, and combinations of at least two of the foregoing types, more preferably at least one enzyme being selected from lipases.

In one embodiment of the present invention, the inventive graft polymer may be used for improved cleaning and anti-redeposition performance (such action as detailed before) for instance primary washing and/or soil removal of particulate stains and/or oily and fatty stains, and/or additionally for whiteness maintenance, preferably in laundry care. In another preferred embodiment the inventive graft polymer may be used for reducing the greying of fabric (anti-greying), preferably more than one of the before mentioned actions as present, i.e. more than one of improved cleaning, anti-redeposition, primary washing, soil removal of particulate stains and/or oily and fatty stains, whiteness maintenance and/or anti-greying being exhibited by the graft polymers of the invention.

In another embodiment, the inventive graft polymer may be used for improved dye transfer inhibition, i.e. to prevent the transfer of dyes from one piece of fabric to another piece of fabric, either by direct contact or via the washing liquor. For such application it is preferred that the graft polymer contains vinylpyrrolidone as monomer (B2) as herein defined for such cases. Such graft polymers comprising such (B2) are being defined herein with suitable compositions and processes to obtain such graft polymers.

In one preferred embodiment, the cleaning composition of the present invention is a liquid or solid laundry detergent composition.

In another preferred embodiment, the cleaning composition of the present invention is a liquid or solid (e.g. powder or tab/unit dose) detergent composition for manual or automatic dish wash, preferably a liquid manual dish wash detergent composition. Such compositions are known to a person of skill in the art.

In another embodiment, the cleaning composition of the present invention is a hard surface cleaning composition that may be used for cleaning various surfaces such as hard wood, tile, ceramic, plastic, leather, metal, glass.

In another embodiment, the fabric care composition is in the form of a solid additive, a sheet, a pastille or bead, a fibrous article, a solid article, a tablet, a bar, flake, or a mixture thereof used to treat fabrics, optionally in the presence of water.

### Fabric and Home Care Composition:

Any fabric and home care composition are suitable. Composition may or may not include surfactant. Preferred composition are detergents and cleaning compositions. Especially preferred are fabric treatment compositions, even more preferred are laundry detergent compositions.

Fabric and home care compositions are typically suitable for: (a) the care of finished textiles, cleaning of finished textiles, sanitization of finished textiles, disinfection of finished textiles, detergents, stain removers, softeners, fabric enhancers, stain removal or finished textiles treatments, pre and post wash treatments, washing machine cleaning and maintenance, with finished textiles intended to include garments and items made of cloth; (b) the care of dishes, glasses, crockery, cooking pots, pans, utensils, cutlery and the like in automatic, in-machine washing, including detergents, preparatory post treatment and machine cleaning and maintenance products for both the dishwasher, the utilized water and its contents; or (c) manual hand dish washing detergents.

Preferably, the composition may comprise from 0.01 wt % to 20.0 wt %, preferably from 0.02 wt % to 10.0 wt %, preferably from 0.05 wt % to 5 wt %, more preferably from 0.1 wt % to 3.0 wt % of the graft polymer.

The composition may comprise from 1.0 wt % to 70 wt % detersive surfactant.

Fabric and home care compositions include, but not limit to:

Laundry Detergent Composition: Suitable laundry detergent compositions include laundry detergent powder compositions, laundry beads, laundry detergent liquid compositions, laundry detergent gel compositions, laundry sheets, fibrous articles and water-soluble unit dose laundry detergent compositions.

Fabric Enhancers: Suitable fabric enhancers are liquid fabric enhancers including compact liquid fabric enhancers, and solid fabric enhancers including fabric enhancer beads and sheets.

Dish-washing Detergent Composition: Suitable dish-washing detergent compositions include hand dish-washing detergent compositions and automatic dish-washing detergent compositions. Such as automatic dish-washing powder, tablet and pouches.

Hard Surface Cleaner Compositions: Suitable hard surface cleaner compositions include product that can be directly applied onto hard surface, eg. by a spray, and products that can be diluted in water before been applied onto hard surface.

### Fabric and Home Care Ingredients

Suitable fabric and home care ingredients are described in more detail below.

### Surfactant System:

The compositions comprise a surfactant system in an amount sufficient to provide desired cleaning properties. In some embodiments, the composition comprises, by weight of the composition, from about 1% to about 70% of a surfactant system. In other embodiments, the composition comprises, by weight of the composition, from about 2% to about 60% of the surfactant system. In further embodiments, the composition comprises, by weight of the composition, from about 5% to about 30% of the surfactant system. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material.

Suitable surfactants include anionic surfactants, non-ionic surfactant, cationic surfactants, zwitterionic surfactants and amphoteric surfactants and mixtures thereof. Suitable surfactants may be linear or branched, substituted or un-substituted, and may be derived from petrochemical material or biomaterial. Preferred surfactant systems comprise both anionic and nonionic surfactant, preferably in weight ratios from 90:1 to 1:90. In some instances a weight ratio of anionic to nonionic surfactant of at least 1:1 is preferred. However, a ratio below 10:1 may be preferred. When present, the total surfactant level is preferably from 0.1% to 60%, from 1% to 50% or even from 5% to 40% by weight of the subject composition.

Anionic Surfactant: Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C₈-C₂₂ alkyl, or acyl group. Such surfactants are employed in the form of water-soluble salts and the salt-forming cation usually is selected from sodium, potassium, ammonium, magnesium and mono-, with the sodium cation being the usual one chosen.

Anionic surfactants of the present invention and adjunct anionic cosurfactants, may exist in an acid form, and said acid form may be neutralized to form a surfactant salt which is desirable for use in the present detergent compositions. Typical agents for neutralization include the metal counterion base such as hydroxides, e.g., NaOH or KOH. Further preferred agents for neutralizing anionic surfactants of the present invention and adjunct anionic surfactants or cosurfactants in their acid forms include ammonia, amines, oligamines, or alkanolamines. Alkanolamines are preferred. Suitable non-limiting examples including monoethanolamine, diethanolamine, triethanolamine, and other linear or branched alkanolamines known in the art; for example, highly preferred alkanolamines include 2-amino-1-propanol, 1-aminopropanol, monoisopropanolamine, or 1-amino-3-propanol. Amine neutralization may be done to a full or partial extent, e.g. part of the anionic surfactant mix may be neutralized with sodium or potassium and part of the anionic surfactant mix may be neutralized with amines or alkanolamines.

Suitable sulphonate surfactants include methyl ester sulphonates, alpha olefin sulphonates, alkyl benzene sulphonates, especially alkyl benzene sulphonates, preferably C₁₀-C₃ alkyl benzene sulphonate. Suitable alkyl benzene sulphonate (LAS) is obtainable, preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, although other synthesis routes, such as HF, may also be suitable. In one aspect a magnesium salt of LAS is used.

Preferably, the composition may contain from about 0.5% to about 30%, by weight of the laundry composition, of an HLAS surfactant selected from alkyl benzene sulfonic acids, alkali metal or amine salts of C₁₀-C₁₆ alkyl benzene sulfonic acids, wherein the HLAS surfactant comprises greater than 50% C₁₂, preferably greater than 60%, preferably greater than 70% C₁₂, more preferably greater than 75% Suitable sulphate surfactants include alkyl sulphate, preferably C₈₋₁₈ alkyl sulphate, or predominantly C₁2 alkyl sulphate.

A preferred sulphate surfactant is alkyl alkoxylated sulphate, preferably alkyl ethoxylated sulphate, preferably a C₅-C₁₈ alkyl alkoxylated sulphate, preferably a C₅-C₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₅-C₁₈ alkyl ethoxylated sulphate having an average degree of ethoxylation of from 0.5 to 10, preferably from 0.5 to 5, more preferably from 0.5 to 3 or from about 1.5 to 3 or from about 1.8 to 2.5. The alkyl alkoxylated sulfate may have a broad alkoxy distribution or a peaked alkoxy distribution. The alkyl portion of the AES may include, on average, from 13.7 to about 16 or from 13.9 to 14.6 carbons atoms. At least about 50% or at least about 60% of the AES molecule may include having an alkyl portion having 14 or more carbon atoms, preferable from 14 to 18, or from 14 to 17, or from 14 to 16, or from 14 to 15 carbon atoms.

The alkyl sulphate, alkyl alkoxylated sulphate and alkyl benzene sulphonates may be linear or branched, including 2 alkyl substituted or mid chain branched type, substituted or un-substituted, and may be derived from petrochemical material or biomaterial. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. Most preferably the branched sulfated anionic surfactant is selected from alkyl sulfates, alkyl ethoxy sulfates, and mixtures thereof.

Alkyl sulfates and alkyl alkoxy sulfates are commercially available with a variety of chain lengths, ethoxylation and branching degrees. Commercially available sulfates include those based on Neodol alcohols ex the Shell company, Lial-Isalchem and Safol ex the Sasol company, natural alcohols ex The Procter & Gamble Chemicals company.

Other suitable anionic surfactants include alkyl ether carboxylates, comprising a C₁₀-C₂₆ linear or branched, preferably C₁₀-C₂₀ linear, most preferably C₁₆-C₁₅ linear alkyl alcohol and from 2 to 20, preferably 7 to 13, more preferably 8 to 12, most preferably 9.5 to 10.5 ethoxylates. The acid form or salt form, such as sodium or ammonium salt, may be used, and the alkyl chain may contain one cis or trans double bond. Alkyl ether carboxylic acids are available from Kao (Akypo®), Huntsman (Empicol®) and Clariant (Emulsogen®).

Other suitable anionic surfactants are rhamnolipids. The rhamnolipids may have a single rhamnose sugar ring or two rhamnose sugar rings.

Non-ionic Surfactant: Suitable non-ionic surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic surfactants are alkylpolyglucoside and/or an alkyl alkoxylated alcohol.

Suitable non-ionic surfactants include alkyl alkoxylated alcohols, preferably C₈-C₁₈ alkyl alkoxylated alcohol, preferably a C₈-C₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈-C₁₈ alkyl ethoxylated alcohol having an average degree of ethoxylation of from 1 to 10, preferably from 1 to 7, more preferably from 1 to 5 and most preferably from 3 to 7. In one aspect, the alkyl alkoxylated alcohol is a C₁₂-C₁₈ alkyl ethoxylated alcohol having an average degree of ethoxylation of from 7 to 10. The alkyl alkoxylated alcohol can be linear or branched, and substituted or un-substituted. Suitable nonionic surfactants include those with the trade name Lutensol® from BASF. The alkyl alkoxylated sulfate may have a broad alkoxy distribution for example Alfonic 1214-9 Ethoxylate or a peaked alkoxy distribution for example Novel 1214-9 both commercially available from Sasol

Cationic Surfactant: Suitable cationic surfactants include alkyl pyridinium compounds, alkyl quaternary ammonium compounds, alkyl quaternary phosphonium compounds, alkyl ternary sulphonium compounds, and mixtures thereof.

Preferred cationic surfactants are quaternary ammonium compounds having the general formula:

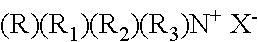

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

The fabric care compositions of the present invention may contain up to about 30%, alternatively from about 0.01% to about 20%, more alternatively from about 0.1% to about 20%, by weight of the composition, of a cationic surfactant. For the purposes of the present invention, cationic surfactants include those which can deliver fabric care benefits. Non-limiting examples of useful cationic surfactants include: fatty amines, imidazoline quat materials and quaternary ammonium surfactants, preferably N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl)N-(2 hydroxyethyl)N-methyl ammonium methylsulfate; N,N-bis(stearoyl-isopropoxy)N,N-dimethyl ammonium methyl sulfate, N,N-bis(tallowoyl-isopropoxy)N,N-dimethyl ammonium methyl sulfate, 1, 2 di (stearoyl-oxy) 3 trimethyl ammoniumpropane chloride; dialkylenedimethylammonium salts such as dicanoladimethylammonium chloride, di(hard)tallowdimethylammonium chloride dicanoladimethylammonium methylsulfate; 1-methyl-1-stearoylamidoethyl-2-stearoylimidazolinium methylsulfate; 1-tallowylamidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above.

It will be understood that combinations of softener actives disclosed above are suitable for use herein Amphoteric and Zwitterionic surfactant: Suitable amphoteric or zwitterionic surfactants include amine oxides, and/or betaines. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R¹ C₈-C₁₈ alkyl moiety and 2 R² and R³ moieties selected from the group consisting of C₁-C₃ alkyl groups and C₁-C₃ hydroxyalkyl groups. Preferably amine oxide is characterized by the formula R¹—N(R²)(R³)O wherein R¹ is a C₈-C₁₈ alkyl and R² and R³ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides.

Other suitable surfactants include betaines, such as alkyl betaines, alkylamidobetaine, amidazoliniumbetaine, sulfobetaine (INCI Sultaines) as well as Phosphobetaines.

### Other Fabric and Home Care Ingredients.

The compositions of the invention may also contain other fabric and home care additives. Suitable fabric and home care additives include enzymes, enzyme stabilizers, builders, dispersants, structurants or thickeners, polymers, additional amines, catalytic materials, bleaching agents, bleaching catalysts, bleach activators, polymeric dispersing agents, soil removal/anti-re-deposition agents, polymeric grease cleaning agents, amphiphilic copolymers, fluorescent brightener, fabric hueing agents, chelating agent, encapsulates, perfume, pro-perfumes, malodor reduction materials, conditioning agents, probiotics, organic acids, anti-oxidants, anti-microbial agents and/or preservatives, neutralizers and/or pH adjusting agents, processing aids, rheology modifiers, corrosion and/or anti-tarnishing agents, hygiene Agent, pearlescent agent, pigments, opacifier, solvents, carriers, hydrotrope, suds suppressor and mixtures thereof.

### Enzymes:

Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, 8-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in the composition, the aforementioned additional enzymes may be present at levels from about 0.00001% to about 2%, from about 0.0001% to about 1% or even from about 0.001% to about 0.5% enzyme protein by weight of the composition.

Proteases. Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), especially those derived from Bacillus, such as Bacillus sp., Bacillus sp., B. lentus, B. alkalophilus, B. subtilis, B. amyloliquefaciens, B. gibsonii, B. akibaii, B. clausii and B. clarkii described in WO2004067737, WO2015091989, WO2015091990, WO2015024739, WO2015143360, U.S. Pat. Nos. 6,312,936B1, 5,679,630, 4,760,025, DE102006022216A1, DE102006022224A1, WO2015089447, WO2015089441, WO2016066756, WO2016066757, WO2016069557, WO2016069563, WO2016069569, WO2017/089093, WO2020/156419.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.
(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Liquanase® Evity®, Savinase® Evity®, Ovozyme®, Neutrase®, Everlase®, Coronase®, Blaze®, Blaze Ultra®, Blaze® Evity®, Blaze® Exceed, Blaze® Pro, Esperase®, Progress® Uno, Progress® Excel, Progress® Key, Ronozyme®, Vinzon® and Het Ultra® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604 with the following mutations S99D+S101 R+S103A+V1041+G159S, hereinafter referred to as BLAP), BLAP R (BLAP with S3T+V4I+V199M+V205I+L217D), BLAP X (BLAP with S3T+V4I+V205I) and BLAP F49 (BLAP with S3 T+V4I+A194P+V199M+V205I+L217D); and KAP (Bacillus alkalophilus subtilisin with mutations A230V+S256G+S259N) from Kao and Lavergy®, Lavergy® Pro, Lavergy® C Bright from BASF.

Amylases. Preferably the composition may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus lichenformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.
(b) variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643: 26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.
(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.
(d) variants exhibiting at least 95% identity with the wild-type enzyme from Bacillus sp. 707 (SEQ ID NO:7 in U.S. Pat. No. 6,093,562), especially those comprising one or more of the following mutations M202, M208, S255, R172, and/or M261. Preferably said amylase comprises one or more of M202L, M202V, M202S, M202T, M202I, M202Q, M202W, S255N and/or R172Q. Particularly preferred are those comprising the M202L or M202T mutations.
(e) variants described in WO 09/149130, preferably those exhibiting at least 90% identity with SEQ ID NO: 1 or SEQ ID NO:2 in WO 09/149130, the wild-type enzyme from Geobacillus stearothermophilus or a truncated version thereof.
(f) variants exhibiting at least 89% identity with SEQ ID NO:1 in WO2016091688, especially those comprising deletions at positions H183+G184 and additionally one or more mutations at positions 405, 421, 422 and/or 428.
(g) variants exhibiting at least 60% amino acid sequence identity with the “PcuAmyl α-amylase” from Paenibacillus curdlanolyticus YK9 (SEQ ID NO:3 in WO2014099523).
(h) variants exhibiting at least 60% amino acid sequence identity with the “CspAmy2 amylase” from Cytophaga sp. (SEQ ID NO:1 in WO2014164777).
(i) variants exhibiting at least 85% identity with AmyE from Bacillus subtilis (SEQ ID NO:1 in WO2009149271).
(j) Variants exhibiting at least 90% identity variant with the wild-type amylase from Bacillus sp. KSM-K38 with accession number AB051102.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE® and PURASTAR OXAM® (Genencor International Inc., Palo Alto, California) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

Lipases. Preferably the composition comprises one or more lipases, including “first cycle lipases” such as those described in U.S. Pat. No. 6,939,702 B1 and US PA 2009/0217464. Preferred lipases are first-wash lipases. In one embodiment of the invention the composition comprises a first wash lipase.

First wash lipases includes a lipase which is a polypeptide having an amino acid sequence which: (a) has at least 90% identity with the wild-type lipase derived from Humicola lanuginosa strain DSM 4109; (b) compared to said wild-type lipase, comprises a substitution of an electrically neutral or negatively charged amino acid at the surface of the three-dimensional structure within 15A of E1 or Q249 with a positively charged amino acid; and (c) comprises a peptide addition at the C-terminal; and/or (d) comprises a peptide addition at the N-terminal and/or (e) meets the following limitations: i) comprises a negative amino acid in position E210 of said wild-type lipase; ii) comprises a negatively charged amino acid in the region corresponding to positions 90-101 of said wild-type lipase; and iii) comprises a neutral or negative amino acid at a position corresponding to N94 or said wild-type lipase and/or has a negative or neutral net electric charge in the region corresponding to positions 90-101 of said wild-type lipase.

Preferred are variants of the wild-type lipase from Thermomyces lanuginosus comprising one or more of the T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Other suitable lipases include: Liprl 139, e.g. as described in WO2013/171241; TfuLip2, e.g. as described in WO2011/084412 and WO2013/033318; Pseudomonas stutzeri lipase, e.g. as described in WO2018228880; Microbulbifer thermotolerans lipase, e.g. as described in WO2018228881; Sulfobacillus acidocaldarius lipase, e.g. as described in EP3299457; LIP062 lipase e.g. as described in WO2018209026; PinLip lipase e.g. as described in WO2017036901 and Absidia sp. lipase e.g. as described in WO2017005798.

Preferred lipases would include those sold under the tradenames Lipex® and Lipolex® and Lipoclean®.

Cellulases. Suitable enzymes include cellulases of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and 5,691,178. Suitable cellulases include the alkaline or neutral cellulases having colour care benefits. Commercially available cellulases include CELLUZYME®, CAREZYME® and CAREZYME PREMIUM (Novozymes A/S), CLAZINASE®, and PURADAX HA® (Genencor International Inc.), and KAC-500(B)® (Kao Corporation).

The bacterial cleaning cellulase may be a glycosyl hydrolase having enzymatic activity towards amorphous cellulose substrates, wherein the glycosyl hydrolase is selected from GH families 5, 7, 12, 16, 44 or 74. Suitable glycosyl hydrolases may also be selected from the group consisting of: GH family 44 glycosyl hydrolases from Paenibacillus polyxyma (wild-type) such as XYG1006 described in U.S. Pat. No. 7,361,736 or are variants thereof. GH family 12 glycosyl hydrolases from Bacillus lichenformis (wild-type) such as SEQ ID NO:1 described in U.S. Pat. No. 6,268,197 or are variants thereof, GH family 5 glycosyl hydrolases from Bacillus agaradhaerens (wild type) or variants thereof, GH family 5 glycosyl hydrolases from Paenibacillus (wild type) such as XYG1034 and XYG 1022 described in U.S. Pat. No. 6,630,340 or variants thereof, GH family 74 glycosyl hydrolases from Jonesia sp. (wild type) such as XYG1020 described in WO 2002/077242 or variants thereof, and GH family 74 glycosyl hydrolases from Trichoderma Reesei (wild type), such as the enzyme described in more detail in Sequence ID NO. 2 of U.S. Pat. No. 7,172,891, or variants thereof. Suitable bacterial cleaning cellulases are sold under the tradenames Celluclean® and Whitezyme® (Novozymes A/S, Bagsvaerd, Denmark).

The composition may comprise a fungal cleaning cellulase belonging to glycosyl hydrolase family 45 having a molecular weight of from 17 kDa to 30 kDa, for example the endoglucanases sold under the tradename Biotouch® NCD, DCC and DCL (AB Enzymes, Darmstadt, Germany).

Pectate Lyases. Other preferred enzymes include pectate lyases sold under the tradenames Pectawash®, Pectaway®, Xpect® and mannanases sold under the tradenames Mannaway® (all from Novozymes A/S, Bagsvaerd, Denmark), and Purabrite® (Genencor International Inc., Palo Alto, California).

Nucleases. The composition may comprise a nuclease enzyme. The nuclease enzyme is an enzyme capable of cleaving the phosphodiester bonds between the nucleotide sub-units of nucleic acids. The nuclease enzyme herein is preferably a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus, it includes truncated, but functional versions, of the enzyme and/or variants and/or derivatives and/or homologues whose functionality is maintained. Suitable DNases include wild-types and variants described in detail by WO2017162836 and WO2018108865, and variants of the Bacillus cibi DNase including those described in WO2018011277.

RNase: suitable RNases include wild-types and variants of DNases described in WO2018178061 and WO2020074499.

Preferably the nuclease enzyme is a deoxyribonuclease, preferably selected from any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof.

Hexosaminidases. The composition may comprise one or more hexosaminidases. The term hexosaminidase includes “dispersin” and the abbreviation “Dsp”, which means a polypeptide having hexosaminidase activity, EC 3.2.1.- that catalyzes the hydrolysis of β-1,6-glycosidic linkages of N-acetyl-glucosamine polymers found in soils of microbial origin. The term hexosaminidase includes polypeptides having N-acetylglucosaminidase activity and 3-N-acetylglucosaminidase activity. Hexosaminidase activity may be determined according to Assay II described in WO2018184873. Suitable hexosaminidases include those disclosed in WO2017186936, WO2017186937, WO2017186943, WO2017207770, WO2018184873, WO2019086520, WO2019086528, WO2019086530, WO2019086532, WO2019086521, WO2019086526, WO2020002604, WO2020002608, WO2020007863, WO2020007875, WO2020008024, WO2020070063, WO2020070249, WO2020088957, WO2020088958 and WO2020207944. Variants of the Terribacillus saccharophilus hexosaminidase defined by SEQ ID NO: 1 of WO2020207944 may be preferred, especially the variants with improved thermostability disclosed in that publication.

Mannanases. The composition may comprise an extracellular-polymer-degrading enzyme that includes a mannanase enzyme. The term “mannanase” means a polypeptide having mannan endo-1,4-beta-mannosidase activity (EC 3.2.1.78) from the glycoside hydrolase family 26 that catalyzes the hydrolysis of 1,4-3-D-mannosidic linkages in mannans, galactomannans and glucomannans. Alternative names of mannan endo-1,4-beta-mannosidase are 1,4-3-D-mannan mannanohydrolase; endo-1,4-3-mannanase; endo-β-1,4-mannase; β-mannanase B; 3-1,4-mannan 4-mannanohydrolase; endo-3-mannanase; and β-D-mannanase. For purposes of the present disclosure, mannanase activity may be determined using the Reducing End Assay as described in the experimental section of WO2015040159. Suitable examples from class EC 3.2.1.78 are described in WO2015040159, such as the mature polypeptide SEQ ID NO: 1 described therein.

Galactanases. The composition may comprise an extracellular polymer-degrading enzyme that includes an endo-beta-1,6-galactanase enzyme. The term “endo-beta-1,6-galactanase” or “a polypeptide having endo-beta-1,6-galactanase activity” means a endo-beta-1,6-galactanase activity (EC 3.2.1.164) from the glycoside hydrolase family 30 that catalyzes the hydrolytic cleavage of 1,6-3-D-galactooligosaccharides with a degree of polymerization (DP) higher than 3, and their acidic derivatives with 4-O-methylglucosyluronate or glucosyluronate groups at the non-reducing terminals. For purposes of the present disclosure, endo-beta-1,6-galactanase activity is determined according to the procedure described in WO 2015185689 in Assay I. Suitable examples from class EC 3.2.1.164 are described in WO 2015185689, such as the mature polypeptide SEQ ID NO: 2.

### Enzyme Stabilizing System.

The composition may optionally comprise from about 0.001% to about 10%, in some examples from about 0.005% to about 8%, and in other examples, from about 0.01% to about 6%, by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

### Builders:

The composition may optionally comprise a builder. Built compositions typically comprise at least about 1% builder, based on the total weight of the composition. Liquid compositions may comprise up to about 10% builder, and in some examples up to about 8% builder, of the total weight of the composition. Granular compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof, carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing compositions. Additional suitable builders may be selected from citric acid, lactic acid, fatty acid and salt thereof.

Suitable builders may include polycarboxylate and salt thereof, for example, homopolymers of acrylic acid, copolymers of acrylic acid and maleic acid, and copolymers of acrylic acid and/or maleic acid, and other suitable ethylenic monomers with various types of additional functionalities. More suitable polycarboxylate are described in polycarboxylate polymers section of this patent.

Also suitable for use as builders herein are synthesized crystalline ion exchange materials or hydrates thereof having chain structure and a composition represented by the following general anhydride form: x(M₂O)·ySiO₂·zM′O wherein M is Na and/or K, M′ is Ca and/or Mg; y/x is 0.5 to 2.0; and z/x is 0.005 to 1.0.

Alternatively, the composition may be substantially free of builder.

Structurant/Thickeners: Suitable structurant/thickeners include:
Di-benzylidene Polyol Acetal Derivative
Bacterial Cellulose
Coated Bacterial Cellulose
Cellulose fibers non-bacterial cellulose derived
Non-Polymeric Crystalline Hydroxyl-Functional Materials
Polymeric Structuring Agents
Di-amido-gellants
Any combination of above.

### Polymers:

The compositions may include one or more polymers. Typically, the level of polymers is from about 0.01% to about 10.0% by weight of the composition, preferably from about 0.1% to about 5%, and more preferably from about 0.2% to about 3.0% by weight of the composition. In some situations where the composition is in concentrated form, such as concentrated fabric and home care products in any forms which designed for consumer to dilute at home and then use following their regular dosing habits, the level of the polymers maybe higher than 10.0%, or higher than 5.0%, by weight of the composition.

Depending on the structure of the polymer, polymers can provide various benefits for the composition, including but not limit to, hydrophobic and hydrophilic stain removal, surfactant boosting, soil suspension, whiteness maintenance, soil release, malodor control, dye transfer inhibition, enhanced softness, enhanced freshness, etc. Polymers are normally multi-functional, which means one specific given type of polymer may provide more than one types of benefit as mentioned above. For example, a specific soil release polymer may provide soil release benefit as primary benefit, while also providing other benefits such as whiteness maintenance, malodor control, soil suspension, dye transfer inhibition.

Suitable polymers including, but not limited to the following:

### Graft Polymers Based on Polyalkylene Oxide.

The composition may comprise graft polymers which comprising polyalkylene oxide backbone (A) as a graft base and polymeric sidechains (B) grafted thereon. The polymeric sidechains (B) are obtainable by polymerization of at least one vinyl ester monomer. The polyalkylene oxide backbone (A) is obtainable by polymerization of at least one monomers selected from the group of ethylene oxide, 1,2-propylene oxide, 1,2-butylene oxide, 2,3-butylene oxide, 1,2-pentene oxide or 2,3-pentene oxide. Such graft polymers are known as effective soil suspension polymers for hydrophobic and hydrophilic stains, surfactant boosters, and sometimes as dye transfer inhibitors.

Suitable graft polymers include amphilic graft co-polymer comprises polyethylene glycol backbone (A) as a graft base, and at least one pendant sidechains (B) selected from polyvinyl acetate, polyvinyl alcohol and mixtures thereof. A preferred graft polymer of this type is Sokalan HP22 available from BASF.

Suitable graft polymers are also described in WO2007/138053 as amphiphilic graft polymers based on water-soluble polyalkylene oxides (A) as a graft base and side chains formed by polymerization of a vinyl ester component (B), said polymers having an average of <one graft site per 50 alkylene oxide units and mean molar masses M of from 3 000 to 100 000. One specific preferred graft polymer of this type is polyvinyl acetate grafted polyethylene oxide copolymer having a polyethylene oxide as graft base and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. The most preferred polymer of this type is available from BASF as Sokalan PG101.

Suitable graft polymer also include graft polymer comprising a block copolymer backbone (A) as a graft base, wherein said block copolymer backbone (A) is obtainable by polymerization of at least two monomers selected from the group of ethylene oxide, 1,2-propylene oxide, 1,2-butylene oxide, 2,3-butylene oxide, 1,2-pentene oxide or 2,3-pentene oxide, wherein the number (x) of individual blocks within the block copolymer backbone (A) is an integer, wherein x is from 2 to 10 and preferably 3 to 5, and (B) polymeric sidechains grafted onto the block copolymer backbone, wherein said polymeric sidechains (B) are obtainable by polymerization of at least one vinyl ester monomer. Suitable graft polymers of this type are described in WO2021/160795 and WO2021/160851, these polymers have improved biodegradation profiles.

Suitable graft polymer also include graft polymer comprising a polyalkylene oxide backbone (A) which has a number average molecular weight of from about 1000 to about 20,000 Daltons and is based on ethylene oxide, propylene oxide, or butylene oxide; and side chains derived from N-vinylpyrrolidone (B), and side chains derived from vinyl ester (C) derived from a saturated monocarboxylic acid containing from 1 to 6 carbon atoms and/or a methyl or ethyl ester of acrylic or methacrylic acid. Such graft polymers are described in WO2020005476 and can be used as dye transfer inhibitors.

### Modified Polyamine Dispersing Agent.

The composition may comprise one or more modified polyamine dispersing agent. The modified polyamine dispersant comprises a polyamine core structure and a plurality of alkoxylate groups attached to the core structure. The polyamine core structure includes polyalkyleneimine, and linear or branched oligoamine.

The polyamine core structure and the alkoxylate groups attached to the core structure can be further derivatized. For example, the polyamine core structure can be further partly or completely quaternized with C₁-C₃₀ linear or branched alkyl, more preferably C₁-C₁₀ or even C₁-C₅ linear or branched alkyl, most preferably methyl. The alkoxylate group can be further sulphated, sulphonated and/or substituted with an amino functional group.

Suitable modified polyamine dispersing agent includes ethoxylated polyethyleneimine (EPEI). EPEI are effective dispersing agent for hydrophilic stains, especially hydrophilic particulate stain such as clay.

In one embodiment, the EPEI has a polyethyleneimine backbone of weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol, preferably about 600.

The ethoxylation chains within the EPEI may be from 200 g/mol to 2000 g/mol weight average molecular weight, preferably from 400 g/mol to 1500 g/mol weight average molecular weight, more preferably from 600 g/mol to 1000 g/mol weight average molecular weight, most preferably about 880 g/mol weight average molecular weight per ethoxylated chain. The ethoxylation chains within the EPEI have on average 5 to 40, preferably 10 to 30, more preferably 15 to 25, even more preferably 18 to 22, most preferably about 20 ethoxy units per ethoxylation chain. The EPEI may have a total weight average molecular weight of from 5000 g/mol to 20000 g/mol, preferably from 7500 g/mol to 17500 g/mol, more preferably from 10000 g/mol to 15000 g/mol, even more preferably from 12000 g/mol to 13000 g/mol, most preferably about 12700 g/mol. A preferred example is polyethyleneimine core (with average molecular weight about 600 g/mol) ethoxylated to 20 EO groups per NH. Suitable EPEI this type includes Sokalan HP20 available from BASF, Lutensol FP620 from BASF. Examples of available polyethyleneimine ethoxylates also include those prepared by reacting ethylene oxide with Epomine SP-006 manufactured by Nippon Shokubai.

In another embodiment, the EPEI comprises polyethyleneimine has an average molecular weight (Mw) ranging from 1800 to 5000 g/mol (prior to ethoxylation), and the polyoxyethylene side chains have an average of from 25 to 40 ethoxy units per side chain bonded to the polyethyleneimine backbone. Such EPEI is described in WO2020/030760 and WO2020/030469.

Suitable modified polyamine dispersing agent includes amphiphilic alkoxylated polyalkyleneimine polymer. These polymers have balanced hydrophilic and hydrophobic properties such that they remove grease and body soil particles from fabrics and surfaces, and keep the particles suspended in washing liquor. Suitable amphiphilic water-soluble alkoxylated polyalkyleneimine polymer is described in WO2009/061990 and WO2006/108857, which comprising in polyalkyleneimine, preferable polyethyleneimine core, and alkoxylate group of below connected to the core

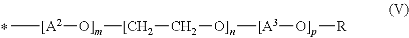

wherein
“*” in each case denotes one-half of bond to the nitrogen atom of the core.
A² is in each case independently selected from 1,2-propylene, 1,2-butylene, and 1,2-isobutylene;
A³ is 1,2-propylene;
R is in each case independently selected from hydrogen and C₁-C₄-alkyl, preferably hydrogen;
m has an average value in the range of from 0 to 2, preferably 0;
n has an average value in the range of 5 to 50; and
p has an average value in the range of 3-50;
The polymer comprising a degree of quaternization ranging from 0 to 50, preferably from 0 to 20, and more preferably from 0 to 10.

A preferred alkoxylated polyalkyleneimine polymer is polyethyleneimine (MW=600) modified with 24 ethoxylate groups per —NH and 16 propoxylate groups per —NH. Another preferred alkoxylated polyalkyleneimine polymer is polyethyleneimine (MW=600) modified with 10 ethoxylate groups per —NH and 7 propoxylate groups per —NH.

Another suitable alkoxylated polyalkyleneimine polymer of this type includes Sokalan HP20 Booster available from BASF.

Another suitable modified polyamine dispersing agent is described in WO2021061774.

Suitable modified polyamine dispersing agent also includes zwitterionic polyamines. Said zwitterionic polyamine is selected from zwitterionic polyamines according to the following formula:

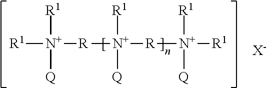

R is each independently C₃-C₂₀ linear or branched alkylene;
R¹ is an anionic unit-capped polyalkyleneoxy unit having the formula: —(R²O)ₓR³, wherein
   R² is C₂-C₄ linear or branched alkylene, preferably C₂ (ethylene);
   R³ is hydrogen, an anionic unit, and mixtures thereof, in which not all R³ groups are hydrogen, preferably wherein R³ anionic units are selected from —(CH₂)ₚCO₂M; —(CH₂)_{q}SO₃M; —(CH₂)_{q}OSO₃M; —(CH₂)_{q}CH(SO₃M)-CH₂SO₃M; —(CH₂)_{q}CH(OSO₃M)CH₂OSO3M; —(CH₂)_{q}CH(SO₃M)CH₂SO₃M; —(CH₂)ₚPO₃M; —PO₃M; —SO₃M and mixtures thereof, wherein M is hydrogen or a water soluble cation, preferably selected from sodium, potassium, ammonium, and mixtures thereof and in sufficient amount to satisfy charge balance;
   x is from 5 to 50, preferably from 10 to 40, even more preferably from 15 to 30, most preferably from 20 to 25;
Q is a quaternizing unit selected from the group consisting of C₁-C₃₀ linear or branched alkyl, C₆-C₃₀ cycloalkyl, C₇-C₃₀ substituted or unsubstituted alkylenearyl, and mixtures thereof, preferably C₁-C₃₀ linear or branched alkyl, even more preferably C₁-C₁₀ or even C₁-C₅ linear or branched alkyl, most preferably methyl; the degree of quaternization preferably is more than 50%, more preferably more than 70%, even more preferably more than 90%, most preferably about 100;
X⁻ is an anion present in sufficient amount to provide electronic neutrality, preferably a water-soluble anion selected from the group consisting of chlorine, bromine, iodine, methylsulfate, and mixtures thereof, more preferably chloride;
n is from 0 to 8, preferably 0 to 4, preferably 0 to 2, most preferably 0.

A suitable zwitterionic polyamine having the following general structure: bis((C₂H₅O)(C₂H₄O)n)(CH₃)—N⁺—CₓH₂ₓ—N+—(CH₃)-bis((C₂H₅O)(C₂H₄O)n), wherein n=from 20 to 30, and x=from 3 to 8, or sulphated or sulphonated variants thereof.

A particular preferred zwitterionic polyamine is available from BASF as Lutensit Z96 polymer (zwitterionic hexamethylene diamine according to below formula: 100% quaternized and about 40% of the polyethoxy (EO₂₄) groups are sulfonated).

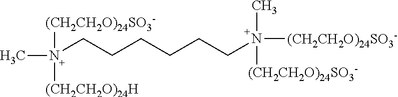

Another preferred zwitterionic polyamine is Sokalan HP96, available from BASF.

Another suitable zwitterionic polyamine is amphoterically-modified oligopropyleneimine ethoxylates as described in WO2021239547.

### Polyester Soil Release Polymers.

The composition may comprise one or more soil release polymer (SRP).

Polyester SRP typically have hydrophilic segments to hydrophilize the surface of hydrophobic fibers (such as polyester and nylon), and hydrophobic segments to deposit on hydrophobic fibers and remain adhered thereto through completion of washing and rinsing cycles, thereby serving as an anchor for the hydrophilic segments. This may enable stains occurring subsequent to treatment with a soil release agent to be more easily cleaned in later washing procedures. It is also believed that facilitating the release of soils helps to improve or maintain the wicking properties of a fabric.

The structure of polyester SRP may be tailored to be suitable to use in different detergent or detergent additive products. Soil release polymers may be linear, branched, or star-shaped. Soil release polymers may also include a variety of charged units. Typically, a nonionic SRP or anionic SRP may be particularly preferred when the SRP is used in combination with a detergent which containing anionic surfactants, in order to avoid potentially negative interactions between the SRP and anionic surfactants. Soil release polymer may include an end capping moiety, which is especially effective in controlling the molecular weight of the polymer or altering the physical or surface-adsorption properties of the polymer.

Preferred polyester SRP soil release polymers include terephthalate-derived polyester polymers, which comprise structure unit (I) and/or (II):

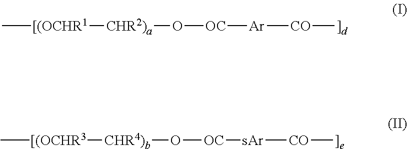

wherein:
a, b are from 1 to 200;
d, e are from 1 to 50;
Ar is independently selected from 1,4-substituted phenylene, and 1,3-substituted phenylene
sAr is 1,3-substituted phenylene substituted in position 5 with —SO₃M; wherein M is a counterion selected from Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴ are independently selected from H or C₁-C₁₈ n-alkyl or iso-alkyl; preferably selected from H or C₁ alkyl.

Optionally, the polymer further comprises one or more terminal group (III) derived from polyalkylene glycolmonoalkylethers, preferably selected from structure (III-a)

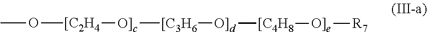

wherein:
R₇ is a linear or branched C₁₋₃₀ alkyl, C₂-C₃₀ alkenyl, or a cycloalkyl group with 5 to 9 carbon atoms, or a C₈-C₃₀ aryl group, or a C₆-C₃₀ arylalkyl group; preferably C₁₋₄ alkyl, more preferably methyl; and
c, d and e are, based on molar average, a number independently selected from 0 to 200, where the sum of c+d+e is from 2 to 500,
wherein the [C₂H₄—O], [C₃H₆—O] and [C₄H₈—O] groups of the terminal group (IV-a) may be arranged blockwise, alternating, periodically and/or statistically, preferably blockwise and/or statistically, either of the [C₂H₄—O], [C₃H₆—O] and [C₄H₈—O] groups of the terminal group (IV-a) can be linked to —R₇ and/or —O. Preferably, [C₃H₆—O] group is linked to —O, and the —O is further connected to —OC—Ar—CO— or —OC-sAr—CO—.

Optionally, the polymer further comprises one or more anionic terminal unit (IV) and/or (V) as described in EP3222647. Where M is a counterion selected from Na⁺, Li⁺, K⁺, ½Mg²⁺, ½Ca²⁺, ⅓Al³⁺, ammonium, mono-, di-, tri-, or tetraalkylammonium wherein the alkyl groups are C₁-C₁₈ alkyl or C₂-C₁₀ hydroxyalkyl, or mixtures thereof.

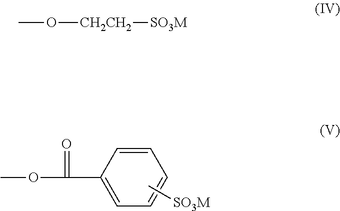

Optionally, the polymer may comprise crosslinking multifunctional structural unit which having at least three functional groups capable of the esterification reaction. The functional which may be for example acid-, alcohol-, ester-, anhydride- or epoxy groups, etc.

Optionally, other di- or polycarboxylic acids or their salts or their (di)alkylesters can be used in the polyesters, such as, naphthalene-1,4-dicarboxylic acid, naphthalene-2,6,-dicarboxylic acid, tetrahydrophthalic acid, trimellitic acid, diphenoxyethane-4,4′-dicarboxylic acid, diphenyl-4,4′-dicarboxylic acid, 2,5-furandicarboxylic acid, adipic acid, sebacic acid, decan-1,10-dicarboxylic acid, fumaric acid, succinic acid, 1,4-cyclohexanedicarboxylic acid, cyclohexanediacetic acid, glutaric acid, azelaic acid, or their salts or their (di)alkyl esters, preferably their (C₁-C₄)-(di)alkyl esters and more preferably their (di)methyl esters, or mixtures thereof.

One type of preferred polyester SRPs are nonionic polyester SRP, which does not comprise above structure unit (II). A particular preferred nonionic terephthalate-derived soil release polymer has a structure according to formula below:

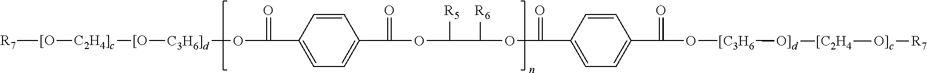

wherein:
R₅ and R₆ is independently selected from H or CH₃. More preferably, one of the R₅ and R₆ is H, and another is CH₃.
c, d are, based on molar average, a number independently selected from 0 to 200, where the sum of c+d is from 2 to 400,
   More preferably, d is from 0 to 50, c is from 1 to 200,
   More preferably, d is 1 to 10, c is 5 to 150,
R₇ is C₁-C₄ alkyl and more preferably methyl,
n is, based on molar average, from 1 to 50.

One example of most preferred above suitable terephthalate-derived nonionic SRP has one of the R₅ and R₆ is H, and another is CH₃; d is 0; c is from 5-100 and R₇ is methyl, and n is from 3-10.

Other suitable terephthalate-derived polyester SRP are described in patent WO2014019903, WO2014019658 and WO2014019659. The end capping group of these SRPs are selected from

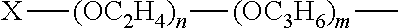

wherein X is C₁-C₄ alkyl and preferably methyl, the —(OC₂H₄) groups and the —(OC₃H₆) groups are arranged blockwise and the block consisting of the —(OC₃H₆) groups is bound to a COO group, n is based on a molar average a number of from 40 to 50, m is based on a molar average a number of from 1 to 10 and preferably of from 1 to 7.

Polyester soil release polymers may be available or convert into different forms, include powder, particle, liquid, waxy or premix. In some embodiment, other materials (for example, water, alcohol, other solvents, salt, surfactant, etc.) are needed to convert the polyester soil release polymer into different forms mentioned above, the wt % of active soil release polymer in the powder, particle, liquid, waxy or premix is in the range from 10% to 100%, for example 15%, 20%, 40%, 60%, 70%, 80%, 90%, 95%, 100%. Useful soil release polymer premix examples are described in EP351759 and WO2022100876. When the soil release polymers exist in liquid or premix from, the premix maybe transparent or opaque, white or slightly yellowish. Premix in opaque maybe use to provide an opaque appearance for the finish product or part of the finish product.

The polyester may or may not be biodegradable, preferred soil release polymers are readily biodegradable.

Example of suitable soil release polymers include TexCare® series supplied by Clariant, including noniconic soil release polymers Texcare® SRN 100, SRN 170, SRN 170 C, SRN 170 Terra, SRN 172, SRN 240, SRN 260, SRN 260 life, SRN 260 SG Terra, SRN UL50, SRN 300, SRN 325; and anionic soil release polymers TexCare® SRA 100, SRA 300, SRA300 F. Example of suitable soil release polymers also include REPEL-O-TEX® line of polymers supplied by Rhodia/Solvay, including nonionic soil release polymer REPEL-O-TEX® Crystal, Crystal PLUS, Crystal NAT, SRP6; and anionic soil release polymer REPEL-O-TEX® SF-2. Other example of commercial soil release polymers also includes WeylClean® series of soil release polymers supplied by WeylChem, including noniconic soil release polymers WeylClean® PLN1, PLN2; and anionic soil release polymers WeylClean® PSA1. Other examples of commercial soil release polymers are Marloquest® polymers, such as Marloquest® SL, HSCB, L235M, U, B, and G82, supplied by Sasol. Further suitable commercial soil release polymers include Sorez 100 (from ISP or Ashland).

### Polymers Based on Polysaccharide.

Various polysaccharides have proven to be useful starting material to make polymers for fabric and home care products, including cellulose, starch, guar, dextran, polyglucan, chitin, curdlan, xylose, Inulin, pullulan, locust bean gum, cassia gum, tamarind gum (xyloglucan), xanthan gum, amylose, amylopectin, scleroglucan and mixtures thereof.

The most common type of modified polysaccharide is modified cellulose.

Modified cellulose polymers include anionic modified cellulose polymers which been modified with functional groups that contain negative charge. Suitable anionic modified cellulose polymers include carboxyalkyl cellulose, such as carboxymethyl cellulose. In one preferred embodiment, the carboxymethyl cellulose has a degree of carboxymethyl substitution of from about 0.5 to about 0.9 and a molecular weight from about 80,000 Da to about 300,000 Da. Suitable carboxymethylcellulose is described in WO2011/031599 and WO2009/154933. Suitable carboxymethylcellulose include Finnfix® series sold by CP Kelco or Nouryon, which include Finnfix® GDA, a hydrophobically modified carboxymethylcellulose, e.g., the alkyl ketene dimer derivative of carboxymethylcellulose sold under the tradename Finnfix® SH1, or the blocky carboxymethylcellulose sold under the tradename Finnfix®V. Other suitable anionic modified cellulose polymers include sulphoalkyl group which described in WO2006117056, sulfoethyl cellulose which described in WO2014124872.

Modified cellulose polymers also include nonionic modified cellulose polymers which been modified by functional group that does not contain any charge. Suitable nonionic modified cellulose polymers include alkyl cellulose, hydroxyalkyl cellulose, hydroxyalkyl alkylcellulose, alkylalkoxyalkyl cellulose. Suitable nonionic modified cellulose polymers also include nonionic cellulose carbamates which described in WO2015/044061; nonionic 6-desoxy-6-amino-celluloses derivative which described in US20180346846. Example of alkyl cellulose include methyl cellulose (MC), ethyl cellulose (EC), etc. Suitable ethyl cellulose are sold under tradename Ethocel™ by Dow Chemicals, DuPont, or IFF. Example of hydroxyalkyl cellulose include hydroxyethyl cellulose (HEC) and hydroxypropyl cellulose (HPC). Suitable HEC are sold under tradename Natrosol™ hydroxyethylcellulose by Ashland, such as Natrosol™ 250 with different grade available which has a total molar substitution (MS) of 2.5. Suitable HEC are also sold under tradename CELLOSIZE™ Hydroxyethyl Cellulose by Dow Chemicals. Suitable HPC are sold under tradename Klucel™ by Ashland. Example of hydroxyalkyl alkylcellulose include hydroxypropyl methylcellulose (HPMC), suitable HPMC are sold under tradename Methocel™ with different grade available by Dow Chemicals, DuPont or IFF, and under tradename Benecel™ by Ashland.

Modified cellulose polymers also include cationic modified cellulose polymers which been modified by functional group that contain cationic charge. Suitable cationic modified celluloses include quaternized hydroxyethyl cellulose (Polyquaternium-10), which available under the tradename of Ucare by Dow Chemical, such as Ucare LR400, Ucare LR30M, Ucare JR125, Ucare JR400, etc. Suitable cationic modified cellulose polymers also include quaternised hydroxyethyl cellulose (HEC) polymers with cationic substitution of trimethyl ammonium and dimethyldodecyl ammonium (Polyquaternium-67), which available under trade the tradename of SoftCAT by Dow Chemical, such as SoftCAT SK, SoftCAT SK-MH, SoftCAT SX, SoftCAT SL. Other suitable cationic modified celluloses include those sold under tradename SupraCare™ by Dow Chemical, such as SupraCare™ 150, SupraCare™ 133, SupraCare™ 212.

Suitable cationic modified cellulose polymers also include those modified with cationic group and/or a hydrophobic group and described as soil release polymers in WO2019111948, WO2019111949, WO2019111946 and WO2019111947; suitable polymers is also disclosed in WO2022060754, WO2021242942 and WO2020/091988.

Another common type of modified polysaccharide is modified guar. Similar to modified cellulose, modified guar can be nonionic modified, and anionic modified. Suitable nonionic modified guar includes hydroxypropyl guar, such as N-Hance™ HP40 and HP40S guar available from Ashland. Suitable example of modified guar also include carboxymethyl hydroxypropyl guar (CMHPG) which is anionic and nonionic modified, such as Galactasol™ available from Ashland. Other nonionic and/or anionic modified guar include for example Jaguar® HP 105 (Hydroxypropyl Guar gum), Jaguar® SOFT and HP-120 COS (Carboxymethyl Hydroxypropyl Guar Gum).

Suitable modified polysaccharide polymers also include modified starch. Examples of modified starch include carboxylate ester of starch as described in WO2015144438, esterification product of starch with e.g. C₆-C₂₄ alk(en)yl succinic anhydride as described in EP0703243; starch maleates (starch react with maleic acid anhydride) as described U.S. Pat. No. 6,063,914. Examples of modified starch also include, but not limit to, acetylated starch, acetylated distarch adipate, distarch phosphate, hydroxypropyl starch, hydroxy propyl distarch phosphate, phosphated distarch phosphate, acetylated distarch phosphate, starch sodium octenyl succinate.

Suitable modified polysaccharide polymers also include polymers based on other polysaccharide, such as cationic dextran polymers described in WO2021194808, the cationic dextran polymers are commercially available under brand name CDC, CDC-L, CD C-H by Meito Sangyo.

Suitable modified polysaccharide polymers also include polymers based on polyglucans. Suitable modified polyglucans are based on alpha 1,3-polyglucans and/or 1,6-polyglucans. In one embodiment, the modified polyglucans can be cationic modified, such as cationic modified alpha 1,3-polyglucan which described in WO2021225837; such as cationic modified alpha 1,6-polyglucans which described in WO2021257793, WO2021257932, and WO2021/257786. In another embodiment, the modified polyglucans can be hydrophobic and/or hydrophilic modified, such as those described in WO2018112187, WO2019246228, WO2019246171, WO2021252558, WO2021252560, WO2021252561, EP3922704, WO2021252569, WO2021252562, WO2021252559, WO2021252575, WO2021252563. Along the hydrophobic and/or hydrophilic modified polyglucans, the polyglucan esters which described in WO2021252562, WO2021252559, WO2021252575, WO2021252563 are especially preferred due to their performance and biodegradability profiles.

Other suitable polysaccharide polymers also include those based on inulin. Example of modified inulin include carboxymethyl group modified inulin (CMI), suitable CMI are Carboxyline series sold by Cosun Beet Company, including Carboxyline 25-40D, Carboxyline 25 D Powder, Carboxyline 20 LS D Powder, Carboxyline 25, Carboxyline 25-30 UP. Example of modified inulin also include cationic modified inulin, suitable cationic modified inulin are as described in US20190274943, US20180119055; suitable cationic modified inulin are Quatin series sold by Cosun Beet Company, including Quatin 350, Quatin 380 and Quatin 1280 which are characterized by different degree of substitution (DS), cationic density (meq/g) and molecular weight (g/mol).

Suitable modified polysaccharide polymers also include polymers based on other polysaccharide, such as xylose carbamates as described in US20210115358; carboxy or sulfo-alkylated pullulan as described in WO2019243072; carboxy- or sulfo-alkylated chitosan as described in WO2019/243108 and WO2021156093.

### Polycarboxylate Polymers.

The composition may also include one or more polycarboxylate polymers which comprise at least one carboxy group-containing monomer. The carboxy group-containing monomers are selected from acrylic acid, methacrylic acid, fumaric acid, maleic acid, itaconic acid, aconitic acid, mesaconic acid, citraconic acid, methylenemalonic acid, and salts thereof, and anhydride thereof.

Suitable polycarboxylate polymers include polyacrylate homopolymer having a molecular weight of from 4,000 Da to 9,000 Da, or from 6,000 Da to 9,000 Da. Other suitable carboxylate polymers include copolymer of acrylic acid (and/or methacrylic acid) and maleic acid having a molecular weight of from 50,000 Da to 120,000 Da, or from 60,000 Da to 80,000 Da. The polyacrylate homopolymer and copolymer of acrylic acid (and/or methacrylic acid) and maleic acid are commercially available as Acusol 445 and 445N, Acusol 531, Acusol 463, Acusol 448, Acusol 460, Acusol 465, Acusol 497, Acusol 490 from Dow Chemicals, and as Sokalan CP 5, Sokalan CP 7, Sokalan CP 45, and Sokalan CP 12S from BASF. Suitable polycarboxylate polymers also include polyitaconate homopolymers, such as Itaconix® DSP 2K™ sold by Itaconix, and Amaze SP available from Nouryon.

Suitable polycarboxylate polymers also include co-polymers comprising carboxy group-containing monomers and one or more sulfonate or sulfonic group-containing monomers. The sulfonate or sulfonic group containing monomers are selected rom 2-acrylamido-2-methyl-1-propanesulfonic acid (AMPS), 2-methacrylamido-2-methyl-1-propanesulfonic acid, 3-methacrylamido-2-hydroxy-propanesulfonic acid, allysulfonic acid, methallysulfonic acid, 3-allyloxy-2-hydroxy-1-propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof. In one embodiment, suitable polymers comprise maleic acid, acrylic acid, and 3-allyloxy-2-hydroxy-1-propanesulfonic acid, such polymers are as described in U.S. Pat. Nos. 8,450,261 and 8,389,458. In another embodiment, suitable polymers comprise acrylic acid and 2-acrylamido-2-methyl-propane sulfonate, such as those sold under tradename Acusol 588 by Dow Chemicals, Sokalan CP50 by BASF, Aquatreat AR-545, Versaflex 310 and Versaflex 310-37 by Nouryon. In another embodiment, suitable polymers also include Poly(itaconic acid-co-AMPS) sodium salt, such as Itaconix® TSI™ 322 and Itaconix® CHT™ 122 available from Itaconix.

Suitable polymer also includes those contain other structure units in addition to the sulfonate or sulfonic group group-containing monomers and carboxy group-containing monomers. Suitable polymer examples are described in WO2010024468 and WO2014/032267, the additional monomers herein are ether bond-containing monomers represented by formula (1) and (2) below:

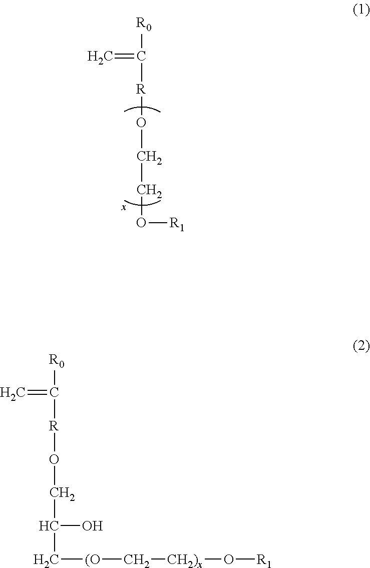

Wherein in Formula (1)
R₀ represents a hydrogen atom or CH₃ group,
R represents a CH₂ group, CH₂CH₂ group or single bond,
x represents a number 0-50, preferable 0-20, more preferable 0-5 (provided x represents a number 1-5 when R is a single bond), and
R₁ is a hydrogen atom or C₁ to C₂₀ organic group
Wherein in Formula (2),
R₀ represents a hydrogen atom or CH₃ group,
R represents a CH₂ group, CH₂CH₂ group or single bond,
x represents a number 0-5, and
R₁ is a hydrogen atom or C₁ to C₂₀ organic group.

A specific preferred polymer of this type comprises structure units derived from 1 to 49 wt % of 1-(allyloxy)-3-butoxypropan-2-ol, from 50 to 98 wt % acrylic acid or methacrylic acid, and from 1 to 49 wt % of 3-allyloxy-2-hydroxy-1-propanesulfonic acid, and the has a weight average molecular weight of from about 20,000 to about 60,000. a specific preferred polymer of this type comprises structure units derived from 1 to 10 wt % of 1-(allyloxy)-3-butoxypropan-2-ol, from 70 to 89 wt % acrylic acid or methacrylic acid, and from 10 to 20 wt % of 3-allyloxy-2-hydroxy-1-propanesulfonic acid, and the has a weight average molecular weight of from about 30,000 to about 60,000. Herein, 1-(allyloxy)-3-butoxypropan-2-ol is a preferred monomer as represented by formula (2) when R₀ is H, R is CH₂, x is 0, and R₁ is n-butyl (C₄-alkyl).

Suitable polycarboxylate polymers also include co-polymers comprising carboxy group-containing monomers and other suitable monomers. Other suitable monomers here are selected from esters and/or amide of the carboxy group-containing monomers, such as C₁-C₂₀ alkyl ester of acrylic acid; alkylene; vinyl ethers, such as methyl vinyl ether, styrene and any mixtures thereof. One specific preferred polymer family of this type is sold under tradename Gantrez by Ashland, which includes Gantrez An (alternating co-polymer of methyl vinyl ether and maleic anhydride), Gantrez S (alternating co-polymer of methyl vinyl ether and maleic acid), Gantrez ES (alternating co-polymer of methyl vinyl ether and maleic acid ester), Gantrez MS (alternating co-polymer of methyl vinyl ether and maleic acid salt).

Suitable polycarboxylate polymers also include polyepoxy succinic acid polymers (PESA). A most preferred polyepoxy succinic acid polymer can be identified using CAS number: 51274-37-4, or 109578-44-1. Suitable polyepoxy succinic acid polymers are commercially available from various suppliers, such as Aquapharm Chemicals Pvt. Ltd (commercial name: Maxinol 600); Shandong Taihe Water Treatment Technologies Co., Ltd (commercial name: PESA), and Sirius International (commercial name: Briteframe PESA).

Suitable polycarboxylate polymers also include polymer comprising a monomer having at least one aspartic acid group or a salt thereof, this polymer comprises at least 25 mol %, 40 mol %, or 50 mol %, of said monomer. A preferred example is sodium salt of poly(aspartic acid) having a molecular weight of from 2000 to 3000 g/mol which is available as Baypure® DS 100 from Lanxess.

### Other Polymers.

The composition may comprise block polymers of ethylene oxide, propylene oxide and butylene oxide. Examples of such block polymers include ethylene oxide-propylene oxide-ethylene oxide (EO/PO/EO) triblock copolymer, wherein the copolymer comprises a first EO block, a second EO block and PO block wherein the first EO block and the second EO block are linked to the PO block. Blocks of ethylene oxide, propylene oxide, butylene oxide can also be arranged in other ways, such as (EO/PO) diblock copolymer, (PO/EO/PO) triblock copolymer. The block polymers may also contain additional butylene oxide (BO) block. Suitable block polymers are for example Pluronic PE series from BASF, including Pluronic PE3100, PE4300, PE6100, PE6200, PE6400, PE6800, PE8100, PE9200, PE9400, PE10100, PE10500, PE10400. Suitable block polymers also available as Tergitol L series from Dow Chemicals, such as Tergitol L-61, L-62, L-64, L-81, L-101. Due to the hydrophobic and hydrophilic nature, such block polymer sometime is also considered as nonionic surfactant in literature.

The composition may comprise dye transfer inhibiting agents (also called dye transfer inhibitor, or dye fixatives), which include, but are not limited to, polyvinylpyrrolidone polymers (PVP), poly(vinylpyridine-N-oxide) polymer (PVNO), poly(vinylimidazole), polyamine N-oxide polymers, copolymers of N-vinylpyrrolidone and N-vinylimidazole, polyvinyloxazolidones and polyvinylimidazoles or mixtures thereof dye transfer inhibiting agents may be selected from the group consisting of reaction products of: i) polyamines with cyanamides and organic and/or inorganic acids, ii) cyanamides with aldehydes and ammonium salts, iii) cyanamides with aldehydes and amines, or iv) amines with epichlorohydrin.

The composition may comprise one or more other polymeric dispersing agents. Examples are poly (ethylene glycol), poly(vinyl alcohol).

Suitable polymers can also comprise monomers obtainable from renewable raw materials. Such monomers are described in US20200277548, US20200277549, WO2019096590.

### Additional Amines:

Additional amines may be used in the compositions described herein for added removal of grease and particulates from soiled materials. The compositions described herein may comprise from about 0.1% to about 10%, in some examples, from about 0.1% to about 4%, and in other examples, from about 0.1% to about 2%, by weight of the composition, of additional amines. Non-limiting examples of additional amines may include, but are not limited to, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

### Bleaching Agents.

It may be preferred for the composition to comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent or mixtures of bleaching agents by weight of the subject composition. Examples of suitable bleaching agents include:
(1) photobleaches for example sulfonated zinc phthalocyanine sulfonated aluminium phthalocyanines, xanthene dyes, thioxanthones, and mixtures thereof;
(2) pre-formed peracids: Suitable preformed peracids include, but are not limited to compounds selected from the group consisting of pre-formed peroxyacids or salts thereof typically a percarboxylic acids and salts, percarbonic acids and salts, perimidic acids and salts, peroxymonosulfuric acids and salts, for example, Oxone®, and mixtures thereof.

Particularly preferred peroxyacids are phthalimido-peroxy-alkanoic acids, in particular F-phthalimido peroxy hexanoic acid (PAP). Preferably, the peroxyacid or salt thereof has a melting point in the range of from 30° C. to 60° C.
(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. When employed, inorganic perhydrate salts are typically present in amounts of from 0.05 to 40 wt %, or 1 to 30 wt % of the overall fabric and home care product and are typically incorporated into such fabric and home care products as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and
(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS).
(5) Bleach Catalysts. The compositions of the present invention may also include one or more bleach catalysts capable of accepting an oxygen atom from a peroxyacid and/or salt thereof, and transferring the oxygen atom to an oxidizeable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and alpha amino-ketones and mixtures thereof. One particularly preferred catalyst is acyl hydrazone type such as 4-(2-(2-((2-hydroxyphenylmethyl)methylene)-hydrazinyl)-2-oxoethyl)-4-methylchloride.
(6) The composition may preferably comprise catalytic metal complexes. One preferred type of metal-containing bleach catalyst is a catalyst system comprising a transition metal cation of defined bleach catalytic activity, such as copper, iron, titanium, ruthenium, tungsten, molybdenum, or manganese cations.

If desired, the compositions herein can be catalyzed by means of a manganese compound. Such compounds and levels of use are well known in the art and include, for example, the manganese-based catalysts disclosed in U.S. Pat. No. 5,576,282. In some embodiments, an additional source of oxidant in the composition is not present, molecular oxygen from air providing the oxidative source.

Cobalt bleach catalysts useful herein are known, and are described, for example, in U.S. Pat. Nos. 5,597,936; 5,595,967.

### Fluorescent Brightener:

Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The fluorescent brightener may be selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by BASF), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by BASF), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by BASF). More preferably, the fluorescent brightener is disodium 4,4′-bis{[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt. The brighteners may be added in particulate form or as a premix with a suitable solvent, for example nonionic surfactant, propanediol.

Fabric Hueing Agents: The compositions may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

### Chelating Agent.

Preferably the composition comprises chelating agents and/or crystal growth inhibitor. Suitable molecules include copper, iron and/or manganese chelating agents and mixtures thereof. Suitable molecules include hydroxamic acids, aminocarboxylates, aminophosphonates, succinates, salts thereof, and mixtures thereof. Non-limiting examples of suitable chelants for use herein include ethylenediaminetetracetates, N-(hydroxyethyl)ethylenediaminetriacetates, nitrilotriacetates, ethylenediamine tetraproprionates, triethylenetetraaminehexacetates, diethylenetriamine-pentaacetates, ethanoldiglycines, ethylenediaminetetrakis (methylenephosphonates), diethylenetriamine penta(methylene phosphonic acid) (DTPMP), ethylenediamine disuccinate (EDDS), hydroxyethanedimethylenephosphonic acid (HEDP), methylglycinediacetic acid (MGDA), diethylenetriaminepentaacetic acid (DTPA), N,N-Dicarboxymethyl glutamic acid (GLDA) and salts thereof, and mixtures thereof. Other nonlimiting examples of chelants of use in the present invention are found in U.S. Pat. Nos. 7,445,644, 7,585,376 and 2009/0176684A1. Other suitable chelating agents for use herein are the commercial DEQUEST series, and chelants from Monsanto, DuPont, and Nalco, Inc. Yet other suitable chelants include the pyridinyl N Oxide type.

### Encapsulates.

The compositions may comprise an encapsulate. In some aspects, the encapsulate comprises a core, a shell having an inner and outer surface, where the shell encapsulates the core.

In certain aspects, the encapsulate comprises a core and a shell, where the core comprises a material selected from perfumes; brighteners; dyes; insect repellants; silicones; waxes; flavors; vitamins; fabric softening agents; skin care agents, e.g., paraffins; enzymes; anti-bacterial agents; bleaches; sensates; or mixtures thereof, and where the shell comprises a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts, or mixtures thereof. In some aspects, where the shell comprises an aminoplast, the aminoplast comprises polyurea, polyurethane, and/or polyureaurethane. The polyurea may comprise polyoxymethyleneurea and/or melamine formaldehyde.

### Perfume.

Preferred compositions of the invention comprise perfume. Typically the composition comprises a perfume that comprises one or more perfume raw materials, selected from the group as described in WO08/87497. However, any perfume useful in a laundry care composition may be used. A preferred method of incorporating perfume into the compositions of the invention is via an encapsulated perfume particle comprising either a water-soluble hydroxylic compound or melamine-formaldehyde or modified polyvinyl alcohol.

### Malodor Reduction Materials.

The cleaning compositions of the present disclosure may comprise malodour reduction materials. Such materials are capable of decreasing or even eliminating the perception of one or more malodors. These materials can be characterized by a calculated malodor reduction value (“MORV”), which is calculated according to the test method shown in WO2016/049389.

As used herein “MORV” is the calculated malodor reduction value for a subject material. A material's MORV indicates such material's ability to decrease or even eliminate the perception of one or more malodors.

The cleaning compositions of the present disclosure may comprise a sum total of from about 0.00025% to about 0.5%, preferably from about 0.0025% to about 0.1%, more preferably from about 0.005% to about 0.075%, most preferably from about 0.01% to about 0.05%, by weight of the composition, of 1 or more malodor reduction materials. The cleaning composition may comprise from about 1 to about 20 malodor reduction materials, more preferably 1 to about 15 malodor reduction materials, most preferably 1 to about 10 malodor reduction materials.

One, some, or each of the malodor reduction materials may have a MORV of at least 0.5, preferably from 0.5 to 10, more preferably from 1 to 10, most preferably from 1 to 5. One, some, or each of the malodor reduction materials may have a Universal MORV, defined as all of the MORV values of >0.5 for the malodors tested as described herein. The sum total of malodor reduction materials may have a Blocker Index of less than 3, more preferable less than about 2.5, even more preferably less than about 2, and still more preferably less than about 1, and most preferably about 0. The sum total of malodor reduction materials may have a Blocker Index average of from about 3 to about 0.001.

In the cleaning compositions of the present disclosure, the malodor reduction materials may have a Fragrance Fidelity Index of less than 3, preferably less than 2, more preferably less than 1 and most preferably about 0 and/or a Fragrance Fidelity Index average of 3 to about 0.001 Fragrance Fidelity Index. As the Fragrance Fidelity Index decreases, the malodor reduction material(s) provide less and less of a scent impact, while continuing to counteract malodors.

The cleaning compositions of the present disclosure may comprise a perfume. The weight ratio of parts of malodor reduction composition to parts of perfume may be from about 1:20,000 to about 3000:1, preferably from about 1:10,000 to about 1,000:1, more preferably from about 5,000:1 to about 500:1, and most preferably from about 1:15 to about 1:1. As the ratio of malodor reduction composition to parts of perfume is tightened, the malodor reduction material(s) provide less and less of a scent impact, while continuing to counteract malodors.

### Conditioning Agents.

Suitable conditioning agents include high melting point fatty compounds. The high melting point fatty compound useful herein has a melting point of 25° C. or higher and is selected from the group consisting of fatty alcohols, fatty acids, fatty alcohol derivatives, fatty acid derivatives, and mixtures thereof. Suitable conditioning agents also include nonionic polymers and conditioning oils, such as hydrocarbon oils, polyolefins, and fatty esters.

Suitable conditioning agents include those conditioning agents characterized generally as silicones (e.g., silicone oils, polyoils, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. The compositions of the present invention may also comprise from about 0.05% to about 3% of at least one organic conditioning oil as the conditioning agent, either alone or in combination with other conditioning agents, such as the silicones (described herein). Suitable conditioning oils include hydrocarbon oils, polyolefins, and fatty esters.

### Probiotics.

The composition may comprise probiotics, such as those described in WO2009/043709.

### Organic Acids.

The detergent comprises one or more organic acids selected from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof. Preferably, the detergent composition may comprise an organic acid selected from the group consisting of acetic acid, lactic acid, and citric acid.

### Anti-Oxidant.

The composition may optionally contain an anti-oxidant present in the composition from about 0.001 to about 2% by weight. Preferably the antioxidant is present at a concentration in the range 0.01 to 0.08% by weight. Mixtures of anti-oxidants may be used.

### Hygiene Agent.

The compositions of the present invention may also comprise components to deliver hygiene and/or malodour benefits such as one or more of zinc ricinoleate, thymol, quaternary ammonium salts such as Bardac®, polyethylenimines (such as Lupasol® from BASF) and zinc complexes thereof, silver and silver compounds, especially those designed to slowly release Ag+ or nano-silver dispersions.

The cleaning compositions of the present invention may also contain antimicrobial agents. Preferably, the anti-microbial agent is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

### Pearlescent Agent.

Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

### Opacifier.

In one embodiment, the composition might also comprise an opacifier. As the term is used herein, an “opacifier” is a substance added to a material in order to make the ensuing system opaque. In one preferred embodiment, the opacifier is Acusol, which is available from Dow Chemicals. Acusol opacifiers are provided in liquid form at a certain % solids level. As supplied, the pH of Acusol opacifiers ranges from 2.0 to 5.0 and particle sizes range from 0.17 to 0.45 um. In one preferred embodiment, Acusol OP303B and 301 can be used.

In yet another embodiment, the opacifier may be an inorganic opacifier. Preferably, the inorganic opacifier can be TiO₂, ZnO, talc, CaCO₃, and combination thereof. The composite opacifier-microsphere material is readily formed with a preselected specific gravity, so that there is little tendency for the material to separate.

### Solvents.

The solvent system in the present compositions can be a solvent system containing water alone or mixtures of organic solvents either without or preferably with water. The compositions may optionally comprise an organic solvent. Suitable organic solvents include C₄-C₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. Preferred organic solvents include 1,2-propanediol, 2,3 butane diol, ethanol, glycerol, ethoxylated glycerol, dipropylene glycol, methyl propane diol and mixtures thereof 2 ethyl hexanol, 3,5,5,trimethyl-1 hexanol, and 2 propyl heptanol. Solvents may be a polyethylene or polypropylene glycol ether of glycerin. Other lower alcohols, C₁-C₄ alkanolamines such as monoethanolamine and triethanolamine, can also be used.

Solvent systems can be absent, for example from anhydrous solid embodiments of the invention, but more typically are present at levels in the range of from about 0.1% to about 98%, preferably at least about 1% to about 50%, more usually from about 5% to about 25%, alternatively from about 1% to about 10% by weight of the liquid detergent composition of said organic solvent. These organic solvents may be used in conjunction with water, or they may be used without water Hydrotrope.

The composition may optionally comprise a hydrotrope in an effective amount, i.e. from about 0% to 15%, or about 1% to 10%, or about 3% to about 6%, so that compositions are compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903.

### Suds Suppressor.

Compounds for reducing or suppressing the formation of suds can be incorporated into the water-soluble unit dose articles. Suds suppression can be of particular importance in the so-called “high concentration cleaning process” and in front-loading style washing machines. Examples of suds suppressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons preferably having a melting point below about 100° C., silicone suds suppressors, and secondary alcohols. Preferred fatty acid blends may be mixtures enriched or Fatty acid mixtures enriched with 2-alkyl fatty acid, preferably 2-methyl octanoic acid Additional suitable antifoams are those derived from phenylpropylmethyl substituted polysiloxanes.

The detergent composition may comprise a suds suppressor selected from organomodified silicone polymers with aryl or alkylaryl substituents combined with silicone resin and a primary filler, which is modified silica. The detergent compositions may comprise from about 0.001% to about 4.0%, by weight of the composition, of such a suds suppressor.

The detergent composition comprises a suds suppressor selected from: a) mixtures of from about 80 to about 92% ethylmethyl, methyl(2-phenylpropyl) siloxane; from about 5 to about 14% MQ resin in octyl stearate; and from about 3 to about 7% modified silica; b) mixtures of from about 78 to about 92% ethylmethyl, methyl(2-phenylpropyl) siloxane; from about 3 to about 10% MQ resin in octyl stearate; from about 4 to about 12% modified silica; or c) mixtures thereof, where the percentages are by weight of the anti-foam.

### Liquid Laundry Detergent Composition.

The fabric and home care product can be a laundry detergent composition, such as a liquid laundry detergent composition. Suitable liquid laundry detergent compositions can comprise a non-soap surfactant, wherein the non-soap surfactant comprises an anionic non-soap surfactant and a non-ionic surfactant. The laundry detergent composition can comprise from 10% to 60%, or from 20% to 55% by weight of the laundry detergent composition of the non-soap surfactant. The non-soap anionic surfactant to nonionic surfactant are from 1:1 to 20:1, from 1.5:1 to 17.5:1, from 2:1 to 15:1, or from 2.5:1 to 13:1. Suitable non-soap anionic surfactants include linear alkylbenzene sulphonate, alkyl sulphate or a mixture thereof. The weight ratio of linear alkylbenzene sulphonate to alkyl sulphate can be from 1:2 to 9:1, from 1:1 to 7:1, from 1:1 to 5:1, or from 1:1 to 4:1. Suitable linear alkylbenzene sulphonates are C₁₀-C₁₆ alkyl benzene sulfonic acids, or C₁-C₁₄ alkyl benzene sulfonic acids. Suitable alkyl sulphate anionic surfactants include alkoxylated alkyl sulphates, non-alkoxylated alkyl sulphates, and mixture thereof. Preferably, the HLAS surfactant comprises greater than 50% C₁₂, preferably greater than 60%, preferably greater than 70% C₁₂, more preferably greater than 75% C₁₂. Suitable alkoxylated alkyl sulphate anionic surfactants include ethoxylated alkyl sulphate anionic surfactants. Suitable alkyl sulphate anionic surfactants include ethoxylated alkyl sulphate anionic surfactant with a mol average degree of ethoxylation of from 1 to 5, from 1 to 3, or from 2 to 3. The alkyl alkoxylated sulfate may have a broad alkoxy distribution or a peaked alkoxy distribution. The alkyl portion of the AES may include, on average, from 13.7 to about 16 or from 13.9 to 14.6 carbons atoms. At least about 50% or at least about 60% of the AES molecule may include having an alkyl portion having 14 or more carbon atoms, preferable from 14 to 18, or from 14 to 17, or from 14 to 16, or from 14 to 15 carbon atoms. The alkyl sulphate anionic surfactant may comprise a non-ethoxylated alkyl sulphate and an ethoxylated alkyl sulphate wherein the mol average degree of ethoxylation of the alkyl sulphate anionic surfactant is from 1 to 5, from 1 to 3, or from 2 to 3. The alkyl fraction of the alkyl sulphate anionic surfactant can be derived from fatty alcohols, oxo-synthesized alcohols, Guerbet alcohols, or mixtures thereof. Preferred alkyl sulfates include optionally ethoxylated alcohol sulfates including 2-alkyl branched primary alcohol sulfates especially 2-branched C₁₂₋₁₅ primary alcohol sulfates, linear primary alcohol sulfates especially linear C₁₂₋₁₄ primary alcohol sulfates, and mixtures thereof. The laundry detergent composition can comprise from 10% to 50%, or from 15% to 45%, or from 20% to 40%, or from 30% to 40% by weight of the laundry detergent composition of the non-soap anionic surfactant.

Suitable non-ionic surfactants can be selected from alcohol broad or narrow range alkoxylates, an oxo-synthesised alcohol alkoxylate, Guerbet alcohol alkoxylates, alkyl phenol alcohol alkoxylates, or a mixture thereof. The laundry detergent composition can comprise from 0.01% to 10%, from 0.01% to 8%, from 0.1% to 6%, or from 0.15% to 5% by weight of the liquid laundry detergent composition of a non-ionic surfactant.

The laundry detergent composition comprises from 1.5% to 20%, or from 2% to 15%, or from 3% to 10%, or from 4% to 8% by weight of the laundry detergent composition of soap, such as a fatty acid salt. Such soaps can be amine neutralized, for instance using an alkanolamine such as monoethanolamine.

The laundry detergent composition can comprises an adjunct ingredient selected from the group comprising builders including citrate, enzymes, bleach, bleach catalyst, dye, hueing dye, Leuco dyes, brightener, cleaning polymers including alkoxylated polyamines and polyethyleneimines, amphiphilic copolymers, soil release polymer, surfactant, solvent, dye transfer inhibitors, chelant, diamines, perfume, encapsulated perfume, polycarboxylates, structurant, pH trimming agents, antioxidants, antibacterial, antimicrobial agents, preservatives and mixtures thereof.

The laundry detergent composition can have a pH of from 2 to 11, or from 6.5 to 8.9, or from 7 to 8, wherein the pH of the laundry detergent composition is measured at a 10% product concentration in demineralized water at 20° C.

The liquid laundry detergent composition can be Newtonian or non-Newtonian, preferably non-Newtonian.

For liquid laundry detergent compositions, the composition can comprise from 5% to 99%, or from 15% to 90%, or from 25% to 80% by weight of the liquid detergent composition of water.

The detergent composition according to the invention can be liquid laundry detergent composition. The following are exemplary liquid laundry detergent formulations (Table 1). Preferably the liquid laundry detergent composition comprises from between 0.1 to 20.0%, preferably 0.2% to 10%, preferably between 0.3% and 5.0%, preferably between 0.5% and 3%, more preferably between 1% to 2.5% by weight of the detergent composition of the graft polymer according to the invention.

TABLE 1

| | Comp. 1 | Comp. 2 | Comp. 3 | Comp. 4 |
|---|---|---|---|---|
| Raw Material | % wt | % wt | % wt | % wt |
| Branched Alkyl | 0.0 | 5.3 | 0.0 | 5.3 |
| Sulfate | | | | |
| Sodium Lauryl | 0.0 | 3.0 | 0.0 | 3.0 |
| Sulfate | | | | |
| Linear alkylbenzene | 18.0 | 5.0 | 6.0 | 5.0 |
| sulfonate | | | | |
| AE₃S | 5.0 | 0.0 | 1.3 | 0.0 |
| Ethoxylated alkyl | | | | |
| sulphate with an average | | | | |
| degree of | | | | |
| ethoxylation of 3 | | | | |
| C₂₅AES | 0.0 | 3.0 | 1.4 | 0.0 |
| Ethoxylated alkyl | | | | |
| sulphate with an average | | | | |
| degree of | | | | |
| ethoxylation of 2.5¹ | | | | |
| Amine oxide | 0.7 | 1.0 | 0.4 | 0.8 |
| C₁₂₋₁₄ alkyl | 8.4 | 0.0 | 12.9 | 5.0 |
| ethoxylate (EO7) | | | | |
| C₁₂₋₁₄ alkyl | 0.0 | 8.7 | 0.0 | 3.7 |
| ethoxylate (EO9) | | | | |
| C₁₂₋₁₅ alkyl | 0.0 | 2.7 | 0.0 | 2.7 |
| ethoxylate (EO7) | | | | |
| Citric acid | 2.9 | 2.3 | 0.7 | 2.3 |
| Palm kernel | 0.0 | 1.0 | 0.0 | 1.0 |
| fatty acid | | | | |
| Topped kernel | 2.9 | 0.0 | 2.3 | 0.0 |
| fatty acid | | | | |
| Mannanase | 0.0017 | 0.0017 | 0.0017 | 0.0017 |
| Pectawash | 0.00342 | 0.00342 | 0.00342 | 0.00342 |
| Amylase | 0.00766 | 0.00766 | 0.00766 | 0.00766 |
| Protease | 0.07706 | 0.07706 | 0.07706 | 0.07706 |
| Nuclease³ | 0.010 | 0.01 | 0.01 | 0.01 |
| Sodium tetraborate | 0.0 | 1.7 | 0.0 | 1.7 |
| MEA-Boric Acid Salt | 0.0 | 0.0 | 0.8 | 0.0 |
| Calcium/ | 0.0 | 0.04 | 0.01 | 0.04 |
| sodium formate | | | | |
| Sodium/Calcium | 0.04 | 0.02 | 0.03 | 0.02 |
| Chloride | | | | |
| Ethoxylated | 0.0 | 2.0 | 1.1 | 2.0 |
| polyethyleneimine² | | | | |
| Amphiphilic | 1.5 | 0.0 | 0.0 | 0.0 |
| graft copolymer | | | | |
| Ethoxylated- | 0.0 | 2.0 | 0.8 | 2.0 |
| Propoxylated | | | | |
| polyethyleneimine | | | | |
| Zwitterionic polyamine | 0.5 | 0.0 | 0.0 | 0.0 |
| Nonionic polyester | 1.0 | 1.0 | 1.0 | 1.0 |
| terephthalate | | | | |
| Graft polymer | 1.0 | 2.0 | 1.5 | 2.5 |
| of the present | | | | |
| invention | | | | |
| DTPA | 0.0 | 0.1 | 0.2 | 0.1 |
| EDDS | 0.1 | 0.0 | 0.0 | 0.0 |
| GLDA | 0.4 | 0.3 | 0.1 | 0.0 |
| MGDA | 0.2 | 0.0 | 0.0 | 0.5 |
| Diethylene triamine | 1.1 | 0.0 | 0.0 | 0.0 |
| penta(methyl | | | | |
| phosphonic) acid | | | | |
| (DTPMP) | | | | |
| Fluorescent | 0.06 | 0.22 | 0.03 | 0.15 |
| Brightener⁸ | | | | |
| Ethanol | 0.7 | 1.9 | 0.0 | 1.9 |
| propylene glycol | 5.5 | 5.5 | 0.33 | 5.5 |
| Sorbitol | 0.01 | 0.01 | 0.0 | 0.01 |
| Monoethanolamine | 0.2 | 0.2 | 0.6 | 0.2 |
| DETA | 0.1 | 0.08 | 0.0 | 0.08 |
| Antioxidant 1 | 0.0 | 0.1 | 0.1 | 0.1 |
| Antioxidant 2 | 0.1 | 0.0 | 0.0 | 0.0 |
| Hygiene Agent | 0.0 | 0.0 | 0.05 | 0.0 |
| NaOH | 4.7 | 4.7 | 1.1 | 4.7 |
| NaCS | 3.2 | 1.7 | 3.2 | 1.7 |
| Hydrogenated | 0.2 | 0.1 | 0.12 | 0.1 |
| Castor Oil | | | | |
| Aesthetic dye | 0.10 | 0.01 | 0.006 | 0.01 |
| Leuco dye | 0.05 | 0.01 | 0.0 | 0.01 |
| Perfume | 2.0 | 1.3 | 0.5 | 1.3 |
| Perfume microcapsules | 0.5 | 0.05 | 0.1 | 0.05 |
| Silicone antifoam⁷ | 0.02 | 0.01 | 0.0 | 0.01 |
| Phenyloxyethanol | 0.002 | 0.01 | 0.0 | 0.01 |
| Hueing dye | 0.01 | 0.1 | 0.05 | 0.1 |
| Water & miscellaneous | balance | balance | balance | balance |

Description of super-script numbers:
¹C12-15E02.5S AlkylethoxySulfate where the alkyl portion of AES includes from about 13.9 to 14.6 carbon atoms
²PE-20 commercially available from BASF
³Nuclease enzyme is as claimed in co-pending European application 19219568.3
⁴Antioxidant 1 is 3,5-bis(1,1-dimethylethyl)-4-hydroxybenzenepropanoic acid, methyl ester [6386-38-5]
⁵Antioxidant 2 is Tinogard TS commercially available from BASF
⁶Hygiene Agent is agent is Tinosan HP 100 commercially available from BASF
⁷Dow Corning supplied antifoam blend 80-92% ethylmethyl, methyl(2-phenyl propyl)siloxane; 5-14% MQ Resin in octyl stearate a 3-7% modified silica.
⁸Fluorescent Brightener is disodium 4,4′-bis{[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt.

### Water Soluble Unit Dose Article.

The fabric and home care product can be a water-soluble unit dose article. The water-soluble unit dose article comprises at least one water-soluble film orientated to create at least one unit dose internal compartment, wherein the at least one unit dose internal compartment comprises a detergent composition. The water-soluble film preferably comprises polyvinyl alcohol homopolymer or polyvinyl alcohol copolymer, for example a blend of polyvinylalcohol homopolymers and/or polyvinylalcohol copolymers, for example copolymers selected from sulphonated and carboxylated anionic polyvinylalcohol copolymers especially carboxylated anionic polyvinylalcohol copolymers, for example a blend of a polyvinylalcohol homopolymer and a carboxylated anionic polyvinylalcohol copolymer. In some examples water soluble films are those supplied by Monosol under the trade references M8630, M8900, M8779, M8310. The detergent product comprises a detergent composition, more preferably a laundry detergent composition. Preferably the laundry detergent composition enclosed in the water-soluble unit dose article comprises from between 0.1% and 8%, preferably between 0.5% and 7%, more preferably 1.0% to 6.0% by weight of the detergent composition of the graft polymer of the present invention. Preferably the soluble unit dose laundry detergent composition comprises a non-soap surfactant, wherein the non-soap surfactant comprises an anionic non-soap surfactant and a non-ionic surfactant. More preferably, the laundry detergent composition comprises between 10% and 60%, or between 20% and 55% by weight of the laundry detergent composition of the non-soap surfactant. The weight ratio of non-soap anionic surfactant to nonionic surfactant preferably is from 1:1 to 20:1, from 1.5:1 to 17.5:1, from 2:1 to 15:1, or from 2.5:1 to 13:1. The non-soap anionic surfactants preferably comprise linear alkylbenzene sulphonate, alkyl sulphate or a mixture thereof. The weight ratio of linear alkylbenzene sulphonate to alkyl sulphate preferably is from 1:2 to 9:1, from 1:1 to 7:1, from 1:1 to 5:1, or from 1:1 to 4:1. Example linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear. Example alkyl sulphate anionic surfactant may comprise alkoxylated alkyl sulphate or non-alkoxylated alkyl sulphate or a mixture thereof. Example alkoxylated alkyl sulphate anionic surfactants comprise an ethoxylated alkyl sulphate anionic surfactant. Example alkyl sulphate anionic surfactant may comprise an ethoxylated alkyl sulphate anionic surfactant with a mol average degree of ethoxylation from 1 to 5, from 1 to 3, or from 2 to 3. Example alkyl sulphate anionic surfactant may comprise a non-ethoxylated alkyl sulphate and an ethoxylated alkyl sulphate wherein the mol average degree of ethoxylation of the alkyl sulphate anionic surfactant is from 1 to 5, from 1 to 3, or from 2 to 3. Example alkyl fraction of the alkyl sulphate anionic surfactant are derived from fatty alcohols, oxo-synthesized alcohols, Guerbet alcohols, or mixtures thereof. Preferably the laundry detergent composition comprises between 10% and 50%, between 15% and 45%, between 20% and 40%, or between 30% and 40% by weight of the laundry detergent composition of the non-soap anionic surfactant. In some examples, the non-ionic surfactant is selected from alcohol alkoxylate, an oxo-synthesised alcohol alkoxylate, Guerbet alcohol alkoxylates, alkyl phenol alcohol alkoxylates, or a mixture thereof. Preferably, the laundry detergent composition comprises between 0.01% and 10%, or between 0.01% and 8%, or between 0.1% and 6%, or between 0.15% and 5% by weight of the liquid laundry detergent composition of a non-ionic surfactant. Preferably, the laundry detergent composition comprises between 1.5% and 20%, between 2% and 15%, between 3% and 10%, or between 4% and 8% by weight of the laundry detergent composition of soap, in some examples a fatty acid salt, in some examples an amine neutralized fatty acid salt, wherein in some examples the amine is an alkanolamine preferably monoethanolamine. Preferably the liquid laundry detergent composition comprises less than 15%, or less than 12% by weight of the liquid laundry detergent composition of water. Preferably, the laundry detergent composition comprises between 10% and 40%, or between 15% and 30% by weight of the liquid laundry detergent composition of a non-aqueous solvent selected from 1,2-propanediol, dipropylene glycol, tripropyleneglycol, glycerol, sorbitol, polyethylene glycol or a mixture thereof. Preferably the liquid laundry detergent composition comprises from 0.1% to 10%, preferably from 0.5% to 8% by weight of the detergent composition of further soil release polymers, preferably selected from the group of nonionic and/or anionically modified polyester terephthalate soil release polymers such as commercially available under the Texcare brand name from Clariant, amphiphilic graft polymers such as those based on polyalkylene oxides and vinyl esters, polyalkoxylated polyethyleneimines, and mixtures thereof. Preferably the liquid detergent composition further comprises from 0.1% to 10% preferably from 1% to 5% of a chelant. In some examples, the laundry detergent composition comprises an adjunct ingredient selected from the group comprising builders including citrate, enzymes, bleach, bleach catalyst, dye, hueing dye, brightener, cleaning polymers including (zwitterionic) alkoxylated polyamines, surfactant, solvent, dye transfer inhibitors, perfume, encapsulated perfume, polycarboxylates, structurant, pH trimming agents, and mixtures thereof. Preferably, the laundry detergent composition has a pH between 6 and 10, between 6.5 and 8.9, or between 7 and 8, wherein the pH of the laundry detergent composition is measured as a 10% product concentration in demineralized water at 20° C. When liquid, the laundry detergent composition may be Newtonian or non-Newtonian, preferably non-Newtonian.

The following is an exemplary water-soluble unit dose formulations (Table 2). The composition can be part of a single chamber water soluble unit dose article or can be split over multiple compartments resulting in below “averaged across compartments” full article composition. The composition is enclosed within a polyvinyl alcohol-based water soluble, the polyvinyl alcohol comprising a blend of a polyvinyl alcohol homopolymer and an anionic e.g. carboxylated polyvinyl alcohol copolymer.

TABLE 2

| Ingredients | Comp. 5 (wt %) |
|---|---|
| Fatty alcohol ethoxylate non-ionic surfactant, | 3.8 |
| C₁₂₋₁₄ average degree of | |
| ethoxylation of 7 | |
| Lutensol XL100 | 0.5 |
| Linear C₁₁₋₁₄ | 24.6 |
| alkylbenzene sulphonate | |
| AE₃S Ethoxylated alkyl | 12.5 |
| sulphate with an | |
| average degree of | |
| ethoxylation of 3 | |
| Citric acid | 0.7 |
| Palm Kernel Fatty acid | 5.3 |
| Nuclease enzyme* (wt % active protein) | 0.01 |
| Protease enzyme (wt % active protein) | 0.07 |
| Amylase enzyme (wt % active protein) | 0.005 |
| Xyloglucanese enzyme (wt % active protein) | 0.005 |
| Mannanase enzyme (wt % active protein) | 0.003 |
| Ethoxylated polyethyleneimine | 1.4 |
| (Lutensol FP620 - PEI600EO20) | |
| Amphiphilic graft copolymer** | 1.6 |
| Zwitterionic polyamine (Lutensit Z96) | 1.5 |
| Anionic polyester | 0.6 |
| terephthalate (Texcare SRA300) | |
| Graft polymer of the present invention | 3.0 |
| HEDP | 2.2 |
| Brightener 49 | 0.4 |
| Silicone anti-foam | 0.3 |
| Hueing dye | 0.05 |
| 1,2 PropaneDiol | 11.0 |
| Glycerine | 4.7 |
| DPG (DiPropyleneGlycol) | 1.7 |
| TPG (TriPropyleneGlycol) | 0.1 |
| Sorbitol | 0.1 |
| Monoethanolamine | 10.2 |
| K₂SO₃ | 0.4 |
| MgCl₂ | 0.3 |
| water | 10.5 |
| Hydrogenated castor oil | 0.1 |
| Perfume | 2.1 |
| Aesthetic dye & Minors | Balance to 100 |
| pH (10% product concentration in | 7.4 |
| demineralized water at 20° C.) | |

Description of super-scripts:
*Nuclease enzyme is as claimed in co-pending European application 19219568.3
**polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains

### Hand Dishwashing Liquid Composition.

The fabric and home care product can be a dishwashing detergent composition, such as a hand dishwashing detergent composition, more preferably a liquid hand dishwashing detergent composition. Preferably the liquid hand dishwashing detergent composition comprises from between 0.1% and 5.0%, preferably between 0.5% and 4%, more preferably 1.0% to 3.0% by weight of the detergent composition of the graft polymer of the present invention. The liquid hand-dishwashing detergent composition preferably is an aqueous composition, comprising from 50% to 90%, preferably from 60% to 75%, by weight of the total composition of water. Preferably the pH of the detergent composition of the invention, measured as a 10% product concentration in demineralized water at 20° C., is adjusted to between 3 and 14, more preferably between 4 and 13, more preferably between 6 and 12 and most preferably between 8 and 10. The composition of the present invention can be Newtonian or non-Newtonian, preferably Newtonian. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof. The viscosity is measured at 20° C. with a Brookfield RT Viscometer using spindle 31 with the RPM of the viscometer adjusted to achieve a torque of between 40% and 60%.

The composition comprises from 5% to 50%, preferably from 8% to 45%, more preferably from 15% to 40%, by weight of the total composition of a surfactant system. The surfactant system preferably comprises from 60% to 90%, more preferably from 70% to 80% by weight of the surfactant system of an anionic surfactant. Alkyl sulphated anionic surfactants are preferred, particularly those selected from the group consisting of: alkyl sulphate, alkyl alkoxy sulphate preferably alkyl ethoxy sulphate, and mixtures thereof. The alkyl sulphated anionic surfactant preferably has an average alkyl chain length of from 8 to 18, preferably from 10 to 14, more preferably from 12 to 14, most preferably from 12 to 13 carbon atoms. The alkyl sulphated anionic surfactant preferably has an average degree of alkoxylation preferably ethoxylation, of less than 5, preferably less than 3, more preferably from 0.5 to 2.0, most preferably from 0.5 to 0.9. The alkyl sulphate anionic surfactant preferably has a weight average degree of branching of more than 10%, preferably more than 20%, more preferably more than 30%, even more preferably between 30% and 60%, most preferably between 30% and 50%. Suitable counterions include alkali metal cation earth alkali metal cation, alkanolammonium or ammonium or substituted ammonium, but preferably sodium. Suitable examples of commercially available alkyl sulphate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company.

The surfactant system preferably comprises from 0.1% to 20%, more preferably from 0.5% to 15% and especially from 2% to 10% by weight of the liquid hand dishwashing detergent composition of a co-surfactant. Preferred co-surfactants are selected from the group consisting of an amphoteric surfactant, a zwitterionic surfactant, and mixtures thereof. The anionic surfactant to the co-surfactant weight ratio can be from 1:1 to 8:1, preferably from 2:1 to 5:1, more preferably from 2.5:1 to 4:1. The co-surfactant is preferably an amphoteric surfactant, more preferably an amine oxide surfactant. Preferably, the amine oxide surfactant is selected from the group consisting of: alkyl dimethyl amine oxide, alkyl amido propyl dimethyl amine oxide, and mixtures thereof, most preferably C₁₂-C₁₄ alkyl dimethyl amine oxide. Suitable zwitterionic surfactants include betaine surfactants, preferably cocamidopropyl betaine.

Preferably, the surfactant system of the composition of the present invention further comprises from 1% to 25%, preferably from 1.25% to 20%, more preferably from 1.5% to 15%, most preferably from 1.5% to 5%, by weight of the surfactant system, of a non-ionic surfactant. Suitable nonionic surfactants can be selected from the group consisting of: alkoxylated non-ionic surfactant, alkyl polyglucoside (“APG”) surfactant, and mixtures thereof. Suitable alkoxylated non-ionic surfactants can be linear or branched, primary or secondary alkyl alkoxylated preferably alkyl ethoxylated non-ionic surfactants comprising on average from 9 to 15, preferably from 10 to 14 carbon atoms in its alkyl chain and on average from 5 to 12, preferably from 6 to 10, most preferably from 7 to 8, units of ethylene oxide per mole of alcohol. Most preferably, the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6. C₈-C₁₆ alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

The liquid hand dishwashing detergent composition herein may optionally comprise a number of other adjunct ingredients such as builders (e.g., preferably citrate), chelants (e.g., preferably GLDA), conditioning polymers, cleaning polymers including polyalkoxylated polyalkylene imines, surface modifying polymers, soil flocculating polymers, sudsing polymers including EO-PO-EO triblock copolymers, grease cleaning amines including cyclic polyamines, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic solvents, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, phosphoric and sulfonic acids, carbonates such as sodium carbonates, bicarbonates, sesquicarbonates, borates, silicates, phosphates, imidazole and alike).

The following is an exemplary liquid hand dishwashing detergent formulation (Table 3). The formulation can be made through standard mixing of the individual components.

TABLE 3

| As 100% active | Comp. 6 (wt %) |
|---|---|
| C₁₂₁₃ AE_{0.6}S | 19.6 |
| anionic surfactant (Avg. branching: 37.84%) | |
| C₁₂₁₄ dimethyl amine oxide | 6.5 |
| Alcohol ethoxylate | 1.0 |
| nonionic surfactant (Neodol 91/8) | |
| Alkoxylated polyethyleneimine | 0.2 |
| (PEI₆₀₀EO₂₄PO₁₆) | |
| Graft polymer of the present invention | 1.0 |
| Ethanol | 2.4 |
| NaCl | 0.7 |
| Polypropyleneglycol (MW2000) | 0.9 |
| Water + Minor ingredients | Balance to 100 |
| (perfume, dye, preservatives) | |
| pH (at 10% product concentration in | 9.0 |
| demineralized water - with NaOH trimming) | |

### Solid Free-flowing Particulate Laundry Detergent Composition.

The fabric and home care product can be solid free-flowing particulate laundry detergent composition. The following is an exemplary solid free-flowing particulate laundry detergent composition (Table 4).

TABLE 4

| Ingredient | Comp. 7 (wt %) |
|---|---|
| Anionic detersive surfactant (such as alkyl benzene sulphonate, | from 8 wt % to 15 wt % |
| alkyl ethoxylated sulphate and mixtures thereof) | |
| Non-ionic detersive surfactant (such as alkyl ethoxylated | from 0.1 wt % to 4 wt % |
| alcohol) | |
| Cationic detersive surfactant (such as quaternary ammonium | from 0 wt % to 4 wt % |
| compounds) | |
| Other detersive surfactant (such as zwiterionic detersive | from 0 wt % to 4 wt % |
| surfactants, amphoteric surfactants and mixtures thereof) | |
| Carboxylate polymer (such as co-polymers of maleic acid and | from 0.1 wt % to 4 wt % |
| acrylic acid and/or carboxylate polymers comprising ether | |
| moieties and sulfonate moieties) | |
| Polyethylene glycol polymer (such as a polyethylene glycol | from 0 wt % to 4 wt % |
| polymer comprising polyvinyl acetate side chains) | |
| Polyester soil release polymer (such as Repel-o-tex and/or | from 0 wt % to 2 wt % |
| Texcare polymers) | |
| Cellulosic polymer (such as carboxymethyl cellulose, methyl | from 0.5 wt % to 2 wt % |
| cellulose and combinations thereof) | |
| Graft polymer of the present invention | From 0.1 wt % to 4 wt % |
| Other polymer (such as polymers based on polysaccharide) | from 0 wt % to 4 wt % |
| Zeolite builder and phosphate builder (such as zeolite 4A and/or | from 0 wt % to 4 wt % |
| sodium tripolyphosphate) | |
| Other co-builder (such as sodium citrate and/or citric acid) | from 0 wt % to 3 wt % |
| Carbonate salt (such as sodium carbonate and/or sodium | from 0 wt % to 20 wt % |
| bicarbonate) | |
| Silicate salt (such as sodium silicate) | from 0 wt % to 10 wt % |
| Filler (such as sodium sulphate and/or bio-fillers) | from 10 wt % to 70 wt % |
| Source of hydrogen peroxide (such as sodium percarbonate) | from 0 wt % to 20 wt % |
| Bleach activator (such as tetraacetylethylene diamine (TAED) | from 0 wt % to 8 wt % |
| and/or nonanoyloxybenzenesulphonate (NOBS)) | |
| Bleach catalyst (such as oxaziridinium-based bleach catalyst | from 0 wt % to 0.1 wt % |
| and/or transition metal bleach catalyst) | |
| Other bleach (such as reducing bleach and/or pre-formed | from 0 wt % to 10 wt % |
| peracid) | |
| Photobleach (such as zinc and/or aluminium sulphonated | from 0 wt % to 0.1 wt % |
| phthalocyanine) | |
| Chelant (such as ethylenediamine-N′N′-disuccinic acid (EDDS) | from 0.2 wt % to 1 wt % |
| and/or hydroxyethane diphosphonic acid (HEDP)) | |
| Hueing agent (such as direct violet 9, 66, 99, acid red 50, | from 0 wt % to 1 wt % |
| solvent violet 13 and any combination thereof) | |
| Brightener (C.I. fluorescent brightener 260 or C.I. fluorescent | from 0.1 wt % to 0.4 wt % |
| brightener 351) | |
| Protease (such as Savinase, Savinase Ultra, Purafect, FN3, FN4 | from 0.1 wt % to 0.4 wt % |
| and any combination thereof) | |
| Amylase (such as Termamyl, Termamyl ultra, Natalase, | from 0 wt % to 0.2 wt % |
| Optisize, Stainzyme, Stainzyme Plus and any combination | |
| thereof) | |
| Cellulase (such as Carezyme and/or Celluclean) | from 0 wt % to 0.2 wt % |
| Lipase (such as Lipex, Lipolex, Lipoclean and any combination | from 0 wt % to 1 wt % |
| thereof) | |
| Other enzyme (such as xyloglucanase, cutinase, pectate lyase, | from 0 wt % to 2 wt % |
| mannanase, bleaching enzyme) | |
| Fabric softener (such as montmorillonite clay and/or | from 0 wt % to 15 wt % |
| polydimethylsiloxane (PDMS)) | |
| Flocculant (such as polyethylene oxide) | from 0 wt % to 1 wt % |
| Suds suppressor (such as silicone and/or fatty acid) | from 0 wt % to 4 wt % |
| Perfume (such as perfume microcapsule, spray-on perfume, | from 0.1 wt % to 1 wt % |
| starch encapsulated perfume accords, perfume loaded zeolite, | |
| and any combination thereof) | |
| Aesthetics (such as coloured soap rings and/or coloured | from 0 wt % to 1 wt % |
| speckles/noodles) | |
| Miscellaneous | balance to 100 wt % |

### Fibrous Water-Soluble Unit Dose Article.

As used herein, the phrases “water-soluble unit dose article,” “water-soluble fibrous structure”, and “water-soluble fibrous element” mean that the unit dose article, fibrous structure, and fibrous element are miscible in water. In other words, the unit dose article, fibrous structure, or fibrous element is capable of forming a homogeneous solution with water at ambient conditions. “Ambient conditions” as used herein means 23° C.±1.0° C. and a relative humidity of 50%±2%. The water-soluble unit dose article may contain insoluble materials, which are dispersible in aqueous wash conditions to a suspension mean particle size that is less than about 20 microns, or less than about 50 microns.

The fibrous water-soluble unit dose article may include any of the disclosures found in U.S. patent application Ser. No. 15/880,594 filed on Jan. 26, 2018; U.S. patent application Ser. No. 15/880,599 filed Jan. 26, 2018; and U.S. patent application Ser. No. 15/880,604 filed Jan. 26, 2018; incorporated by reference in their entirety. Preferred water-soluble fibrous structure comprises particles having a ratio of Linear Alkylbenzene Sulfonate to Alkylethoxylated Sulfate or Alkyl Sulfate of greater than 1.

These fibrous water-soluble unit dose articles can be dissolved under various wash conditions, e.g., low temperature, low water and/or short wash cycles or cycles where consumers have been overloading the machine, especially with items having high water absorption capacities, while providing sufficient delivery of active agents for the intended effect on the target consumer substrates (with similar performance as today's liquid products). Furthermore, the water-soluble unit dose articles described herein can be produced in an economical manner by spinning fibers comprising active agents. The water-soluble unit dose articles described herein also have improved cleaning performance.

### METHOD OF USE

The compositions of this invention, prepared as hereinbefore described, can be used to form aqueous washing/treatment solutions for use in the laundering/treatment of fabrics. Generally, an effective amount of such compositions is added to water, for example in a conventional fabric automatic washing machine, to form such aqueous laundering solutions. The aqueous washing solution so formed is then contacted, typically under agitation, with the fabrics to be laundered/treated therewith. An effective amount of the liquid detergent compositions herein added to water to form aqueous laundering solutions can comprise amounts sufficient to form from about 500 to 7,000 ppm of composition in aqueous washing solution, or from about 1,000 to 3,000 ppm of the laundry care compositions herein will be provided in aqueous washing solution.

Typically, the wash liquor is formed by contacting the laundry care composition with wash water in such an amount so that the concentration of the laundry care composition in the wash liquor is from above Og/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l. The method of laundering fabric or textile may be carried out in a top-loading or front-loading automatic washing machine or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 liters or less of water, or 30 liters or less, or 20 liters or less, or 10 liters or less, or 8 liters or less, or even 6 liters or less of water. The wash liquor may comprise from above 0 to 15 liters, or from 2 liters, and to 12 liters, or even to 8 liters of water. Typically, from 0.01 kg to 2 kg of fabric per liter of wash liquor is dosed into said wash liquor. Typically, from 0.01 kg, or from 0.05 kg, or from 0.07 kg, or from 0.10 kg, or from 0.15 kg, or from 0.20 kg, or from 0.25 kg fabric per liter of wash liquor is dosed into said wash liquor. Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1. Typically the wash liquor comprising the laundry care composition of the invention has a pH of from 3 to 11.5.

In one aspect, such method comprises the steps of optionally washing and/or rinsing said surface or fabric, contacting said surface or fabric with any composition disclosed in this specification then optionally washing and/or rinsing said surface or fabric is disclosed, with an optional drying step.

Drying of such surfaces or fabrics may be accomplished by any one of the common means employed either in domestic or industrial settings. The fabric may comprise any fabric capable of being laundered in normal consumer or institutional use conditions, and the invention is suitable for cellulosic substrates and in some aspects also suitable for synthetic textiles such as polyester and nylon and for treatment of mixed fabrics and/or fibers comprising synthetic and cellulosic fabrics and/or fibers. As examples of synthetic fabrics are polyester, nylon, these may be present in mixtures with cellulosic fibers, for example, polycotton fabrics. The solution typically has a pH of from 7 to 11, more usually 8 to 10.5. The compositions are typically employed at concentrations from 500 ppm to 5,000 ppm in solution. The water temperatures typically range from about 5° C. to about 90° C. The water to fabric ratio is typically from about 1:1 to about 30:1. Another method includes contacting a nonwoven substrate, which is impregnated with the detergent composition, with a soiled material. As used herein, “nonwoven substrate” can comprise any conventionally fashioned nonwoven sheet or web having suitable basis weight, caliper (thickness), absorbency, and strength characteristics. Non-limiting examples of suitable commercially available nonwoven substrates include those marketed under the trade names SONTARA® by DuPont and POLY WEB® by James River Corp.

### Carbon Source of Raw Materials.

The raw materials for preparation of the surfactant, polymers and other ingredients can be based on fossil carbon or renewable carbon. Renewable carbon is a carbon source that avoid the use of fossil carbon such as natural gas, coal, petroleum. Typically, renewable carbon is derived from the biomass, carbon capture, or chemical recycling.

Biomass is a renewable carbon source formed through photosynthesis in the presence of sunlight, or chemosynthesis process in the absence of sunlight. In some cases, polymers isolated from biomass can be used directly, or further derivatized to make performance polymers. For example, the use of polysaccharide (such as starch) and derivatized polysaccharide (such as cellulose derivatives, guar derivatives, dextran derivatives) in fabric home care composition are known. In some cases, biomass can be converted into basic chemicals under certain thermal, chemical, or biological conditions. For example, bioethanol can be derived from biomass such as straw, and further convert to biobased polyethylene glycol. Other nonlimiting examples of renewable carbon from biomass include plants (e.g., sugar cane, beets, corn, potatoes, citrus fruit, woody plants, lignocellulosics, hemicellulosics, cellulosic waste), animals, animal fats, fish, bacteria, fungi, plant-based oils, and forestry products. These resources can be naturally occurring, hybrids, or genetically engineered organisms.

Carbon capture is another renewable carbon source which use various process to capture CO₂ or methane from industrial or natural processes, or directly from air (direct capture). Captured methane and CO₂ maybe converted into syngas, and/or further convert to basic chemicals, including but not limit to methanol, ethanol, fatty alcohols such as C₁₂/C₁₄ or even C₁₆/C₁₈ alcohols, other alcohols, olefins, alkanes, saturated and unsaturated organic acids, etc. These basic chemicals can used as or further convert to monomers for making transformed to usable chemicals by e.g. catalytic processes, such as the Fischer-Tropsch process or by fermentation by C₁-fixing microorganisms.

Chemical recycling is another renewable carbon source which allow plastics from waste management industry to be recycled and converted into base chemicals and chemical feedstocks. In some cases, waste plastics which cannot be re-used or mechanical recycled are convert to hydrocarbons or basic petrochemicals through gasification, pyrolysis or hydrothermal treatment processes, the hydrocarbons and basic petrochemicals can be further convert into monomers for polymers. In some cases, waste plastics are depolymerized into monomers to make new polymers. It is also possible that waste plastics are depolymerized into oligomers, the oligomers can be used as building blocks to make new polymers. The waste plastic converted by various processes to a waste plastic feedstock for the above materials may either be used alone or in combination with traditional surfactant feedstocks, such as kerosene, polyolefins derived from natural gas, coal, crude oil or even biomass, or waste fat/oil-derived paraffin and olefin, to produce biodegradable surfactants for use in detergents and other industries (thereby providing a benefit to society).

Preferably, the surfactant, polymers and other ingredients contains renewable carbon, the Renewable Carbon Index (RCI, a measure of sustainability by dividing the number of carbons derived from renewable sources by the total number of carbons in an active ingredient) of the polymer is above 10%, more preferably above 30%, more preferably above 50%, more preferably above 60%, more preferably between 70% to 100%, and most preferably 100%.

### EXAMPLES

The examples below are intended to illustrate the invention in detail without, however, limiting it thereto. Unless explicitly stated otherwise, all percentages given are percentages by weight (% by wt. or wt.-%).

The following backbone are prepared for inventive graft polymers.

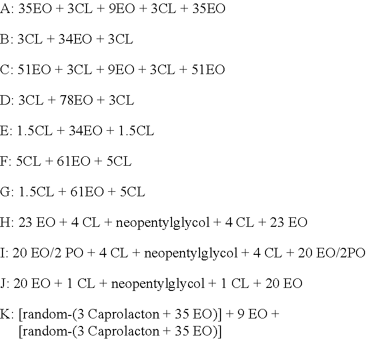

### General Synthesis of Backbones A, C, H, I, and J (Table 5):

Caprolactone is oligomerized before alkylene oxide polymerization yielding mixed random/block structures, and backbones are obtained by alkoxylation of polycaprolactones. Such polycaprolactones are accessible by polymerization of caprolactone onto starters with 2 hydroxy groups such as diols like ethylene glycol, polyethylene glycol, propylene glycol, polypropylene glycol, ethylene oxide and propylene oxide block copolymers, 1,3-propylene diol, 1,4-butane diol, 1,6-hexane diol, neopentyl glycol, etc.

Polymerization of caprolactone is carried out with various catalysts like transesterification catalysts tin(II)alkanoates.

The alkoxylation of such polycaprolactones is done under typical alkoxylation conditions. Due to basic reaction conditions for the alkoxylation, transesterification reaction at ester bonds from polycaprolactone can occur and mixed random/block structures are obtained

TABLE 5

| | | | Molecular |
|---|---|---|---|
| | | | weight * |
| Backbone | Example | | (g/mol) |
| A | 1, 2 | Pluriol E 400 + 3 Caprolacton/OH + 35 EO/OH | 4168 |
| | | (polyethylene glycol (molecular weight 400 g/mol), | |
| | | modified with 6 moles caprolactone and | |
| | | ethoxylated with 70 moles ethylene oxide) | |
| C | 3, 4 | Pluriol E 400 + 3 Caprolacton/OH + 51.1 EO/OH | 5590 |
| | | (polyethylene glycol (molecular weight 400 g/mol), | |
| | | modified with 6 moles caprolactone and | |
| | | ethoxylated with 102.2 moles ethylene oxide) | |
| H | 12 | NPG + 4 Caprolacton/OH + 23 EO/OH | 3040 |
| | | (Neopentylglycol, modified with 8 moles | |
| | | caprolactone and ethoxylated with 46 moles | |
| | | ethylene oxide) | |
| I | 13, 14, 15, 16, | NPG + 4 Caprolacton/OH (=Capromer PD1-10) + | 3009 |
| | 22, 23 | 20 EO/OH & 2 PO/OH | |
| | | (Neopentylglycol, modified with 8 moles | |
| | | caprolactone and alkoxylated with a mixture 40 | |
| | | moles ethylene oxide and 4 moles propylene oxide) | |
| J | 17 | (NPG + 1 Caprolacton/OH) + 20 EO/OH | 2092 |
| | | (Neopentylglycol, modified with 2 moles | |
| | | caprolactone and ethoxylated with 40 moles | |
| | | ethylene oxide) | |

* The molecular weights given are calculated weights, based on the total molar amounts of ingredients employed for the preparation reaction. As those reactions proceed basically to completeness, this is an acceptable way of calculation the molecular weights

### General Synthesis of Backbones B, D, E, F and G (Table 6):

Caprolactone is added after alkylene oxide polymerization yielding block structures polycaprolactone-polyalkylene oxide-polycaprolactone

Triblock copolymers from caprolactone and alkylene oxides with a middle polyalkylene oxide block are synthesized by 1. formation of a polyalkoxylate from a diol or water by reaction with alkylene oxides, and 2. polymerization of caprolactone onto the polyalkoxylate. Both reactions can be carried out under typical reaction conditions for alkoxylation reactions (polyalkoxylate) and for caprolactone polymerization (polycaprolactone block).

TABLE 6

| | | | Molecular |
|---|---|---|---|
| | | | Weight * |
| Backbone | Example | | (g/mol) |
| D | 5, 6 | Pluriol E 1500 + 22 EO/OH + 3 Caprolacton/OH | 4165 |
| | | (polyethylene glycol (molecular weight 1500 g/mol), | |
| | | ethoxylated with 44 moles ethylene oxide and | |
| | | modified with 6 moles caprolactone) | |
| E | 7 | Pluriol E 1500 + 1.5 Caprolacton/OH | 1842 |
| | | (polyethylene glycol (molecular weight 1500 g/mol), | |
| | | modified with 3 moles caprolactone) | |
| F | 8 | (Pluriol E 600 + 23.6 EO/OH) + 5 Caprolacton/OH | 3842 |
| | | (polyethylene glycol (molecular weight 600 g/mol), | |
| | | ethoxylated with 47.2 moles ethylene oxide and | |
| | | modified with 10 moles caprolactone) | |
| G | 10, 11 | (Pluriol E 600 + 23.6 EO/OH) + 1.5 | 3000 |
| | | Caprolacton/OH(polyethylene glycol (molecular | |
| | | weight 600 g/mol), ethoxylated with 47.2 moles | |
| | | ethylene oxide and modified with 3 moles | |
| | | caprolactone) | |

* The molecular weights given are calculated weights, based on the total molar amounts of ingredients employed for the preparation reaction. As those reactions proceed basically to completeness, this is an acceptable way of calculation the molecular weights

### General Synthesis Concept of Backbone K:

Suitable starters are reacted with a premixed combination of alkylene oxides and caprolactone.

| | | | Molecular |
|---|---|---|---|
| | | | Weight * |
| Backbone | Example | Backbone Description | (g/mol) |
| K | 19, 20 | Pluriol E 400 + 3 Caprolacton/ | 4241 |
| | | OH + 35 EO/OH random | |
| | | (polyethylene glycol | |
| | | (molecular weight 400 g/mol), | |
| | | modified with 6 moles caprolactone | |
| | | and 70 moles ethylene oxide) | |

* The molecular weight given are calculated weights, based on the total molar amounts of ingredients employed for the preparation reaction. As those reactions proceed basically to completeness, this is an acceptable way of calculation the molecular weights

### Synthesis of Inventive Graft Polymer 1-21:

The following Inventive graft polymers 1-21 (Table 7) are synthesized based on backbone A-K.

TABLE 7

| | Backbone | | | | |
|---|---|---|---|---|---|
| | | Molecular weight | | Graft | |
| Polymer | Type | (g/mol) | Wt % | Type | Wt % |
| Inv. 1 | A | 4168 | 65 | VAc | 35 |
| Inv. 2 | A | 4168 | 50 | VAc | 50 |
| Inv. 3 | C | 5590 | 65 | VAc | 35 |
| Inv. 4 | C | 5590 | 40 | VAc | 60 |
| Inv. 5 | D | 4165 | 65 | VAc | 35 |
| Inv. 6 | D | 4165 | 70 | VAc/VL | 25/5 |
| Inv. 7 | E | 1842 | 80 | VAc | 20 |
| Inv. 8 | F | 3842 | 50 | VAc/VP | 30/20 |
| Inv. 9 | F | 3842 | 50 | VAc | 50 |
| Inv. 10 | G | 3000 | 50 | VAc | 50 |
| Inv. 11 | G | 3000 | 65 | VAc/VP | 20/15 |
| Inv. 12 | H | 3040 | 60 | VAc | 40 |
| Inv. 13 | I | 3009 | 65 | VAc | 35 |
| Inv. 14 | I | 3009 | 65 | VAc/VP | 30/5 |
| Inv. 15 | I | 3009 | 65 | VAc/VP | 25/10 |
| Inv. 16 | I | 3009 | 65 | VAc/VP | 20/15 |
| Inv. 17 | J | 2092 | 65 | VAc/VL | 25/10 |
| Inv. 18 | F | 3842 | 50 | VAc**/VP | 30/20 |
| Inv. 19 | B | 2178 | 65 | VAc | 35 |
| Inv. 20 | K | 4241 | 35 | VAc | 65 |
| Inv. 21 | K | 4241 | 65 | VAc | 35 |

Note:
VAc = Vinyl acetate;
VL = Vinyl laurate;
VP = Vinyl pyrrolidone;
*The molecular weights given are calculated weights, based on the total molar amounts of ingredients employed for the preparation reaction. As those reactions proceed basically to completeness, this is an acceptable way of calculation the molecular weights.
**partially hydrolyzed: 40 mol % hydrolysis based on the total amount of VAc.

Additional illustrative graft polymer examples Inv. 22 and 23 are listed below:

| | Backbone | | | | |
|---|---|---|---|---|---|
| | | Molecular weight * | | Graft | |
| Polymer | Type | (g/mol) | Wt % | Type | Wt % |
| Inv. 22 | I | 3009 | 65 | VAc/VP | 10/20 |
| Inv. 23 | I | 3009 | 55 | VAc/VP | 25/20 |

* The molecular weights given are calculated weights, based on the total molar amounts of ingredients employed for the preparation reaction. As those reactions proceed basically to completeness, this is an acceptable way of calculation the molecular weights.

### Example 1 (Inv. 1)

### Example 1 a: Polyethylene Glycol (Molecular Weight 400 g/mol), Modified with 6 Moles Caprolactone

In a 4-neck vessel with thermometer, reflux condenser, nitrogen inlet, dropping funnel, and stirrer, 240.0 g polyethylene glycol (molecular weight 400 g/mol) and 0.75 g tin(II)ethylhexanoate were placed and heated to 100° C.

415.0 g epsilon-caprolactone was added within 15 minutes. The reaction mixture was heated to 160° C. and stirred for 14 hours at 160° C. under nitrogen. After cooling to room temperature, 645.0 g of an orange oil was obtained. ¹H-NMR in MeOD indicated 99.5% conversion of caprolactone.

### Example 1 b (Backbone A): Polyethylene Glycol (Molecular Weight 400 g/mol), Modified with 6 Moles Caprolactone and Ethoxylated with 70 Moles Ethylene Oxide

In a 21 autoclave 271.2 g polyethylene glycol (molecular weight 400 g/mol), modified with 6 moles caprolactone (example 1a) and 2.1 g potassium tert. butoxide were placed and the mixture was heated to 80° C. The vessel was purged three times with nitrogen and the mixture was heated to 140° C. 770.9 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. After filtration 1041.0 g of a light brown solid was obtained. 1H-NMR in CDCl3 confirmed the expected structure.

### Example 1 c (Graft Polymer)

A polymerization vessel equipped with stirrer and reflux condenser was initially charged with Backbone A (455.00 g) under nitrogen atmosphere and heated to 90° C. Feed 1 (2.81 g of tert-Butyl peroxy-2-ethylhexanoate dissolved in 24.76 g of tripropylene glycol) and 10 min upon the start of Feed 1, Feed 2 (245.00 g of vinyl acetate) were started and dosed to the stirred vessel with a variable feed rate of Feed 1 (0:00 h to 00:10 h: 9.20 g/h and 00:10 h to 06:10 h: 4.34 g/h) and a constant feed rate of Feed 2 (00:10 h to 06:10 h: 40.8 g/h). Upon completion of Feed 1 and Feed 2, Feed 3 (1.79 g of tert-Butyl peroxy-2-ethylhexanoate dissolved in 15.72 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 745 g of a polymer solution.

### Example 2 (Inv. 2)

A polymerization vessel equipped with stirrer and reflux condenser was initially charged with Backbone A (450.00 g) under nitrogen atmosphere and heated to 90° C. Feed 1 (10.08 g of tert-Butyl peroxy-2-ethylhexanoate dissolved in 36.89 g of tripropylene glycol) and 10 min upon the start of Feed 1, Feed 2 (450.50 g of vinyl acetate) were started and dosed to the stirred vessel with a variable feed rate of Feed 1 (0:00 h to 00:10 h: 15.7 g/h and 00:10 h to 06:10 h: 7.39 g/h) and a constant feed rate of Feed 2 (00:10 h to 06:10 h: 75.0 g/h). Upon completion of Feed 1 and Feed 2, Feed 3 (3.19 g of tert-Butyl peroxy-2-ethylhexanoate dissolved in 11.66 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 961 g of a polymer solution.

### Example 3 (Inv. 3)

### Example 3 a (Backbone C): Polyethylene Glycol (Molecular Weight 400 g/mol), Modified with 6 Moles Caprolactone and Ethoxylated with 102.2 Moles Ethylene Oxide

In a 21 autoclave 192.9 g polyethylene glycol (molecular weight 400 g/mol), modified with 6 moles caprolactone (example 1a) and 2.0 g potassium tert. butoxide were placed and the mixture was heated to 80° C. The vessel was purged three times with nitrogen and the mixture was heated to 140° C. 801.8 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. After filtration 990.0 g of a light brown solid was obtained. 1H-NMR in CDCl3 confirmed the expected structure.

### Example 3 b (Graft Polymer)

A polymerization vessel equipped with stirrer and reflux condenser was initially charged with Backbone C (455.00 g) under nitrogen atmosphere and heated to 90° C. Feed 1 (2.81 g of tert-Butyl peroxy-2-ethylhexanoate dissolved in 24.76 g of tripropylene glycol) and 10 min upon the start of Feed 1, Feed 2 (245.00 g of vinyl acetate) were started and dosed to the stirred vessel with a variable feed rate of Feed 1 (0:00 h to 00:10 h: 9.20 g/h and 00:10 h to 06:10 h: 4.34 g/h) and a constant feed rate of Feed 2 (00:10 h to 06:10 h: 40.8 g/h). Upon completion of Feed 1 and Feed 2, Feed 3 (1.79 g of tert-Butyl peroxy-2-ethylhexanoate dissolved in 15.72 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 745 g of a polymer solution.

### Example 4 (Inv. 4)

A polymerization vessel equipped with stirrer and reflux condenser was initially charged with Backbone C (400.00 g) under nitrogen atmosphere and heated to 90° C. Feed 1 (7.24 g of tert-Butyl peroxy-2-ethylhexanoate dissolved in 31.90 g of tripropylene glycol) and 10 min upon the start of Feed 1, Feed 2 (600.00 g of vinyl acetate) were started and dosed to the stirred vessel with a variable feed rate of Feed 1 (0:00 h to 00:10 h: 13.1 g/h and 00:10 h to 06:10 h: 5.13 g/h) and a constant feed rate of Feed 2 (00:10 h to 06:10 h: 83.4 g/h). Upon completion of Feed 1 and Feed 2, Feed 3 (4.80 g of tert-Butyl peroxy-2-ethylhexanoate dissolved in 21.12 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 1065 g of a polymer solution.

### Example 5 (Inv. 5)

### Example 5 a: Polyethylene Glycol (Molecular Weight 1500 g/mol), Ethoxylated with 44 Moles Ethylene Oxide

In a 2 l autoclave 599.9 g polyethylene glycol (molecular weight 1500 g/mol) and 2.7 g potassium tert. butoxide were placed and the mixture was heated to 80° C. The vessel was purged three times with nitrogen and the mixture was heated to 140° C. 754.2 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. After filtration 1350.0 g of a light brown solid was obtained. 1H-NMR in CDCl3 confirmed the expected structure.

### Example 5 b (Backbone D): Polyethylene Glycol (Molecular Weight 1500 g/mol), Ethoxylated with 44 Moles Ethylene Oxide and Modified with 6 Moles Caprolactone

In a 4-neck vessel with thermometer, reflux condenser, nitrogen inlet, dropping funnel, and stirrer, 1044.1 g polyethylene glycol (molecular weight 1500 g/mol), ethoxylated with 44 moles ethylene oxide (example 5a) and 1.25 g tin(II)ethylhexanoate were placed and heated to 90° C. 205.5 g epsilon-caprolactone was added within 15 minutes. The reaction mixture was heated to 160° C. and stirred for 10 hours at 160° C. under nitrogen. After cooling to room temperature, 1236.0 g of an orange oil was obtained. ¹H-NMR in CDCl3 indicated 98.8% conversion of caprolactone.

### Example 5 c (Graft Polymer)

A polymerization vessel equipped with stirrer and reflux condenser was initially charged with Backbone D (455.00 g) under nitrogen atmosphere and heated to 90° C. Feed 1 (2.81 g of tert-Butyl peroxy-2-ethylhexanoate dissolved in 24.76 g of tripropylene glycol) and 10 min upon the start of Feed 1, Feed 2 (245.00 g of vinyl acetate) were started and dosed to the stirred vessel with a variable feed rate of Feed 1 (0:00 h to 00:10 h: 9.20 g/h and 00:10 h to 06:10 h: 4.34 g/h) and a constant feed rate of Feed 2 (00:10 h to 06:10 h: 40.8 g/h). Upon completion of Feed 1 and Feed 2, Feed 3 (1.79 g of tert-Butyl peroxy-2-ethylhexanoate dissolved in 15.72 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 745 g of a polymer solution.

### Example 6 (Inv. 6)

A polymerization vessel equipped with stirrer and reflux condenser was initially charged with Backbone D (679.00 g) under nitrogen atmosphere and heated to 90° C. Feed 1 (10.87 g of tert-Butyl peroxy-2-ethylhexanoate dissolved in 39.76 g of tripropylene glycol) and 10 min upon the start of Feed 1, Feed 2 (a mixture of 242.50 g of vinyl acetate and 48.50 g of vinyl laurate) were started and dosed to the stirred vessel with a variable feed rate of Feed 1 (0:00 h to 00:10 h: 16.9 g/h and 00:10 h to 06:10 h: 7.97 g/h) and a constant feed rate of Feed 2 (00:10 h to 06:10 h: 48.5 g/h). Upon completion of Feed 1 and Feed 2, Feed 3 (3.43 g of tert-Butyl peroxy-2-ethylhexanoate dissolved in 12.56 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 1036 g of a polymer solution.

### Example 7 (Inv. 7)

### Example 7 a (Backbone E): Polyethylene Glycol (Molecular Weight 1500 g/mol), Modified with 3 Moles Caprolactone

In a 4-neck vessel with thermometer, reflux condenser, nitrogen inlet, dropping funnel, and stirrer, 480.0 g polyethylene glycol (molecular weight 1500 g/mol), and 0.6 g tin(II)ethylhexanoate were placed and heated to 80° C.

109.6 g epsilon-caprolactone was added within 5 minutes. The reaction mixture was heated to 160° C. and stirred for 10 hours at 160° C. under nitrogen. After cooling to room temperature, 580.0 g of an orange oil was obtained. ¹H-NMR in CDCl3 indicated 96.7% conversion of caprolactone

### Example 7 b (Graft Polymer)

A polymerization vessel equipped with stirrer and reflux condenser was initially charged with Backbone E (540.00 g) under nitrogen atmosphere and heated to 90° C. Feed 1 (7.56 g of tert-Butyl peroxy-2-ethylhexanoate dissolved in 27.67 g of tripropylene glycol) and 10 min upon the start of Feed 1, Feed 2 (135.00 g of vinyl acetate) were started and dosed to the stirred vessel with a variable feed rate of Feed 1 (0:00 h to 00:10 h: 11.8 g/h and 00:10 h to 06:10 h: 5.55 g/h) and a constant feed rate of Feed 2 (00:10 h to 06:10 h: 22.5 g/h). Upon completion of Feed 1 and Feed 2, Feed 3 (2.39 g of tert-Butyl peroxy-2-ethylhexanoate dissolved in 8.74 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 721 g of a polymer solution.

### Example 8 (Inv. 8)

### Example 8 a: Polyethylene Glycol (Molecular Weight 600 g/mol), Ethoxylated with 47.2 Moles Ethylene Oxide

In a 2 l autoclave 222.5 g polyethylene glycol (molecular weight 600 g/mol) and 2.0 g potassium tert. butoxide were placed and the mixture was heated to 80° C. The vessel was purged three times with nitrogen and the mixture was heated to 130° C. 770.0 g ethylene oxide was added within 10 hours. To complete the reaction, the mixture was allowed to post-react for additional 5 hours at 140° C. The reaction mixture was stripped with nitrogen and volatile compounds were removed in vacuo at 80° C. After filtration 990.0 g of a light brown solid was obtained (hydroxy value. 45.8 mgKOH/g).

### Example 8 b (Backbone F): Polyethylene Glycol (Molecular Weight 600 g/mol), Ethoxylated with 47.2 Moles Ethylene Oxide and Modified with 10 Moles Caprolactone

In a 4-neck vessel with thermometer, reflux condenser, nitrogen inlet, dropping funnel, and stirrer, 617.9 g polyethylene glycol (molecular weight 600 g/mol), ethoxylated with 47.2 moles ethylene oxide (example 8a) and 0.9 g tin(II)ethylhexanoate were placed and heated to 80° C. 288.8 g epsilon-caprolactone was added within 15 minutes. The reaction mixture was heated to 160° C. and stirred for 12 hours at 160° C. under nitrogen. After cooling to room temperature, 900.0 g of an orange oil was obtained. ¹H-NMR in CDCl3 indicated 99.0% conversion of caprolactone.

### Example 8 c (Graft Polymer)

A polymerization vessel equipped with stirrer and reflux condenser was initially charged with Backbone F (397.29 g) under nitrogen atmosphere and heated to 90° C. Feed 1 (3.16 g of tert-Butyl peroxy-2-ethylhexanoate dissolved in 35.56 g of propane-1,2-diol) and 10 min upon the start of Feed 1, Feed 2 (238.37 g of vinyl acetate) and Feed 3 (158.92 g of N-Vinylpyrrolidone) were started simultaneously and dosed to the stirred vessel with a variable feed rate of Feed 1 (0:00 h to 00:10 h: 12.9 g/h and 00:10 h to 06:10 h: 6.09 g/h) and a constant feed rate of Feed 2 (00:10 h to 06:10 h: 39.7 g/h) and Feed 3 (00:10 h to 06:10 h: 26.5 g/h). Upon completion of Feed 1, Feed 2 and Feed 3, Feed 4 (2.03 g of tert-Butyl peroxy-2-ethylhexanoate dissolved in 22.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 721 g of a polymer solution.

### Example 9 (Inv. 9)

A polymerization vessel equipped with stirrer and reflux condenser was initially charged with Backbone F (50.00 g) under nitrogen atmosphere and heated to 90° C. Feed 1 (1.12 g of tert-Butyl peroxy-2-ethylhexanoate dissolved in 4.10 g of tripropylene glycol) and 10 min upon the start of Feed 1, Feed 2 (50.00 g of vinyl acetate) were started and dosed to the stirred vessel with a variable feed rate of Feed 1 (0:00 h to 00:10 h: 1.74 g/h and 00:10 h to 06:10 h: 0.82 g/h) and a constant feed rate of Feed 2 (00:10 h to 06:10 h: 8.33 g/h). Upon completion of Feed 1 and Feed 2, Feed 3 (0.35 g of tert-Butyl peroxy-2-ethylhexanoate dissolved in 1.30 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 107 g of a polymer solution

### Example 10 (Inv. 10)

### Example 10 a

polyethylene glycol (molecular weight 600 g/mol), ethoxylated with 47.2 moles ethylene oxide and modified with 3 moles caprolactone) (Backbone G) In a 4-neck vessel with thermometer, reflux condenser, nitrogen inlet, dropping funnel, and stirrer, 669.8 g polyethylene glycol (molecular weight 600 g/mol), ethoxylated with 47.2 moles ethylene oxide (example 8a) and 0.8 g tin(II)ethylhexanoate were placed and heated to 80° C.

85.6 g epsilon-caprolactone was added within 15 minutes. The reaction mixture was heated to 160° C. and stirred for 12 hours at 160° C. under nitrogen. After cooling to room temperature, 746.0 g of an orange solid was obtained. ¹H-NMR in CDCl3 indicated 98.0% conversion of caprolactone.

### Example 10 b (Graft Polymer)

A polymerization vessel equipped with stirrer and reflux condenser was initially charged with Backbone G (75.00 g) under nitrogen atmosphere and heated to 90° C. Feed 1 (1.68 g of tert-Butyl peroxy-2-ethylhexanoate dissolved in 6.15 g of tripropylene glycol) and 10 min upon the start of Feed 1, Feed 2 (75.00 g of vinyl acetate) were started and dosed to the stirred vessel with a variable feed rate of Feed 1 (0:00 h to 00:10 h: 2.61 g/h and 00:10 h to 06:10 h: 1.23 g/h) and a constant feed rate of Feed 2 (00:10 h to 06:10 h: 12.50 g/h). Upon completion of Feed 1 and Feed 2, Feed 3 (0.53 g of tert-Butyl peroxy-2-ethylhexanoate dissolved in 1.94 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 160 g of a polymer solution

### Example 11 (Inv. 11)

A polymerization vessel equipped with stirrer and reflux condenser was initially charged with Backbone G (97.50 g) under nitrogen atmosphere and heated to 90° C. Feed 1 (0.60 g of tert-Butyl peroxy-2-ethylhexanoate dissolved in 6.92 g of propane-1,2-diol) and 10 min upon the start of Feed 1, Feed 2 (30.00 g of vinyl acetate) and Feed 3 (22.50 g of N-Vinylpyrrolidone) were started simultaneously and dosed to the stirred vessel with a variable feed rate of Feed 1 (0:00 h to 00:10 h: 2.51 g/h and 00:10 h to 06:10 h: 3.75 g/h) and a constant feed rate of Feed 2 (00:10 h to 06:10 h: 5.00 g/h) and Feed 3 (00:10 h to 06:10 h: 3.75 g/h). Upon completion of Feed 1, Feed 2 and Feed 3, Feed 4 (0.38 g of tert-Butyl peroxy-2-ethylhexanoate dissolved in 4.44 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 162 g of polymer a solution.

### Example 12 (Inv. 12)

### Example 12 a: Neopentylglycol, Modified with 8 Moles Caprolactone

In a 4-neck vessel with thermometer, reflux condenser, nitrogen inlet, dropping funnel, and stirrer, 104.1 g neopentyl glycol and 1.0 g tin(II)ethylhexanoate were placed and heated to 140° C. 913.0 g epsilon-caprolactone was added within 15 minutes. The reaction mixture was heated to 160° C. to 205° C. and stirred for 4 hours at 160° C. under nitrogen. After cooling to room temperature, 971.0 g of an light yellow oil was obtained. ¹H-NMR in CDCl3 indicated 99.0% conversion of caprolactone.

### Example 12 b: Neopentylglycol, Modified with 8 Moles Caprolactone and Ethoxylated with 46 Moles Ethylene Oxide) (Backbone H)

In a 2 l autoclave 356.1 g neopentylglycol, modified with 8 moles caprolactone (example 12 a) and 2.01 g potassium tert. butoxide were placed and the mixture was heated to 80° C. The vessel was purged three times with nitrogen and the mixture was heated to 140° C. 709.2 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. 1.1 g acetic acid was added. After filtration 1060.0 g of a light brown solid was obtained. 1H-NMR in CDCl3 confirmed the expected structure.

### Example 12 c (Graft Polymer)

A polymerization vessel equipped with stirrer and reflux condenser was initially charged with Backbone H (79.80 g) under nitrogen atmosphere and heated to 90° C. Feed 1 (1.49 g of tert-Butyl peroxy-2-ethylhexanoate dissolved in 13.17 g of tripropylene glycol) and 10 min upon the start of Feed 1, Feed 2 (53.20 g of vinyl acetate) were started and dosed to the stirred vessel with a variable feed rate of Feed 1 (0:00 h to 00:10 h: 4.89 g/h and 00:10 h to 06:10 h: 0.23 g/h) and a constant feed rate of Feed 2 (00:10 h to 06:10 h: 8.87 g/h). Upon completion of Feed 1 and Feed 2, Feed 3 (0.34 g of tert-Butyl peroxy-2-ethylhexanoate dissolved in 2.99 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 150 g of a polymer solution

### Example 13 (Inv. 13)

### Example 13 a: Neopentylglycol, Modified with 8 Moles Caprolactone and Alkoxylated with a Mixture of 40 Moles Ethylene Oxide and 4 Moles Propylene Oxide (Backbone I)

In a 2 l autoclave 300.0 g neopentylglycol, modified with 8 moles caprolactone (example 12 a) and 1.8 g potassium tert. butoxide were placed and the mixture was heated to 80° C. The vessel was purged three times with nitrogen and the mixture was heated to 140° C. A mixture of 519.6 g ethylene oxide and 68.5 g propylene oxide was added within 14 hours. To complete the reaction, the mixture was allowed to post-react for additional 5 hours at 140° C. The reaction mixture was stripped with nitrogen and volatile compounds were removed in vacuo at 80° C. 0.9 g acetic acid was added. After filtration 880.0 g of a light brown oil was obtained. 1H-NMR in CDCl3 confirmed the expected structure.

### Example 13 b (Graft Polymer)

A polymerization vessel equipped with stirrer and reflux condenser was initially charged with Backbone I (78.00 g) under nitrogen atmosphere and heated to 90° C. Feed 1 (1.35 g of tert-Butyl peroxy-2-ethylhexanoate dissolved in 11.88 g of tripropylene glycol) and 10 min upon the start of Feed 1, Feed 2 (42.00 g of vinyl acetate) were started and dosed to the stirred vessel with a variable feed rate of Feed 1 (0:00 h to 00:10 h: 4.41 g/h and 00:10 h to 06:10 h: 0.23 g/h) and a constant feed rate of Feed 2 (00:10 h to 06:10 h: 7.09 g/h). Upon completion of Feed 1 and Feed 2, Feed 3 (0.31 g of tert-Butyl peroxy-2-ethylhexanoate dissolved in 2.70 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 136 g of a polymer solution

### Example 14 (Inv. 14)

A polymerization vessel equipped with stirrer and reflux condenser was initially charged with Backbone I (97.50 g) under nitrogen atmosphere and heated to 90° C. Feed 1 (1.22 g of tert-Butyl peroxy-2-ethylhexanoate dissolved in 12.33 g of propane-1,2-diol) and 10 min upon the start of Feed 1, Feed 2 (45.00 g of vinyl acetate) and Feed 3 (7.50 g of N-Vinylpyrrolidone) were started simultaneously and dosed to the stirred vessel with a variable feed rate of Feed 1 (0:00 h to 00:10 h: 4.49 g/h and 00:10 h to 06:10 h: 1.25 g/h) and a constant feed rate of Feed 2 (00:10 h to 06:10 h: 7.50 g/h) and Feed 3 (00:10 h to 06:10 h: 1.25 g/h). Upon completion of Feed 1, Feed 2 and Feed 3, Feed 4 (0.38 g of tert-Butyl peroxy-2-ethylhexanoate dissolved in 3.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 165 g of a polymer solution.

### Example 15 (Inv. 15)

A polymerization vessel equipped with stirrer and reflux condenser was initially charged with Backbone I(97.50 g) under nitrogen atmosphere and heated to 90° C. Feed 1 (1.22 g of tert-Butyl peroxy-2-ethylhexanoate dissolved in 12.33 g of propane-1,2-diol) and 10 min upon the start of Feed 1, Feed 2 (37.50 g of vinyl acetate) and Feed 3 (15.00 g of N-Vinylpyrrolidone) were started simultaneously and dosed to the stirred vessel with a variable feed rate of Feed 1 (0:00 h to 00:10 h: 4.49 g/h and 00:10 h to 06:10 h: 2.12 g/h) and a constant feed rate of Feed 2 (00:10 h to 06:10 h: 6.25 g/h) and Feed 3 (00:10 h to 06:10 h: 2.50 g/h). Upon completion of Feed 1, Feed 2 and Feed 3, Feed 4 (0.38 g of tert-Butyl peroxy-2-ethylhexanoate dissolved in 3.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 167 g of a polymer solution.

### Example 16 (Inv. 16)

A polymerization vessel equipped with stirrer and reflux condenser was initially charged with Backbone I (97.50 g) under nitrogen atmosphere and heated to 90° C. Feed 1 (1.22 g of tert-Butyl peroxy-2-ethylhexanoate dissolved in 12.33 g of propane-1,2-diol) and 10 min upon the start of Feed 1, Feed 2 (30.00 g of vinyl acetate) and Feed 3 (22.50 g of N-Vinylpyrrolidone) were started simultaneously and dosed to the stirred vessel with a variable feed rate of Feed 1 (0:00 h to 00:10 h: 4.49 g/h and 00:10 h to 06:10 h: 2.12 g/h) and a constant feed rate of Feed 2 (00:10 h to 06:10 h: 5.00 g/h) and Feed 3 (00:10 h to 06:10 h: 3.75 g/h). Upon completion of Feed 1, Feed 2 and Feed 3, Feed 4 (0.38 g of tert-Butyl peroxy-2-ethylhexanoate dissolved in 3.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 165 g of a polymer solution.

### Example 17 (Inv. 17)

### Example 17 a: Neopentylglycol, Modified with 2 Moles Caprolactone

In a 4-neck vessel with thermometer, reflux condenser, nitrogen inlet, dropping funnel, and stirrer, 156.2 g neopentyl glycol and 0.5 g tin(II)ethylhexanoate were placed and heated to 140° C. 342.4 g epsilon-caprolactone was added within 15 minutes. The reaction mixture was heated to 160° C. and stirred for 2 hours at 160° C. under nitrogen. After cooling to room temperature, 477.0 g of alight yellow oil was obtained. ¹H-NMR in CDCl3 indicated 99.0% conversion of caprolactone.

### Example 17 b: Neopentylglycol, Modified with 2 Moles Caprolactone and Ethoxylated with 40 Moles Ethylene Oxide (Backbone J)

In a 2 l autoclave 149.6 g neopentylglycol, modified with 2 moles caprolactone (example 17 a) and 1.9 g potassium tert. butoxide were placed and the mixture was heated to 80° C. The vessel was purged three times with nitrogen and the mixture was heated to 140° C. 792.0 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. 1.0 g acetic acid was added. After filtration 940.0 g of a light brown oil was obtained. 1H-NMR in CDCl3 confirmed the expected structure.

### Example 17 c (Graft Polymer)

A polymerization vessel equipped with stirrer and reflux condenser was initially charged with Backbone J (97.50 g) under nitrogen atmosphere and heated to 90° C. Feed 1 (1.68 g of tert-Butyl peroxy-2-ethylhexanoate dissolved in 6.15 g of tripropylene glycol) and 10 min upon the start of Feed 1, Feed 2 (37.50 g of vinyl acetate) and Feed 3 (15.00 g of Vinyl laurate) were started simultaneously and dosed to the stirred vessel with a variable feed rate of Feed 1 (0:00 h to 00:10 h: 2.61 g/h and 00:10 h to 06:10 h: 1.23 g/h) and a constant feed rate of Feed 2 (00:10 h to 06:10 h: 6.25 g/h) and Feed 3 (00:10 h to 06:10 h: 2.50 g/h). Upon completion of Feed 1, Feed 2 and Feed 3, Feed 4 (0.54 g of tert-Butyl peroxy-2-ethylhexanoate dissolved in 1.96 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 159 g of a polymer solution.

### Example 18 (Inv. 18) (Hydrolysation)

A polymerization vessel equipped with stirrer and reflux condenser was initially charged with Example 8 c (110.00 g) under nitrogen atmosphere and heated to 80° C. Water (49.86 g) was added and Feed 1 (aqueous sodium hydroxide, 50%, 11.50 g) was started with a constant feed rate within 1:00 h. After the addition was completed, the mixture was stirred at 80° C. for 1 h to yield 250 g of a polymer solution.

### Example 19 (Inv. 19)

### Example 19 a: Polyethylene Glycol (Molecular Weight 1500 g/mol), Modified with 6 Moles Caprolactone (Backbone B)

In a 4-neck vessel with thermometer, reflux condenser, nitrogen inlet, dropping funnel, and stirrer, 750.0 g polyethylene glycol (molecular weight 1500 g/mol), and 1.1 g tin(II)ethylhexanoate were placed and heated to 90° C. 342.4 g epsilon-caprolactone was added within 15 minutes. The reaction mixture was heated to 155° C. and stirred for 11 hours at 155° C. under nitrogen. After cooling to room temperature, 1100.0 g of an orange oil was obtained. ¹H-NMR in CDCl3 indicated 97.5% conversion of caprolactone

### Example 19 b (Graft Polymer)

A polymerization vessel equipped with stirrer and reflux condenser was initially charged with Backbone B (480.0 g) under nitrogen atmosphere and heated to 90° C. Feed 1 (2.97 g of tert-Butyl peroxy-2-ethylhexanoate dissolved in 26.1 g of propane-1,2-diol) and 10 min upon the start of Feed 1, Feed 2 (258.5 g of vinyl acetate) were started simultaneously and dosed to the stirred vessel with a variable feed rate of Feed 1 (0:00 h to 00:10 h: 9.70 g/h and 00:10 h to 06:10 h: 4.58 g/h) and a constant feed rate of Feed 2 (00:10 h to 06:10 h: 43.08 g/h). Upon completion of Feed 1 and Feed 2, Feed 3 (1.88 g of tert-Butyl peroxy-2-ethylhexanoate dissolved in 16.6 g of propane-1,2-diol) was dosed within 0:56 h with constant feed rate at 90° C. The mixture was stirred for 1 h at 90° C. upon complete addition of the feed. The polymerization mixture was heated to 95° C. and a vacuum of 500 mbar was applied to remove the volatiles. The yield was 781 g of a polymer solution.

### Example 20 (Inv. 20)

### Example 20 a: Polyethylene Glycol (Molecular Weight 400 g/mol), Modified with 6 Moles Caprolactone and 70 Moles Ethylene Oxide (Backbone K)

In a 2 l autoclave 150 g polyethylene glycol (molecular weight 400 g/mol), and 2.7 g potassium tert. butoxide were placed and the mixture was heated to 80° C. The vessel was purged three times with nitrogen and the mixture was heated to 140° C. A mixture of 977.5 g ethylene oxide and 217.1 g caprolactone was added within 15 hours. To complete the reaction, the mixture was allowed to post-react for additional 5 hours at 140° C. The reaction mixture was stripped with nitrogen and volatile compounds were removed in vacuo at 80° C. After filtration 1340.0 g of a light brown solid was obtained. 1H-NMR in CDCl3 confirmed the expected structure.

### Example 20 b (Graft Polymer)

A polymerization vessel equipped with stirrer and reflux condenser was initially charged with Backbone K (350.0 g) under nitrogen atmosphere and heated to 90° C. Feed 1 (4.02 g of tert-Butyl peroxy-2-ethylhexanoate dissolved in 33.0 g of propane-1,2-diol) and 10 min upon the start of Feed 1, Feed 2 (650.0 g of vinyl acetate) were started simultaneously and dosed to the stirred vessel with a variable feed rate of Feed 1 (0:00 h to 00:10 h: 12.4 g/h and 00:10 h to 06:10 h: 5.83 g/h) and a constant feed rate of Feed 2 (00:10 h to 06:10 h: 108.3 g/h). Upon completion of Feed 1 and Feed 2, Feed 3 (2.55 g of tert-Butyl peroxy-2-ethylhexanoate dissolved in 21.0 g of propane-1,2-diol) was dosed within 0:56 h with constant feed rate at 90° C. The mixture was stirred for 1 h at 90° C. upon complete addition of the feed. The polymerization mixture was heated to 95° C. and a vacuum of 500 mbar was applied to remove the volatiles. The yield was 1059 g of a polymer solution.

### Example 21 (Inv. 21—Graft Polymer)

A polymerization vessel equipped with stirrer and reflux condenser was initially charged with Backbone K (550.0 g) under nitrogen atmosphere and heated to 90° C. Feed 1 (3.40 g of tert-Butyl peroxy-2-ethylhexanoate dissolved in 30.0 g of propane-1,2-diol) and 10 min upon the start of Feed 1, Feed 2 (296.2 g of vinyl acetate) were started simultaneously and dosed to the stirred vessel with a variable feed rate of Feed 1 (0:00 h to 00:10 h: 11.1 g/h and 00:10 h h to 06:10 h: 5.25 g/h) and a constant feed rate of Feed 2 (00:10 h to 06:10 h: 49.4 g/h). Upon completion of Feed 1 and Feed 2, Feed 3 (2.55 g of tert-Butyl peroxy-2-ethylhexanoate dissolved in 21.0 g of propane-1,2-diol) was dosed within 0:56 h with constant feed rate at 90° C. The mixture was stirred for 1 h at 90° C. upon complete addition of the feed. The polymerization mixture was heated to 95° C. and a vacuum of 500 mbar was applied to remove the volatiles. The yield was 899 g of a polymer solution.

### Synthesis of Comparative Graft Polymer 1 (Based on Un-Published Patent Application PCT/EP2022/065983):

Comparative graft polymer 1 based on PEG ester backbone was synthesized via the following steps.

### Step 1: Oxidation of PAG

Polyalkylene glycol (PAG) with two primary OH end groups (called “diol”) were oxidized to mixtures containing at least a polyalkylene oxide with two COOH end groups (called “diacid”) and a polyalkylene oxide with one primary OH and one COOH end group (called “monoacid”), and, optionally, also remaining polyalkylene oxide with two primary OH end groups. The mixtures were prepared as follows.

Platinum on charcoal (5.0 wt.-% Pt on C, water content: 59.7 wt.-%, 283 g, 29.2 mmol Pt) was suspended in a mixture of polyalkylene oxide comprising two primary OH end groups (details see Table 8) and water (details see Table 8), heated to 52° C. and stirred at 800 rpm. Oxygen was passed through the stirred mixture (20 nL/h) via a glass tube, equipped with a glass frit and the temperature was allowed to rise to 60° C. Oxygen dosage and temperature were maintained for the period mentioned in table 1, the oxygen dosage was then stopped and the mixture was allowed to cool down to room temperature. Solids were separated from the liquid phase by filtration and the filter cake was washed with 500 mL of warm water. The washing water was mixed with the filtrate. Water was removed from the liquid mixture by distillation over a wiped film evaporator (overall height: 87.2 cm, diameter: 3.54 cm, wiped height: 43 cm, feed: 4.0 mL/min, 44° C., 1.8 kPa abs, 600 rpm).

TABLE 8
Polymer backbone-- Oxidation of PEG

| Descriptor of oxidized PEG | A1 | A2 |
|---|---|---|
| Typ^{#1} and molecular average molecular | EO600 | EO600 |
| weight M_{w} [g/mol] of polyalkylene oxide | | |
| Number average of number of ether | 12 | 12 |
| groups | | |
| Amount of polyalkylene oxide [g] | 1500 | 1750 |
| Amount of water [g] | 3500 | 4083 |
| Oxidation time [h] | 72 | 8 |
| Ratio of oxidized OH groups [%]^{#2} | >99^{#2} | 51^{#2} |
| Acid number [mg KOH/g] | 55 | 28 |
| Physical property | solid | solid |

^{#1}EO = polyethylene oxide
^{#2}Calculated on basis of acid number of the reaction solution

### Step 2: Esterification

A mixture of oxidized polyalkylene oxides (see Table 9) obtained by the oxidation of the diol (see Table 8) and the esterification catalyst were mixed and heated for a period of time mentioned in Table 9 under vacuum at a pressure of 1 kPa abs at a temperature of 135° C.

TABLE 9
Esterification to PEG-Ester

| Polymer backbone descriptor | B1 |
|---|---|
| Educt | A1 (76.0 g) + A2 (1100 g) |
| Esterification catalyst ^{#1} | 0.83 wt.-% |
| | TIB Kat 620^{#2} |
| Reaction time [h] | 72 |
| K-value^{#2} | 20.2 |

^{#1} cat = Zn-octanoate
^{#2}K-value measures the relative viscosity of dilute polymer solutions and is a relative measure of the average molecular weight. As the average molecular weight of the polymer increases for a particular polymer, the K-value tends to also increase. The K-value is determined in a 3% by weight NaCl solution at 23° C. and a polymer concentration of 1% polymer according to the method of H. Fikentscher in “Cellulosechemie”, 1932, 13, 58.

### Step 3: Synthesis of Comparative Graft Polymer 1

The polymer backbone B1 (350.0 g) is dosed in a vessel equipped with a stainless-steel anchor stirrer (and 2 other necks) and heated to 95° C. 1.00 g of a 14 wt % solution of t-butylperoxy-2-ethylhexanoate in tripropylene glycol was added within 1 min. Afterwards, the dosage of vinylacetate (350.0 g) was started and continued over 7.5 h with constant feed rate. At the same time the Initiator solution (50.0 g) t-butylperoxy-2-ethylhexanoate was dosed as a 14 wt % solution in tripropylene glycol with a constant feed rate within 8.5 h. For completion of the reaction, the mixture is stirred for another 180 minutes. Finally, volatile components were stripped for 90 minutes at 120° C. with nitrogen at a feed rate of 6 L N₂/h.

### Synthesis Procedures for Comparative Polymers Comp Ex. 2-Comp Ex. 5

The procedure follows published process descriptions to produce polymers already known and used in the state of the art-documents.

### Comp. Ex. 2: Graft Polymerization of Vinyl Acetate (40 wt. %) on PEG (Mn 6000 g/mol; 60 wt. %)

A polymerization vessel equipped with stirrer and reflux condenser was initially charged with 660 g of PEG (Mn 6000 g/mol) under nitrogen atmosphere and melted at 90° C. Feed 1 containing 4.42 g of tert-butyl peroxy-2-ethylhexanoate, dissolved in 35.09 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (440 g of vinyl acetate) was started and dosed within 6:00 h at constant feed rate and 90° C. Upon completion of the Feeds 1 and 2, the temperature was increased to 95° C. and Feed 3 consisting of 2.81 g of tert-butyl peroxy-2-ethylhexanoate, dissolved in 23.21 g of 1,2-propanediol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar.

### Comp. Ex. 3: Graft Polymerization of Vinyl Acetate (30 wt. %) on PEG (Mn 6000 g/mol; 70 wt. %)

A polymerization vessel equipped with stirrer and reflux condenser was initially charged with 700 g of PEG (Mn 6000 g/mol) under nitrogen atmosphere and melted at 90° C. Feed 1 containing 12.24 g of tert-butyl peroxy-2-ethylhexanoate, dissolved in 50.30 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (300 g of vinyl acetate) was started and dosed within 6:00 h at constant feed rate and 90° C. Upon completion of the Feeds 1 and 2, the temperature was increased to 95° C. and Feed 3 consisting of 4.80 g of tert-butyl peroxy-2-ethylhexanoate, dissolved in 19.70 g of tripropylene glycol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar.

### Comp. Ex. 4: Graft Polymerization of Vinyl Acetate (40 wt. %) on PEG (Mn 4000 g/mol; 60 wt. %)

A polymerization vessel equipped with stirrer and reflux condenser was initially charged with 600 g of PEG (Mn 4000 g/mol) under nitrogen atmosphere and melted at 90° C. Feed 1 containing 3.57 g of tert-butyl peroxy-2-ethylhexanoate, dissolved in 29.90 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed within 6:00 h at constant feed rate and 90° C. Upon completion of the Feeds 1 and 2, the temperature was increased to 95° C. and Feed 3 consisting of 4.90 g of tert-butyl peroxy-2-ethylhexanoate, dissolved in 41.00 g of tripropylene glycol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar.

### Comp. Ex. 5: Graft Polymerization of Vinyl Acetate (60 wt. %) on PEG (Mn 6000 g/mol; 40 wt. %)

A polymerization vessel equipped with stirrer and reflux condenser was initially charged with 400 g of PEG (Mn 6000 g/mol) under nitrogen atmosphere and melted at 90° C. Feed 1 containing 4.8 g of tert-butyl peroxy-2-ethylhexanoate, dissolved in 23.6 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (600 g of vinyl acetate) was started and dosed within 6:00 h at constant feed rate and 90° C. Upon completion of the Feeds 1 and 2, the temperature was increased to 95° C. and Feed 3 consisting of 3.16 g of tert-butyl peroxy-2-ethylhexanoate, dissolved in 15.70 g of tripropylene glycol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar.

### Polymer Biodegradability

Polymer Biodegradation in wastewater was tested in triplicate using the OECD 301F manometric respirometry method. 30 mg/mL test substance is inoculated into wastewater taken from Mannheim Wastewater Treatment Plant and incubated in a closed flask at 25° C. for 28 days. The consumption of oxygen during this time is measured as the change in pressure inside the flask using an OxiTop C (WTW). Evolved CO₂ is absorbed using an NaOH solution. The amount of oxygen consumed by the microbial population during biodegradation of the test substance, after correction using a blank, is expressed as a % of the ThOD (Theoretical Oxygen Demand).

The biodegradation data of inventive polymers at 28 day of the OECD 301F test is summarized in Table 10. Inventive graft polymers show good percentage of biodegradation at 28 day of the OECD 301F test.

The biodegradation data of comparative graft polymer EX. 2 to 5 at 28 day of the OECD 301F test is summarized in Table 10A. comparative graft polymer EX. 2 to 5 show low percentage of biodegradation at 28 day of the OECD 301F test.

TABLE 10

| | Backbone | | | | | |
|---|---|---|---|---|---|---|
| | | Molecular weight * | | Graft | | |
| Polymer | Type | (g/mol) | Wt % | Type | Wt % | Biodeg (%) |
| Inv. 1 | A | 4168 | 65 | VAc | 35 | 70 |
| Inv. 2 | A | 4168 | 50 | VAc | 50 | 62 |
| Inv. 3 | C | 5590 | 65 | VAc | 35 | 67 |
| Inv. 4 | C | 5590 | 40 | VAc | 60 | 49 |
| Inv. 5 | D | 4165 | 65 | VAc | 35 | 54 |
| Inv. 6 | D | 4165 | 70 | VAc/VL | 25/5 | 45 |
| Inv. 7 | E | 1842 | 80 | VAc | 20 | 68 |
| Inv. 8 | F | 3842 | 50 | VAc/VP | 30/20 | 42 |
| Inv. 10 | G | 3000 | 50 | VAc | 50 | 51 |
| Inv. 11 | G | 3000 | 65 | VAc/VP | 20/15 | 58 |
| Inv. 12 | H | 3040 | 60 | VAc | 40 | 51 |
| Inv. 13 | I | 3009 | 65 | VAc | 35 | 75 |
| Inv. 14 | I | 3009 | 65 | VAc/VP | 30/5 | 66 |
| Inv. 15 | I | 3009 | 65 | VAc/VP | 25/10 | 67 |
| Inv. 16 | I | 3009 | 65 | VAc/VP | 20/15 | 62 |
| Inv. 17 | J | 2092 | 65 | VAc/Vlau | 25/10 | 57 |
| Inv. 19 | B | 2178 | 65 | VAc | 35 | 60 |
| Inv. 21 | K | 4241 | 65 | VAc | 35 | 51 |

* The molecular weights given are calculated weights, based on the total molar amounts of ingredients employed for the preparation reaction. As those reactions proceed basically to completeness, this is an acceptable way of calculation the molecular weights

TABLE 10A
Comparative Graft Polymers Ex. 2 to 5

| | | | Weight Ratio | |
|---|---|---|---|---|
| | | | of Polymer | |
| | PEG | | Backbone | |
| | Backbone | | to Sidechain | |
| | Mₙ | Sidechain | Monomers | Biodegradation |
| Example | [g/mol] | Monomers(B) | (A):(B1) | [%], 28 d |
| Comp. Ex. 2 | 6000 | VAc | 60:40 | 15 |
| Comp. Ex. 3 | 6000 | VAc | 70:30 | 15 |
| Comp. Ex. 4 | 4000 | VAc | 60:40 | 38 |
| Comp. Ex. 5 | 6000 | VAc | 40:60 | 28 |

Annotations:
VAc: vinyl acetate

### Stability of Inventive Graft Polymer 5 (Inv. 5) Vs Comparative Graft Polymer 1

Aqueous solutions of the inventive graft polymer 5 (Inv. 5) and comparative polymer 1 (9 wt %) were prepared and the mixtures were stored at 54° C. for two weeks.

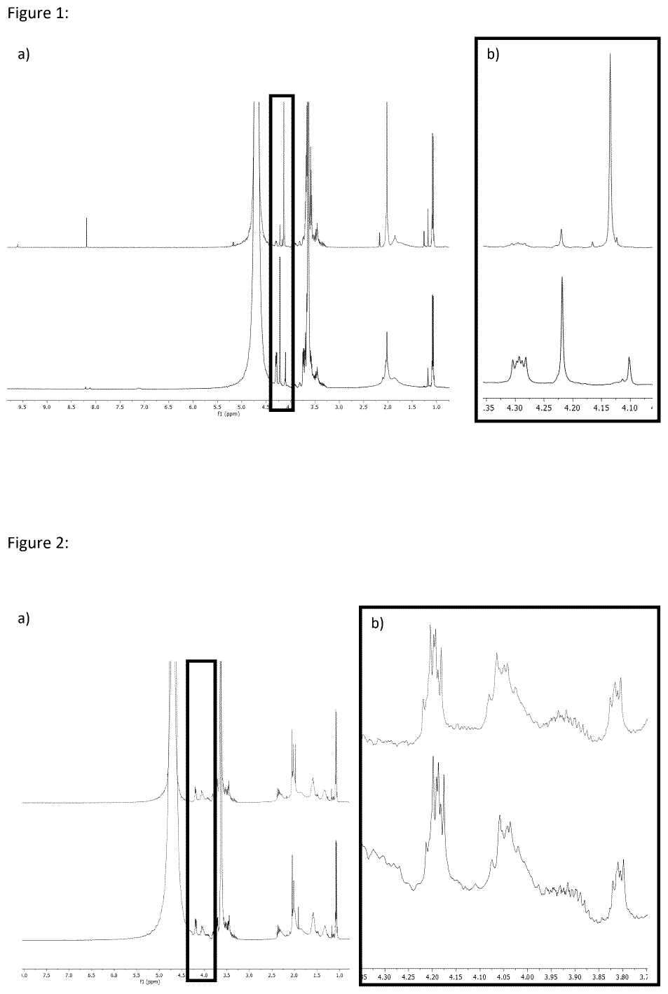

A brown precipitate was formed during storage of the comparative graft polymer 1. Recorded ¹H NMR (298 K, D₂O, 400 MHz) spectra of the precipitate and the solution showed no differences. The comparison of the ¹H NMR spectra of the fresh and the stored sample of comparative graft polymer showed significant rearrangements of the ¹H NMR shifts in the regions of 4.0 to 4.35 ppm (typical for PEG-Ester bonds) and 1.8 to 2.2 ppm (typical for bound/non bound acetate) as shown in FIG. 1.

The comparison of ¹H NMR spectra (298 K, D₂O, 400 MHz) of the fresh and the stored samples of inventive graft polymer (Inv. 5) showed no significant rearrangements in the spectra as shown in FIG. 2.

The results clearly demonstrate better hydrolysis instability from inventive polymers.

### Methods

### Method for Measuring Polydispersity by Gel Permeation Chromatography.

The number average molecular weight (Mn), the weight average molecular weight (Mw) and the polydispersity Mw/Mn of the inventive graft polymers can be determined by gel permeation chromatography in dimethylacetamide. The mobile phase (eluent) to be used is dimethylacetamide comprising 0.5 wt % LiBr. The concentration of graft polymer in tetrahydrofuran is 4.0 mg per mL. After filtration (pore size 0.2 μm), 100 μL of this solution are to be injected into the GPC system. Four columns (heated to 60° C.) may be used for separation (PLgel precolumn, 3 PLgel MIXED-E column). The GPC system is operated at a flow rate of 1 mL per min. A DRI Agilent 1100 may be used as the detection system. Poly(ethylene glycol) (PEG) standards (PL) having a molecular weight Mn from 106 to 1 378 000 g/mol may be used for the calibration.

### Method for Evaluating Suds Mileage of Hand Dish Composition.

The objective of the Suds Mileage Index test is to compare the evolution overtime of suds volume generated for different test formulations at specified water hardness, solution temperatures and formulation concentrations, while under the influence of periodic soil injections. Data are compared and expressed versus a reference composition as a suds mileage index (reference composition has suds mileage index of 100). The steps of the method are as follows:
1) A defined amount of a test composition, depending on the targeted composition concentration (0.12 wt %), is dispensed through a plastic pipette at a flow rate of 0.67 mL/sec at a height of 37 cm above the bottom surface of a sink (dimension: 300 mm diameter and 288 mm height) into a water stream (water hardness: 15 gpg, water temperature: 35° C.) that is filling up the sink to 4 L with a constant pressure of 4 bar.
2) An initial suds volume generated (measured as average foam height×sink surface area and expressed in cm³) is recorded immediately after end of filling.
3) A fixed amount (6 mL) of soil is immediately injected into the middle of the sink.
4) The resultant solution is mixed with a metal blade (10 cm×5 cm) positioned in the middle of the sink at the air liquid interface under an angle of 45 degrees rotating at 85 RPM for 20 revolutions.
5) Another measurement of the total suds volume is recorded immediately after end of blade rotation.
6) Steps 3-5 are repeated until the measured total suds volume reaches a minimum level of 400 cm³. The amount of added soil that is needed to get to the 400 cm³ level is considered as the suds mileage for the test composition.
7) Each test composition is tested 4 times per testing condition (i.e., water temperature, composition concentration, water hardness, soil type).
8) The average suds mileage is calculated as the average of the 4 replicates for each sample.
9) Calculate a Suds Mileage Index by comparing the average mileage of a test composition sample versus a reference composition sample. The calculation is as follows:

$$Suds Mileage Index = \frac{Average number of soil additions of test composition}{Average number of soil additions of reference composition} \times 100$$

Soil composition is produced through standard mixing of the components described in Table 11.

TABLE 11
Greasy Soil

| Ingredient | Weight % |
|---|---|
| Crisco Oil | 12.730 |
| Crisco shortening | 27.752 |
| Lard | 7.638 |
| Refined Rendered Edible Beef Tallow | 51.684 |
| Oleic Acid, 90% (Techn) | 0.139 |
| Palmitic Acid, 99+% | 0.036 |
| Stearic Acid, 99+% | 0.021 |

### Method for Evaluating Whiteness Benefit of Polymers in Laundry Detergent

Whiteness maintenance, also referred to as whiteness preservation, is the ability of a detergent to keep white items from whiteness loss when they are washed in the presence of soil. White garments can become dirty/dingy looking over time when soils are removed from dirty clothes and suspended in the wash water, then these soils can re-deposit onto clothing, making the clothing less white each time they are washed.

The whiteness benefit of polymers of the present disclosure is evaluated using automatic Tergotometer with 10 pots for laundry formulation testing.

SBL2004 test soil strips supplied by WFK Testgewebe GmbH are used to simulate consumer soil levels (mix of body soil, food, dirt etc.). On average, every 1 SBL2004 strip is loaded with 8 g soil. The SBL2004 test soil strips were cut into 5×5 cm squares for use in the test.

White Fabric swatches of Table 12 below purchased from WFK Testgewebe GmbH are used as whiteness tracers. Before the wash test, L, a, b values of all whiteness tracers are measured using Konica Minolta CM-3610D spectrophotometer.

TABLE 12

| | Fiber | % Fiber | Fabric | | |
|---|---|---|---|---|---|
| Code | Content | Content | Construction | Size | WFK Code |
| CK | Cotton | 100 | Weft Knit | (5 × 5 cm) | 19502_5 × |
| | | | | | 5_stamped |
| PC | Polyester/ | 65/35 | Weave | (5 × 5 cm) | 19503_5 × |
| | cotton | | | | 5_stamped |
| PS | Polyester/ | 95/5 | Weft Knit | (5 × 5 cm) | 19507_5 × |
| | Spandex ™ | | | | 5_stamped |

Additional ballast (background fabric swatches) are also used to simulate a fabric load and provide mechanical energy during the real laundry process. Ballast loads are comprised of cotton and polycotton knit swatches at 5×5 cm size.

4 cycles of wash are needed to complete the test:
Cycle 1: Desired amount of detergent is fully dissolved by mixing with 1L water (at defined hardness) in each tergotometer port. 60 grams of fabrics, including whiteness tracers (4 types, each with 4 replicates), 21 pieces 5×5 cm SBL2004, and ballast are washed and rinsed in the tergotometer pot under defined conditions.

In the test of water-soluble unit dose composition, wash concentration is 2000 ppm. Additional 47 ppm PVOH film is also added to the tergotometer pot. The wash temperature is 30° C., water hardness is 20 gpg.
Cycle 2: The whiteness tracers and ballast from each pot are then washed and rinsed again together with a new set of SBL2004 (5×5 cm, 21 pieces) follow the process of cycle 1. All other conditions remain the same as cycle 1.
Cycle 3: The whiteness tracers and ballast from each pot are then washed and rinsed again together with a new set of SBL2004 (5×5 cm, 21 pieces) follow the process of cycle 1. All other conditions remain the same as cycle 1.
Cycle 4: The whiteness tracers and ballast from each port are then washed and rinsed again together with a new set of SBL2004 (5×5 cm, 21 pieces) follow the process of cycle 1. All other conditions remain the same as cycle 1.

After Cycle 4, all whiteness tracers & ballast are tumbled dried between 60-65° C. until dry, the tracers are then measured again using Konica Minolta CM-3610D spectrophotometer. The changes in Whiteness Index (AWI(CIE)) are calculated based on L, a, b measure before and after wash.

$$Δ W I ( CIE ) = W I ( CIE ) ( after wash ) - W I ( CIE ) ( before wash )$$

### Method for Evaluating Stain Removal Benefit of Polymers in Laundry Detergent

Cleaning benefit of polymers are evaluated using tergotometer. Some examples test stains suitable for this test are:
Standard Grass ex CFT
Standard Clay ex CFT
ASTM Dust Sebum ex CFT
Highly Discriminating Sebum on polycotton ex CFT
Burnt Bacon on Knitted cotton (prepared using burnt bacon ex Equest)
Dyed Bacon on Knitted Cotton (prepared using dyed bacon ex Equest)

The stains are analysed using Image Analysis System for Laundry stain removal testing before and after the wash.

SBL2004 test soil strips supplied by WFK Testgewebe GmbH are used to simulate consumer soil levels (mix of body soil, food, dirt etc.). On average, every 1 SBL2004 strip is loaded with 8 g soil. The SBL2004 test soil strips were cut into 5×5 cm squares for use in the test.

Additional ballast (background fabric swatches) are also used to simulate a fabric load and provide mechanical energy during the real laundry process. Ballast loads are comprised of knitted cotton swatches at 5×5 cm size. 4 cycles of the wash are performed: Desired amount of detergent is fully dissolved by mixing with 1L water (at defined hardness) in each tergotometer port. 60 grams of fabrics, stains (2 internal replicates of each stain in each pot), 13 pieces 5×5 cm SBL2004, and ballast are washed and rinsed in the tergotometer pot under defined conditions. In the test of water-soluble unit dose composition, wash concentration is 2000 ppm. Additional 47 ppm PVOH film is also added to the tergotometer pot. The wash temperature is 30° C., water hardness is 7 gpg. The test has four external replicates.

All stains are tumbled dried between 60-65° C. until dry, then stains are measured again using Image Analysis System for Laundry stain removal testing.

Stain Removal Index (SRI) are automatically calculated from the L, a, b values using the formula shown below. The higher the SRI, the better the stain removal.

$$S R I = 100 * ( ( Δ {E}_{b} - Δ {E}_{a} ) / Δ {E}_{b} )$$

$$Δ {E}_{b} = √ ( {( {L}_{c} - {L}_{b} )}^{2} + {( {a}_{c} - {a}_{b} )}^{2} + {( {b}_{c} - {b}_{b} )}^{2} )$$

$$Δ {E}_{a} = √ ( {( {L}_{c} - {L}_{a} )}^{2} + {( {a}_{c} - {a}_{a} )}^{2} + {( {b}_{c} - {b}_{a} )}^{2} )$$

Subscript ‘b’ denotes data for the stain before washing
Subscript ‘a’ denotes data for the stain after washing
Subscript ‘c’ denotes data for the unstained fabric

### Method for Dye Re-Deposition in a Laundry Detergent

Preparation of a concentrated dye solution extracted from a test fabric. A concentrated dye solution is extracted from dyed test fabrics and used to determine the ability of a polymer to prevent dye re-deposition onto white test fabrics. Dyed knit test fabrics are prepared at 3% dye loading as a percentage of the weight of the fiber using a 20:1 liquor ratio (70 g/L sodium sulfate salt and 15 g/L soda ash) with identical auxiliary chemicals, time, temperature, and post-dye scour. Knit fabrics are cut into 3″×3″ swatches (7.6 cm×7.6 cm), and 4 fabric squares are layered on top of each other and fold in half and transferred into a 40 mL glass scintillation vial (Qorpak VWR supplier part #18087-086) using forceps. Deionized water (38 mL) is added to the vial, and vials are placed in heating blocks (Multi Temperature Zone Reaction Blocks, KEM Scientific, SN: 26197) on top of an orbital Shaker (VWR Standard Analog Shaker, Model: 3500, SN: 191011001, NA CAT No: 89032-092) and heated at set temperature of 50° C., and speed setting of 2 for a minimum 24 h to extract available dye. Vials are removed from heat and extracted dye solution and fabrics are transferred into a syringe with the depressor removed fitted with a glass fiber filter (Nalgene glass fiber syringe filters, 25 mm diameter, 1.1 micron, Thermo Scientific, Cat #722-2000, Lot 1705032503). The depressor is re-inserted and depress contents into new scintillation vial. UV-VIS Spectrum is measured and absorbance at λmax is recorded.

Dye re-deposition on fabric in a detergent solution. Concentrated extracts are diluted to 0.25 absorbance units (AU) at λmax. To 20 ml Scintillation vials with urea cap PE cone (Duran Wheaton Kimble 986546, 66021-533), is added 2.8 mL of filtered dye solution, 0.1 mL of 500 gpg hardness solution made from a 3:1 Ca/Mg ratio of CaCl₂/2H₂O, and MgCl₂/6H₂O, 0.1 mL of Detergent G diluted to 8.27%. For the no polymer reference, DI water is added to reach a volume of 3.5 mL (0.495 mL). For all other samples, 0.175 mL of a 0.1% by weight polymer solution is added followed by 0.32 mL to reach a total volume of 3.5 mL. The vial is swirled by hand.

White Acceptor Fabrics (2×2.75 cm, 100% cotton knit, WFK CK-19502) that have been measured for L*ab using a spectrophotometer such as a Konica Minolta CM-3610D spectrophotometer are added to each solution making sure fabrics are submersed in solution. Vials are shaken on a mechanical shaker at room temperature for 30 min wash time. Vials are removed from the shaker, fabrics are removed using forceps, and liquid is removed using a countertop spin dryer after spinning for 1.5 min. Fabrics are rinsed by placing fabrics into new 20 mL vials containing 3.5 mL, 15 gpg water and shaken on mechanical wrist shaker for 15 min at room temperature. Fabrics are removed from each vial using forceps, and liquid removed using a countertop spin dryer after 1.5 min of spinning. After spinning, fabrics are dried on racks in the food dehydrator at 52° C. for 1 hour. Washed and dried fabrics are measured for L*ab and the color change difference between unwashed and washed is recorded as dE2000 (G. Sharma, W. Wu, E. N. Dalal, “THE CIEDE2000 COLOUR-DIFFERENCE FORMULA: Implementation Notes, Supplementary Test Data, and Mathematical Observations,” submitted to COLOR RESEARCH AND APPLICATION, January 2004).

### Polymer Performance in Hand Dish Detergent

Hand dish detergent compositions below are prepared by traditional means known to those of ordinary skill in the art by mixing the listed ingredients. The impact of inventive polymers on suds mileage are evaluated by comparing the suds mileage of formulation A (Reference) and B (Reference with inventive polymers) in Table 13. The suds mileage performance is evaluated using the method for evaluating suds mileage of hand dish compositions described herein, and Suds Mileage Index is reported in Table 14.

TABLE 13

| | | B |
|---|---|---|
| | A | (Test composition: |
| | (Reference | Reference with |
| | composition) | inventive polymers) |
| Ingredient | % by weight of the composition | |
| NaCl | 0.5 | 0.5 |
| Polypropylene glycol (mw 1000) | 0.4 | 0.4 |
| Ethanol | 0.5 | 0.5 |
| Magnesium sulfate | 0.0169 | 0.0169 |
| Mixture of 2-methylcyclohexane- | 0.068 | 0.068 |
| 1,3-diamine, 4- | | |
| methylcyclohexane-1,3-diamine | | |
| C₁₂₋₁₃ AE0.6S anionic surfactant | 15.36 | 15.36 |
| C₁₂₋₁₄ dimethyl amine oxide | 5.91 | 5.91 |
| BIT | 0.0045 | 0.0045 |
| Phenoxyethanol | 0.08 | 0.08 |
| Perfume | 0.195 | 0.195 |
| Yellow Dye | 0.004 | 0.004 |
| Blue Dye | 0.00165 | 0.00165 |
| Inventive graft polymer | — | 2 |
| Water | Balance | Balance |
| pH (as 10 w/v % product | 9.0 | 9.0 |
| concentration in water) | | |

As indicated in Table 14, inventive polymers can deliver strong suds mileage benefit.

TABLE 14

| Inventive Polymer | Suds mileage index vs A (Ref) |
|---|---|
| Inv. 1 | 112 |
| Inv. 2 | 108 |
| Inv. 3 | 113 |
| Inv. 4 | 108 |
| Inv. 5 | 113 |
| Inv. 6 | 108 |
| Inv. 7 | 113 |

### Polymer Whiteness Performance in Liquid Detergent

Water soluble unit dose detergent composition E and F, and heavy-duty liquid detergent composition G, H below are prepared by traditional means known to those of ordinary skill in the art by mixing the listed ingredients (Table 15/Table 16).

The whiteness maintenance of the inventive and comparative polymers is evaluated according to the method for evaluating whiteness performance of polymers by directly comparing the whiteness performance of reference composition E and test composition F. AWI(CIE) of composition F vs composition E is reported in Table 17 as an indication of polymer whiteness performance benefit.

The stain removal performance of the inventive and comparative polymers is evaluated according to the method for evaluating whiteness performance of polymers by directly comparing the whiteness performance of reference composition E and test composition F. ASRI of composition F vs composition E is reported in Table 18 as an indication of polymer whiteness performance benefit.

The dye re-deposition performance of the inventive polymers is evaluated according to the dye re-deposition method by comparing performance of reference composition G having no polymer to test compositions H. The color change before and after washing is reported as dE2000 in Table 19/Table 20 as an indication of polymer dye re-deposition benefit.

TABLE 15

| | | F |
|---|---|---|
| | | (Test composition: |
| | | reference |
| | E | composition + |
| | (Reference | Inventive or |
| Ingredients | composition) | comparative polymer) |
| LAS (wt %) | 24.52 | 24.52 |
| AES (wt %) | 12.62 | 12.62 |
| AE NI (wt %) | 2.02 | 2.02 |
| Suds Suppressor (wt %) | 0.3 | 0.3 |
| Graft Polymer Example (wt %) | 0.00 | 5.96 |
| HEDP (wt %) | 2.23 | 2.23 |
| Monoethanolamine (wt %) | 8.09 | 8.09 |
| 1,2 PropaneDiol (wt %) | 5.0 | 5.0 |
| DiPropyleneGlycol (wt %) | 0.84 | 0.84 |
| K2SO₃ (wt %) | 0.4 | 0.4 |
| MgCl₂ (wt %) | 0.32 | 0.32 |
| Citric Acid (wt %) | 0.70 | 0.70 |
| Fatty Acid (wt %) | 1.61 | 1.61 |
| Glycerine (wt %) | 4.76 | 4.76 |
| Brightener (wt %) | 0.30 | 0.30 |
| Enzyme (including | 0.087 | 0.087 |
| Protease, Amylase, | | |
| Mannanase, PDE) (wt %) | | |
| Perfume (wt %) | 2.05 | 2.05 |
| Hueing Dye (blue, | 0.010 | 0.010 |
| green, yellow) (wt %) | | |
| Water/minors (wt %) | Balance | Balance |

TABLE 16

| | | H (Test composition: |
|---|---|---|
| | G | reference + |
| | (reference | Inventive or |
| Ingredients | composition) | comparative polymer) |
| LAS (wt %) | 10.5 | 10.5 |
| AES (wt %) | 2.5 | 2.5 |
| AE NI (wt %) | 10.9 | 10.9 |
| Suds Suppressor (wt %) | 0.2 | 0.2 |
| Graft Polymer Example | 0 | 2.1 |
| (wt %) | | |
| Chelant (wt %) | −0.3 | 0.3 |
| Monoethanolamine (wt %) | 2.1 | 2.1 |
| 1,2 PropaneDiol (wt %) | 0.7 | 0.7 |
| Enzyme (including | 1.4 | 1.4 |
| Protease, Amylase, | | |
| Mannanase, Pectawash) | | |
| (wt %) | | |
| Perfume (wt %) | 0.6 | 0.6 |
| Water/minors (wt %) | Balance | Balance |

Chelant = DETA + GLDA

As shown in Table 17, the inventive polymer delivers significant whiteness benefit where a difference of 5 units is typically noticeably different to the human eye.

TABLE 17

| | ΔWI(CIE) vs Reference |
|---|---|
| Polymer | (on PE: 100% Polyester Knit) |
| Inv. 1 | +16.24 |
| Inv. 2 | +18.81 |
| Inv. 3 | +17.01 |
| Inv. 5 | +19.60 |
| Inv. 6 | +12.85 |

As shown in Table 18, the inventive polymer delivers significant stain removal benefit on sebum stains and black todd clay. The inventive graft polymers contain VP (especially when VP is more than 50%) show particular strong black todd clay stain removal benefit.

TABLE 18

| | ΔSRI vs Reference | | |
|---|---|---|---|
| Polymer | Dust sebum | Discriminating sebum | Black todd clay |
| Inv. 1 | 11.0 | 8.7 | 9.0 |
| Inv. 2 | 12.9 | 8.8 | 7.2 |
| Inv. 3 | 13.0 | 8.3 | 7.7 |
| Inv. 7 | 10.2 | 7.1 | 7.9 |
| Inv. 8 | 9.0 | 5.3 | 14.8 |
| Inv. 14 | 5.2 | 2.0 | 5.0 |
| Inv. 15 | 9.2 | 6.3 | 10.4 |
| Inv. 16 | 7.4 | 4.2 | 14.0 |
| Inv. 18 | 8.3 | 4.7 | 16.7 |

As shown in Table 19, the inventive polymer delivers significant dye transfer benefit as shown by the decrease in dye re-deposition with a lowered E2000 on Reactive Red 120 and Reactive Red 239 compared to the same detergent without any polymer. Without wishing to be bound by theory, for grafting type I, as the vinyl pyrrolidone weight 0% increases, the dye transfer benefit increases and biodegradability is maintained above 6000. Inventive 16 has a 4.3 units less Reactive Red 120 transfer and 1.5 unit less dye transfer on Reactive Red 239.

TABLE 19

| | | | | | | dE2000 | |
|---|---|---|---|---|---|---|---|
| | Backbone | | | Graft | | Reactive | Reactive |
| Polymer | Type | Mn | Wt % | Type | Wt % | Red 120 | Red 239 |
| No polymer | — | — | — | — | — | 17.8 | 6.8 |
| Inv. 14 | I | 3009 | 65 | VAc/VP | 30/5 | 15.9 | 6.4 |
| Inv. 15 | I | 3009 | 65 | VAc/VP | 25/10 | 16.0 | 6.4 |
| Inv. 16 | I | 3009 | 65 | VAc/VP | 20/15 | 13.5 | 5.1 |

Table 20 shows that the inventive polymer based on grafting type F also delivers a significant and noticeable dye transfer benefit relative to the reference detergent with no polymer. Inventive 8 and Inventive 18 delivers significant dye transfer benefit as shown by the decrease in dye re-deposition with a lower dE2000 on Reactive Red 120 and Reactive Red 239 and Reactive Blue 171. The Inventive polymer 18 has even less dye transfer than inventive 8 since the vinyl acetate is 40% hydrolyzed making it more hydrophilic.

TABLE 20

| | | | | | | dE2000 | | |
|---|---|---|---|---|---|---|---|---|
| | Backbone | | | Graft | | Reactive | Reactive | Reactive |
| Polymer | Type | Mn | Wt % | Type | Wt % | Red 120 | Red 239 | Blue 171 |
| No polymer | — | — | — | — | — | 17.8 | 6.8 | 7.4 |
| Inv. 8 | F | 3842 | 50 | VAc/VP | 30/20 | 8.5 | 4.3 | 5.6 |
| Inv. 18 | F | 3842 | 50 | VAc*/VP | 30/20 | 7.8 | 3.8 | 5.1 |

*Vinyl acetate is 40% hydrolyzed.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric and home care composition comprising:
(i) graft polymer; and
(ii) one or more fabric and home care ingredients,
wherein the graft polymer consists of:
(A) 20 to 95% of a polymer backbone as a graft base,
which comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C₂ to C₁₀-alkylene oxides,
(a2) is a unit comprising at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein the at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
wherein the polymer backbone is obtained:
(A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
(A2) by first oligo-/polymerizing sub-unit(s) (a2) and then polymerizing the product with sub-unit(s) (a1); or
(A3) by first oligo-/polymerizing sub-unit(s) (a1) and then co-polymerizing the product with sub-unit(s) (a2);
(A4) by first providing an oligo- or polymeric sub-unit (a1) which is bears an end-cap on one side, is etherified with short-chain alcohols C₁ to C₄, which—as starter-block—is thereafter reacted with at least one sub-unit (a2) and/or at least one sub-unit (a1)—wherein the sub-unit (a1) may be different to that/those in the starter block or may be arranged in a different order compared to those in the starter block—to attach to the non-endcapped side of the starter block a new block comprising moieties from the sub-units employed for the (co-)polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
wherein in case more than one sub-unit (a1) and/or more than one sub-unit (a2) are present already in an employed oligomer or polymer, those sub-units can be arranged in any order within such employed oligomer or polymer, and
wherein in case more than one sub-unit (a1) and/or more than one sub-unit (a2) are present for the polymerization, those sub-units (and the optional oligomer/polymers if employed) can be arranged in any order within the obtained backbone; and
(B) 5 to 80% of polymeric sidechains (B) grafted onto the polymer backbone (A), wherein said polymeric sidechains (B) are obtainable by (co-)polymerization of at least one vinyl ester monomer (B1), optionally vinylpyrrolidone as monomer (B2), and optionally further monomer(s) (B3), and optionally further monomers,
with all percentages as weight percent in relation to the total weight of the graft polymer.

2. A fabric and home care composition comprising:
(i) graft polymer; and
(ii) one or more fabric and home care ingredients,
wherein the graft polymer consists of:
(A) 20 to 95% of a polymer backbone as a graft base,
which comprises at least one sub-unit (a1) and at least one sub-unit (a2), wherein
(a1) is a unit comprising moieties derived from at least one alkylene oxide monomer and/or at least one polyalkylene oxide-polymer having two hydroxy-end-groups, the alkylene oxide monomer selected from the group of C₂ to C₁₀-alkylene oxides,
(a2) is a unit comprising at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein the at least one lactone and/or hydroxy acid is/are selected from the groups i) and/or ii), with
i) lactone(s), i.e. cyclic esters, starting with α-lactone (three ring atoms) followed by β-lactone (four ring atoms), 7-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
wherein the polymer backbone is selected from:
(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
(A2) a backbone consisting of oligo- or polymerized sub-units (a2) as an inner block and two outer blocks of oligomeric and/or polymeric (a1)-sub-units; and
(A3) a backbone consisting of and inner block of oligomeric and/or polymeric (a1)-sub-units and two outer blocks of oligo- or polymeric sub-units (a2), in the form of at least an tri-block-polymer,
(A4) a backbone consisting of
a first block with
on one end an end-cap—such end-cap being a C₁ to C₁₈; and
an oligo- or polymeric sub-unit (a1); and
a second block which is attached to said first block at the opposite end of said first block via an ether or ester-function, said second block being composed of at least one sub-unit (a2) and optionally at least one sub-unit (a1), wherein the optional sub-unit(s) (a1) in said second block may be different to that/those in the first block or may be arranged in a different order compared to those in the first block, and the order of the sub-unit(s) (A1) and (a2) may be also in any order, including random structure,
such di-block-structure having as an idealized structure in case of using only sub-unit(s) (a2): [end-cap]-[sub-unit(s) (a1)]-[sub-unit(s) (a2)]
or in case of using sub-unit(s) (a1) and (a2): [end-cap]-[sub-unit(s) (a1)]-[random-{sub-unit(s) (a2)-sub unit(s) (a1)}];
and
(B) 5 to 80% of polymeric sidechains (B) grafted onto the polymer backbone (A), wherein said polymeric sidechains (B) are obtainable by (co-)polymerization of at least one vinyl ester monomer (B1), optionally vinylpyrrolidone as monomer (B2), and optionally further monomer(s) (B3), and optionally further monomers,
with all percentages as weight percent in relation to the total weight of the graft polymer.

3. The composition according to claim 1, wherein at least two different alkylene oxides are employed for the preparation of the backbone/are present in the backbone.

4. The composition according to claim 1, wherein the monomers are:
(B1) at least one vinyl ester, selected from vinyl acetate, vinyl propionate and/or vinyl laurate and any further vinylester known to a person skilled in the art, such as vinyl valerate, vinyl pivalate, vinyl neodecanoate, vinyl decanoate and/or vinyl benzoate;
Optionally
(B2) N-vinylpyrrolidone;
optionally
(B3) at least one further monomer, such as any one or more of 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid; and
Optionally
at least one further monomer, being different from those before, such other monomer being present only in an amount of less than 2% of the total amount of monomers employed for obtaining the polymeric sidechains (B), and are preferably present only as impurities but not deliberately added for polymerization.

5. The composition according to claim 1, wherein the amount of
if (B2) is present—
(B) is from 10 to 60%;
(B1) vinyl ester in weight percent being based on the total WEIGHT OF THE GRAFT POLYMER is
from 9 to 55%;
(B2) vinylpyrrolidone in weight percent being based on the total WEIGHT OF THE GRAFT POLYMER is from 1 to 20
and
if (B2) is not present—
(B) is from 5 to 60%;
(B1) vinylester in weight percent being based on the total WEIGHT OF THE GRAFT POLYMER is the total amount of (B) minus the total amount of (B3),
(B2) vinylpyrrolidone is 0%,
And further provided that in all cases before
(B3) (further monomer) is from 0 to 10.

6. The composition according to claim 1, wherein
at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein at least 80 weight percent is employed as vinyl ester (weight percent being based on the total weight of vinyl ester monomers B1 being employed).

7. The composition according to claim 1, wherein
(A) the polyalkoxylate-ester backbone comprises moieties derived from
(i) alkylene oxides (AO) comprising at least one of ethylene oxide (EO), propylene oxide (PO), and butylene oxide (BO),
with the AO in an amount of from 40 to 99, each based on the total weight of the backbone,
the amount of EO being of from 0 to 100 wt. %, based on total AO,
the PO and/or BO, in an total amount of each from 0 to 100 wt. % each based on the total weight of AO, with the total amount of PO and BO adding up to 100 wt. % for the sum of PO and BO,
with the total amount of AO adding up to 100 wt. %;
(ii) lactone/hydroxy acid monomer in an amount of from 1 and up to 60 each based on the total weight of the backbone, preferably only caprolactone;
with the total weight of the sum of sub-units (a1) and sub-units (a2) in the backbone (A) adding up to 100 wt %.

8. The composition according to claim 7, wherein
(i) alkylene oxides (AO) is selected from ethylene oxide (EO), propylene oxide (PO), and butylene oxide (BO), preferably only EO and PO,
with the AO in an amount of from 40 to 99 each based on the total weight of the backbone,
the amount of EO being of from 10 to 90 based on total AO,
the total amount of PO and BO being from 10 to 90 each based on the total weight of AO, with the total amount of PO and BO adding up to 100 wt. % for the sum of PO and BO, and
with the total amount of AO adding up to 100 wt. %;
(ii) lactone/hydroxy acid monomer in an amount of from 1 and up to 60 each based on the total weight of the backbone;
With the total weight of the sum of sub-units (a1) and sub-units (a2) in the backbone (A) adding up to 100 wt %.

9. The composition according to claim 8, wherein
alkylene oxides (AO) is selected from ethylene oxide (EO), propylene oxide (PO), and butylene oxide (BO), preferably only EO and PO, more preferably only EO
the amount of EO being of from 20 to 100 wt %, based on total AO,
the total amount of PO and BO being from 0 to 80 wt. %, each based on the total weight of AO, with the total amount of PO and BO adding up to 100 wt. % for the sum of PO and BO, with the total amount of AO adding up to 100 wt. %;
(ii) lactone/hydroxy acid monomer in an amount of from 5 and up to 50 based on the total weight of the backbone;
with the total weight of the sum of sub-units (a1) and sub-units (a2) in the backbone (A) adding up to 100 wt %.

10. The composition according to claim 1, wherein
(B) the monomers are:
(B1) at least one vinyl ester, selected from vinyl acetate, vinyl propionate and/or vinyl laurate, in amounts of from 70 to 100% by weight of the total weight of monomers that are grafted onto the backbone (A), preferably only vinyl acetate, and
(B2) optionally N-vinylpyrrolidone,
with the vinyl ester monomer(s) (B1) optionally being partially or fully hydrolyzed after polymerization.

11. The composition according to claim 1, wherein essentially no other monomers (B2) nor (B3) are employed.

12. The composition according to claim 1, wherein monomer (B1) and (B2) are present and no other monomers are employed.

13. The composition according to claim 1, wherein the at least one vinyl ester-monomer (B1)-derived moiety is partially or fully hydrolyzed after the polymerization reaction.

14. The composition according to claim 1,
wherein at least one of i), ii) and iii) is fulfilled:
i) the polymer backbones (A1), (A2) and (A3) may bear as the end-groups two hydroxy-groups or may be capped with C₁ to C₂₂-alkyl groups, such end-group being attached using standard means after final preparation of the backbone whereas for (A4) such end-cap is done on the oligo-/polymeric sub-unit (a1) prior to the polycondensation employing sub-unit(s) (a2);
ii) the graft polymer has a polydispersity (PDI) Mw/Mn of at most 10;
iii) the biodegradability of the graft polymer is at least 35 within 28 days, when tested under OECD 301F.

15. A composition according to claim 1, wherein the composition is a fabric and home care product, optionally further comprising at least one enzyme,
wherein the at least one graft polymer is present in an amount ranging from about 0.01% to about 20% in relation to the total weight of such composition or product in relation to the total weight of such composition or product, and
such product or composition further comprising from about 1% to about 70% by weight of a surfactant system.

16. The composition according to claim 1, further comprising an antimicrobial agent selected from the group consisting of 2-phenoxyethanol.

17. The composition according claim 1, further comprising 4,4′-dichloro 2-hydroxydiphenylether in a concentration from 0.001 to 3%, by weight of the composition.

18. The composition according to claim 1, including one or more fabric and home care ingredients selected from the group consisting of a surfactant system, fatty acids and/or salts thereof, enzyme stabilizers, builders, dispersants, structurants or thickeners, polymers, additional amines, catalytic materials, bleaching agents, bleaching catalysts, bleach activators, polymeric dispersing agents, soil removal/anti-re-deposition agents, polymeric grease cleaning agents, amphiphilic copolymers, fluorescent brightener, fabric hueing agents, chelating agent, encapsulates, perfume, pro-perfumes, malodor reduction materials, conditioning agents, probiotics, organic acids, anti-oxidants, anti-microbial agents and/or preservatives, neutralizers and/or pH adjusting agents, processing aids, rheology modifiers, corrosion and/or anti-tarnishing agents, hygiene agent, pearlescent agent, pigments, opacifier, solvents, carriers, hydrotrope, suds suppressor and mixtures thereof.

19. A composition according to claim 1, wherein the composition is in the form of a liquid composition, a granular composition, a single-compartment pouch, a multi-compartment pouch, a sheet, a pastille or bead, a fibrous article, a solid article, a tablet, a bar, flake, or a mixture thereof.

20. A method of laundering fabric or of cleaning hard surfaces, which method comprises treating a fabric or a hard surface with a composition according to claim 1.
